(19) United States
(12) Patent Application Publication
(10) Pub. No.: US 2025/0324188 A1
(43) Pub. Date: Oct. 16, 2025

(54) AUDIO MIXED REALITY AND ASSOCIATED SYSTEMS, METHODS, DEVICES, AND NON-TRANSITORY COMPUTER-READABLE MEDIA

(71) Applicant: Iyo Inc., Redwood City, CA (US)

(72) Inventors: Neil David Treat, Los Gatos, CA (US); Christian Ervin, San Anselmo, CA (US); Kyle Steven Hoefer, Santa Clara, CA (US); William Stanley Woods, Palo Alto, CA (US); Jason Steven Rugolo, Gilbert, AZ (US)

(73) Assignee: Iyo Inc., Redwood City, CA (US)

(21) Appl. No.: 19/178,597

(22) Filed: Apr. 14, 2025

Related U.S. Application Data
(60) Provisional application No. 63/633,616, filed on Apr. 12, 2024.

(51) Int. Cl. H04R 1/10; H04S 7/00

(52) U.S. Cl. CPC H04R 1/1083; H04S 7/304

(57) ABSTRACT

Audio mixed reality devices and systems that may enhance, diminish, or modify real-world sounds, such as by overlaying audio streams onto real-world sounds or by combining audio streams with real-world sounds. The audio mixed reality devices and systems may enable presence in the real world, immersion in audio streams, or focus on real-world sounds. Immersive spatial audio scenes may be layered over or otherwise used to modify real-world sounds. An audio mixed reality device may capture and reproduce real-world sounds such that they appear spatially situated in the user's environment. The resulting auditory experience may ensure that real-world sounds maintain their natural origin points, thereby providing an acoustic foundation upon which audio streams can be overlaid or modulated without disorienting the user. By dynamically reconstructing a spatial representation of the external environment, the audio mixed reality device may facilitate the contextual and spatial interaction of audio streams with real-world sounds.

### CROSS-REFERENCE TO RELATED APPLICATION

This application claims priority to U.S. Provisional Patent Application No. 63/633,616, filed on Apr. 12, 2024, and entitled “Audio Mixed Reality,” and is related to U.S. patent application Ser. No. 18/621,974, filed on Mar. 29, 2024, and entitled “VIRTUAL AUDITORY DISPLAY FILTERS AND ASSOCIATED SYSTEMS, METHODS, AND NON-TRANSITORY COMPUTER-READABLE MEDIA,” to U.S. patent application Ser. No. 18/622,540, filed Mar. 29, 2024, and entitled “VIRTUAL AUDITORY DISPLAY DEVICES AND ASSOCIATED SYSTEMS, METHODS, AND DEVICES,” to U.S. patent application Ser. No. 19/097,807, filed Apr. 1, 2025, and entitled “IN-CANAL AND OTHER MICROPHONE SOUND CAPTURE AND SOUND OUTPUT, AND ASSOCIATED SYSTEMS, METHODS, DEVICES, AND NON-TRANSITORY COMPUTER-READABLE MEDIA,” to U.S. patent application Ser. No. 19/177,479, filed Apr. 11, 2025, and entitled “AUDITORY USER INTERFACES AND ASSOCIATED SYSTEMS, METHODS, DEVICES, AND NON-TRANSITORY COMPUTER-READABLE MEDIA,” and to U.S. patent application Ser. No. ______, filed on the same day herewith, and entitled “IN-CANAL AND OTHER MICROPHONE SOUND CAPTURE AND SOUND OUTPUT, AND ASSOCIATED SYSTEMS, METHODS, DEVICES, AND NON-TRANSITORY COMPUTER-READABLE MEDIA.” Each of the foregoing applications is incorporated by reference herein in its entirety.

### TECHNICAL FIELD

The present disclosure relates in general to audio mixed reality, and in particular to audio mixed reality in which real-world sounds may be enhanced, diminished, or modified, such as by virtual sound or audio that may be overlaid or combined or otherwise used with real-world sounds.

### BACKGROUND

Conventional virtual reality applications rely exclusively on normal or spatial audio with no real-time awareness of the surrounding environment beyond user head orientation. These systems may render rich three dimensional (3D) soundscapes but are fundamentally disconnected from physical reality.

Virtual reality applications often allow virtual content (for example, audio cues, digital announcements) to be heard along with the real-world soundscape (for example, people talking, ambient noises). However, such applications often allow virtual content to overwhelm the user, thereby causing the user to loses awareness of his or her surroundings. Conversely, if real-world noise is too dominant, the virtual content becomes inaudible. Striking the right balance and coherence between these sources is crucial.

Virtual reality applications often focus on visual augmentation by overlaying digital graphics on the real environment or by constructing fully virtual worlds. While spatial audio has enhanced immersion, user interaction with sound itself remains passive. The user can hear virtual audio but cannot interact with the virtual audio.

No admission is necessarily intended, nor should it be construed, that any of the preceding information constitutes prior art.

### SUMMARY

This disclosure describes audio mixed reality devices and systems that may enhance, diminish, or modify real-world sounds, such as by overlaying audio streams onto real-world sounds or by combining audio streams with real-world sounds. In doing so, the audio mixed reality devices and systems may enable presence in the real world, immersion in audio streams, or focus on real-world sounds. Audio mixed reality devices and systems described herein may render immersive spatial audio scenes that can be layered over, selectively mixed with, or used to modify real-world acoustic inputs.

Audio mixed reality devices and systems may capture and reproduce real-world sounds such that they appear spatially situated in the user's environment. The resulting auditory experience may ensure that physical sounds maintain their natural origin points. This may have the effect on the user of feeling as if the audio mixed reality device effectively disappears perceptually. This provides an acoustic foundation upon which sounds from audio streams can be overlaid or modulated without disorienting the user.

By dynamically reconstructing a spatial representation of the external environment, the audio mixed reality devices and systems may facilitate the contextual and spatial interaction of audio streams with real-world sounds. The audio mixed reality devices and systems may modify characteristics of audio streams (for example, locations, reverberances, or other qualities) so as to render them virtually indistinguishable from environmental sounds. This may have the effect on the user of the user perceiving audio streams as an extension of the surrounding environment. This hybridization may unlock unique affordances or experiences for users, such as allowing the user to experience real-world speech with spatial augmentation, or have environmental sounds selectively replaced or redirected.

### BRIEF DESCRIPTION OF THE DRAWINGS

The particular arrangements shown in the Figures should not be viewed as limiting. It should be understood that the illustrated elements, including the shape, size and scale, may not necessarily be drawn in actual proportion to each other.

FIG. 1A is a front bottom perspective view of a virtual auditory display device according to an embodiment.

FIG. 1B is a front elevational view of the virtual auditory display device of FIG. 1A.

FIG. 2 is a front perspective view and a rear view of an ear-worn device of the virtual auditory display device of FIG. 1A.

FIG. 3 is an exploded view of the ear-worn device of FIG. 2

FIG. 4 is an exploded view of an electronics package of the ear-worn device of FIG. 2.

FIG. 5A is a front perspective view and a rear perspective view of an acoustics package of the ear-worn device of FIG. 2.

FIG. 5B is a front perspective view and a rear perspective view of another acoustics package of another ear-worn device of the virtual auditory display device of FIG. 1A.

FIG. 5C depicts multiple views of the acoustics package of FIG. 5A.

FIG. 5D depicts multiple views of the acoustics package of FIG. 5B.

FIG. 6 is an exploded view of the acoustics package of FIG. 5A and an ear interface of the virtual auditory display device of FIG. 1A.

FIG. 7A is a rear bottom perspective view and FIG. 7B is a front top perspective view of a collar for an ear-worn device in some embodiments.

FIG. 8A is a graph depicting frequency responses of multiple audio signals for acoustic packages according to various embodiments.

FIG. 8B is another graph depicting frequency responses of multiple audio signals for acoustic packages according to various embodiments.

FIG. 9A is a rear perspective view of an ear-worn device having the collar of FIGS. 7A and 7B and a pressure-equalization vent in some embodiments.

FIG. 9B is a cross-sectional view of an ear-worn device having another pressure-equalization vent in some embodiments.

FIG. 10A is a logic block diagram of components of an electronics package of the virtual auditory display system of FIG. 1A.

FIG. 10B is another logic block diagram of components of another electronics package of the virtual auditory display system of FIG. 1A.

FIG. 11 is a front perspective view and a rear perspective view of an ear-worn device of a virtual auditory display device according to another embodiment.

FIG. 12 is an exploded view of the ear-worn device of FIG. 11.

FIG. 13 is an exploded view of the electronics package of the ear-worn device of FIG. 11.

FIG. 14 is a logic block diagram of components of the electronics package of FIG. 13.

FIGS. 15A and 15B depict multiple views of a virtual auditory display device according to another embodiment.

FIGS. 16A and 16B depict multiple views of a virtual auditory display device according to another embodiment.

FIG. 17A is a front perspective view and FIG. 17B is a rear perspective view of a virtual auditory display device according to another embodiment.

FIGS. 17C through 17G depict multiple views of an ear-worn device of the virtual auditory display device of FIGS. 17A and 17B.

FIGS. 18A and 18B depict multiple views of a controller for the virtual auditory display device of FIGS. 17A through 17G according to some embodiments.

FIG. 19 depicts a cable that may be utilized with the virtual auditory display device of FIGS. 17A through 17G and the controller of FIGS. 18A and 18B according to some embodiments.

FIG. 20 depicts a battery assembly that may be utilized with the virtual auditory display device of FIGS. 17A through 17G and the controller of FIGS. 18A and 18B according to some embodiments.

FIG. 21 depicts a wireless communications device in some embodiments.

FIGS. 22A and 22B depict multiple views of a virtual auditory display device according to another embodiment.

FIG. 23 is a diagram of an environment in which a virtual auditory display system and virtual auditory display devices may operate in some embodiments.

FIG. 24A is a block diagram depicting components of the virtual auditory display system in some embodiments.

FIG. 24B is a block diagram depicting components of an ear-worn device in some embodiments.

FIG. 24C is a block diagram depicting a process for generating acoustic environment digital filters in some embodiments.

FIG. 24D is a block diagram depicting operations of a spatialization engine of the virtual auditory display system in some embodiments.

FIG. 25A is a block diagram of a method of generating and applying digital filters in some embodiments.

FIG. 25B is a block depicting components of a filter generation system in some embodiments

FIGS. 26A through 26C are graphs of frequency responses of digital audio signals in some embodiments.

FIG. 27A depicts a distribution of center frequencies as a function of azimuth (x-axis) and elevation (y-axis) for the left ear.

FIG. 27B depicts a distribution of center frequencies as a function of azimuth (x-axis) and elevation (y-axis) for the right ear.

FIG. 28A is a graph of the center frequency of a digital filter as a function of elevation angle relative to a head orientation according to some embodiments.

FIG. 28B is a graph of user experience data of multiple trials with five different digital filters, which vary as a function of notch center frequency, in some embodiments.

FIGS. 29A through 29X depict gain modifier masks that may be applied to modify gains of digital filters in some embodiments.

FIGS. 30A and 30B depict head shadow gains produced by digital filters in some embodiments.

FIG. 30C depicts an output of the application of digital filters to a digital audio signal according to some embodiments.

FIG. 30D depicts user experience data for a transfer function based on digital filters according to some embodiments and user experience data for a prior art transfer function.

FIG. 30E depicts an example head-related transfer function (HRTF).

FIGS. 31A and 31B depict methods of generating digital filters according to some embodiments.

FIGS. 32A and 32B depict methods of applying digital filters according to some embodiments.

FIG. 32C depicts a method of generating and applying virtual auditory display filters in some embodiments.

FIGS. 33A and 33B depict an example user interface for displaying a representation of a virtual audio display in some embodiments.

FIG. 33C depicts an example user interface for adjusting settings for a virtual audio display in some embodiments.

FIG. 34 is multiple images depicting example use cases of display filter technology in some embodiments.

FIGS. 35A and 35B are diagrams of a method of personalizing digital filters in some embodiments.

FIGS. 36A and 36B depict methods of personalizing digital filters in some embodiments.

FIGS. 37A through 37C depict an example user interface for calibrating a virtual auditory display device in some embodiments.

FIGS. 37D through 37F depict an example user interface for personalizing a virtual auditory display of a virtual auditory display device in some embodiments.

FIGS. 37G through 37J depict an example user interface for providing information on calibration of a virtual auditory display device and personalization of a virtual auditory display of the virtual auditory display device in some embodiments.

FIG. 38A depicts an example configuration for implementing an auditory user interface in some embodiments.

FIG. 38B depicts another example configuration for implementing an auditory user interface according to some embodiments.

FIG. 39 is a block diagram depicting an auditory operating system according to some embodiments.

FIG. 40 depicts functionality of an auditory operating system in some embodiments.

FIG. 41 depicts interactions between a user device, a shared auditory space, and an auditory operating system according to some embodiments.

FIG. 42A is a block diagram depicting an audio mixed reality device according to some embodiments.

FIG. 42B is a block diagram depicting a memory of the audio mixed reality device of FIG. 42A in some embodiments.

FIG. 42C is a flow diagram illustrating an example method that the audio mixed reality device of FIG. 42A may perform according to some embodiments.

FIG. 43 is a flow diagram illustrating an example method that some embodiments of aspects of the described technology may perform.

FIGS. 44A and 44B are block diagrams depicting systems according to embodiments of aspects of the described technology.

FIG. 45 depicts a block diagram of an example digital device in some embodiments.

Throughout the drawings, like reference numerals will be understood to refer to like parts, components, and structures.

### DETAILED DESCRIPTION

Described herein are virtual auditory display devices. A virtual auditory display device may include a first ear-worn device and a second ear-worn device that a person wears on the person's ears. The virtual auditory display device may receive audio signals from another device and generate virtual auditory display sound based on the audio signals. Virtual auditory display sound may refer to sounds that are capable of being perceived by the wearer of the virtual auditory display device as coming from any point in space surrounding the wearer. The virtual auditory display device may thus provide an immersive sound experience for the wearer.

Virtual auditory display devices may have a wide range of uses. For example, a music creator may use a virtual auditory display device to listen to music the music creator has produced. The music creator may then remix or modify the music based on their hearing the music rendered as virtual auditory display sound. For example, the music creator may move the location of certain sounds, emphasize certain sounds, de-emphasize certain sounds, and the like. In this fashion, the music creator may utilize the virtual auditory display device as part of an iterative process of creating music until the music creator achieves the desired effect for the music.

Another use may be by music afficionados who may utilize a virtual auditory display device to provide a listening experience that reinvigorates the music that they love. Another use may be for users who play video games. The virtual auditory display devices may allow the users to hear sounds emanating from locations that are not shown on their displays, thereby improving the users' awareness.

Another group of example use cases relate to military, non-military (for example, first responders such as police and firefighters) and/or other organizational applications. Virtual auditory display devices may be used to provide hyper-realistic virtual audio environments that facilitate virtual training for military and/or non-military personnel. For military personnel, virtual auditory display devices and associated devices may provide enhanced hearing, communications and hyper-situational awareness in combat and training. Other uses are described herein, and still other uses will be apparent.

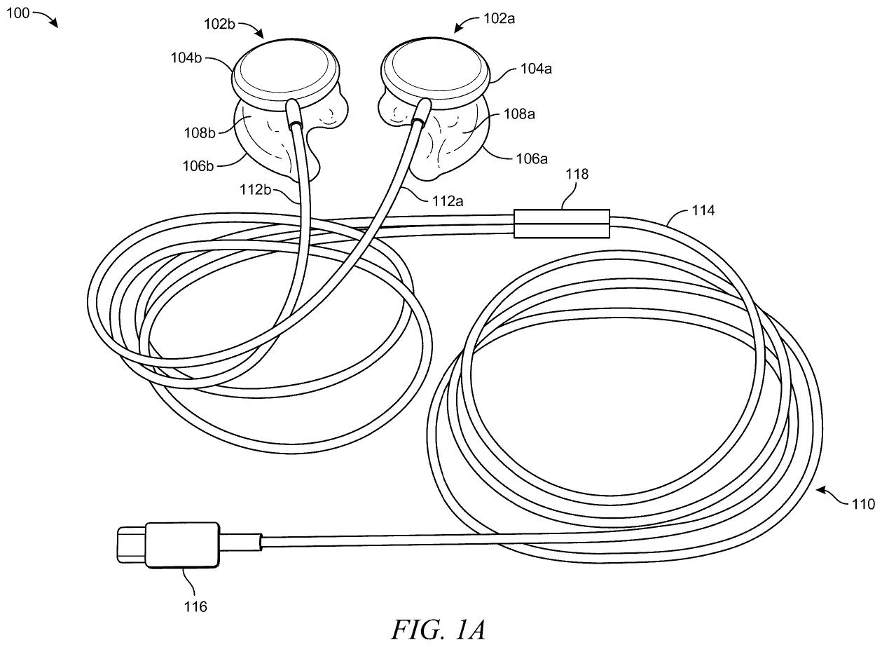

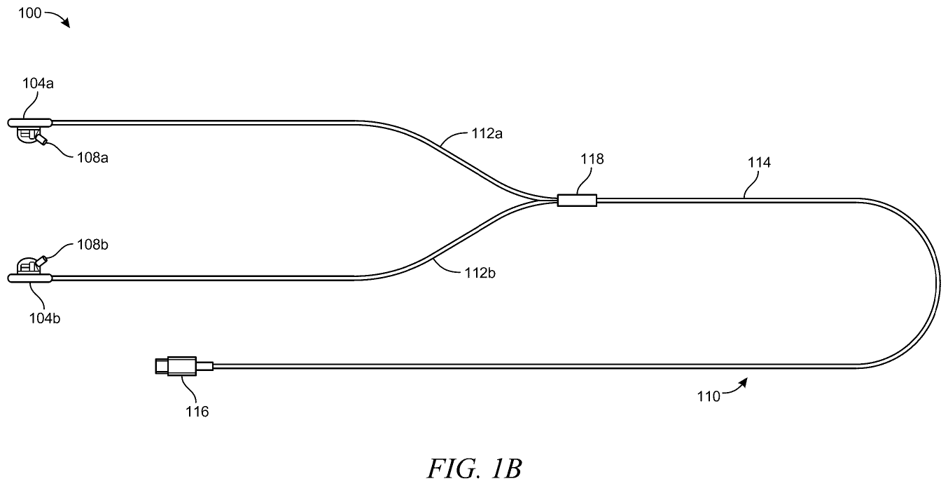

FIG. 1A is a front bottom view of a virtual auditory display device 100 according to an embodiment. The virtual auditory display device 100 includes a first ear-worn device 102a, a second ear-worn device 102b, and a cable 110. The first ear-worn device 102a includes a first electronics package 104a, a first ear interface 106a, and a first acoustic package 108a positioned within the first ear interface 106a and attached to the first electronics package 104a.

The second ear-worn device 102b includes a second electronics package 104b, a second ear interface 106b, and a second acoustic package 108b positioned within the second ear interface 106b and attached to the second electronics package 104b. The cable 110 includes a connector 116, a cable connector portion 114, a junction 118, a first cable portion 112a connected to the junction 118 and the first electronics package 104a, and a second cable portion 112b connected to the junction 118 and the second electronics package 104b.

As described in more detail herein, the first ear interface 106a is structured to be placed in a left ear of a wearer of the virtual auditory display device 100 and the second ear interface 106b is structured to be placed in a right ear of the wearer. The first ear interface 106a and the second ear interface 106b may be custom made for the wearer's ears so as to provide a generally acoustically sealed fit for the wearer's ears.

Each of the first electronics package 104a and the second electronics package 104b includes electronics components for generating audio signals based on digital audio signals received via the cable 110 from an external device, such as a phone or a computer, to which the virtual auditory display device 100 is connected. Each of the first acoustic package 108a and the second acoustic package 108b includes one or more analog components, such as one or more speakers, that are configured to emit sound based on the audio signals received from the first electronics package 104a and the second electronics package 104b respectively. The sound travels through the first ear interface 106a and the second ear interface 106b and into the ear canals of the wearers.

FIG. 1A depicts the first electronics package 104a and the second electronics package 104b as attached to the first acoustic package 108a and the second acoustic package 108b, respectively. However, as described in more detail herein, the first electronics package 104a and the second electronics package 104b may be removed from the first acoustic package 108a and the second acoustic package 108b, respectively.

The wearer may remove the first electronics package 104a and the second electronics package 104b from the first acoustic package 108a and the second acoustic package 108b and insert the first ear interface 106a into the wearer's left ear and the second ear interface 106b into the wearer's right ear. The wearer may then connect the first electronics package 104a to the first acoustic package 108a and the second electronics package 104b to the second acoustic package 108b.

Although the first ear interface 106a and the first acoustic package 108a are for the left ear of the wearer and the second ear interface 106b and the second acoustic package 108b are for the right ear of the wearer, the first electronics package 104a may be connected to either the first acoustic package 108a or the second acoustic package 108b. Similarly, the second electronics package 104b may be connected to either the first acoustic package 108a or the second acoustic package.

The user may connect the virtual auditory display device 100 to an external device such as a phone or laptop or desktop computer (not illustrated in FIG. 1A) via the connector 116 of the cable 110. The external device may stream two-channel digital audio to the first ear-worn device 102a and the second ear-worn device 102b via the cable 110. The two-channel digital audio may have been generated using virtual auditory display filters that produce audio signals that the first ear-worn device 102a and the second ear-worn device 102b use to generate virtual auditory display sound for the wearer. Virtual auditory display sound may refer to sounds that are capable of being perceived by the wearer of the virtual auditory display device 100 as coming from any point in space surrounding the wearer. The virtual auditory display device 100 may thus provide an immersive sound experience for the wearer using the sound output by the first ear-worn device 102a and the sound output by the second ear-worn device 102b. The generation of virtual auditory display filters and application of virtual auditory display filters so that the first ear-worn device 102a and the second ear-worn device 102b may output virtual auditory display sound is described in more detail herein.

FIG. 1B is a front elevational view of the virtual auditory display device 100. The first ear-worn device 102a and the second ear-worn device 102b are shown without the first acoustic package 108a and the second acoustic package 108b positioned within the first ear interface 106a and the second ear interface 106b, respectively.

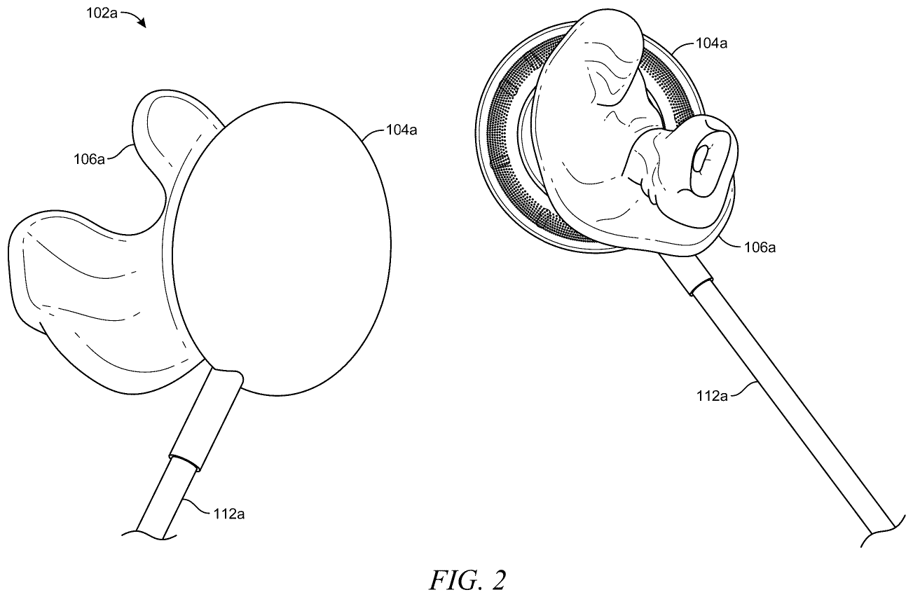

FIG. 2 depicts a front perspective view and a rear view of the first ear-worn device 102a. As described in more detail herein, the first electronics package 104a is removably magnetically coupleable to the first acoustic package 108a (not illustrated in FIG. 2), and the first acoustic package 108a is removably coupleable to the first ear interface 106a. Similarly, for the second ear-worn device 102b (not illustrated in FIG. 2), the second electronics package 104b is removably coupleable to the second acoustic package 108b and the second acoustic package 108b is removably coupleable to the second ear interface 106b.

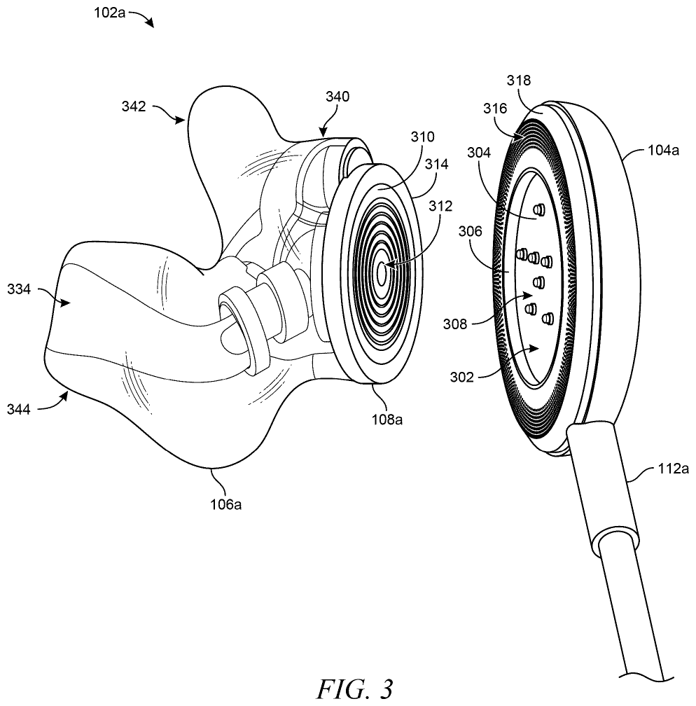

FIG. 3 is an exploded view of the first ear-worn device 102a. The first ear-worn device 102a includes the first electronics package 104a, the first acoustic package 108a, and the first ear interface 106a. The first acoustic package 108a includes a connector 310 having a generally planar surface. The connector 310 includes a first set of electrical contacts 312 on the generally planar surface. In some embodiments, the first set of electrical contacts 312 includes a set of annular electrical contacts. In some embodiments, there are seven annular electrical contacts in the set. The first acoustic package 108a also includes a magnet 314 having a generally hollow cylindrical shape.

The first electronics package 104a includes a microphone cover 318 including multiple perforations 316. The first electronics package 104a further includes a magnet 306 positioned inward relative to the microphone cover 318. The microphone cover 318 and the magnet 306 form a generally cylindrical recess 302 having a generally planar surface 304. A second set of electrical contacts 308 extend outwards from the generally planar surface 304. Each electrical contact of the second set of electrical contacts 308 is configured to connect with a separate electrical contact of the first set of electrical contacts 312 so that power and/or data may pass between the electronics package 104a and the acoustics package 108a. In some embodiments, the second set of electrical contacts 308 includes a set of pogo pins. In some embodiments, there are seven pogo pins in the set, and each pogo pin is arranged on the generally planar surface 304 such that the pogo pin contacts a separate annular electrical contact.

The generally cylindrical recess 302 has the same general shape as the magnet 314 and the connector 310 of the second acoustic package 108b. The first electronics package 104a may thus removably magnetically couple to the first acoustic package 108a. The first electronics package 104a is removably magnetically coupleable to the first acoustic package 108a due to attractive magnetic forces between the magnet 314 and the magnet 306. Similarly, the second electronics package 104b of the second ear-worn device 102b is also removably magnetically coupleable to the second acoustic package 108b due to magnetic attractive forces between corresponding magnets.

The first ear interface 106a includes a proximal portion 340, an upper portion 342, and a distal portion 344. When first ear-worn device 102a is worn by a wearer, the distal portion 344 is positioned in the left ear canal of the wearer and the upper portion 342 is positioned generally proximate to the left ear concha and generally between the left ear antihelix and helical crus of the wearer. The proximal portion 340 is positioned generally proximate to the left ear antihelix, antitragus, and tragus of the wearer.

The first ear interface 106a also includes a first opening and multiple cavities (not illustrated in FIG. 3) that allow the first acoustic package 108a to be placed into and positioned within the first ear interface 106a. The first ear interface 106a also includes a second opening (not illustrated in FIG. 3) and a passage 334 from the second opening to the first acoustic package 108a. The second ear interface 106b is structured similarly to the first ear interface 106a but for the right ear of the wearer.

The first ear interface 106a and the second ear interface 106b (not illustrated in FIG. 3) may be custom-made for a left ear and a right ear of a wearer. The first ear interface 106a and the second ear interface 106b may thus provide a generally acoustically sealed fit for the left ear and the right ear, respectively, of the wearer. The first ear interface 106a and the second ear interface 106b may be made of any suitable material, such as silicone, thermoplastic elastomers (TPE), and/or other biocompatible options, and may be transparent, translucent, or opaque.

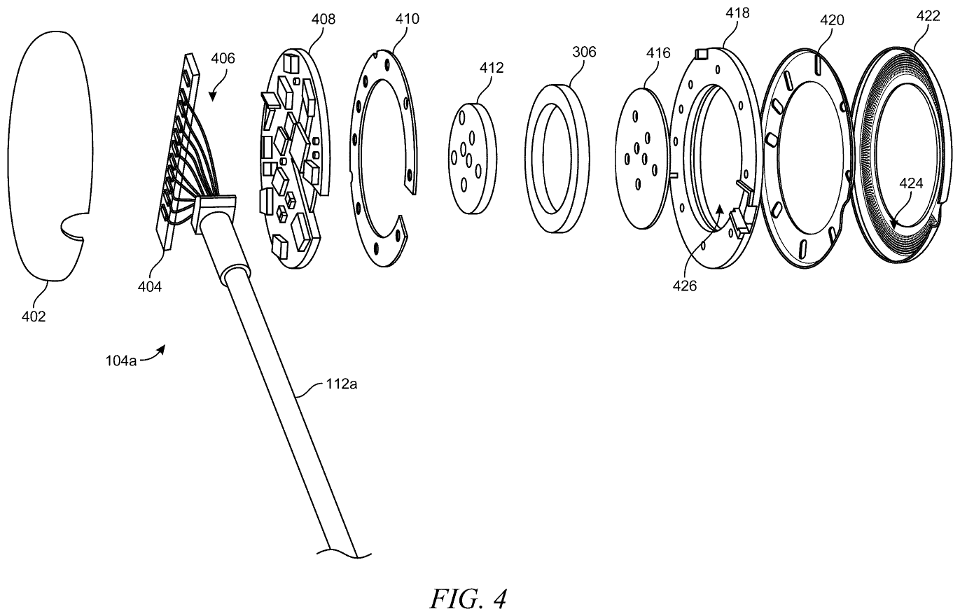

FIG. 4 is an exploded view of the first electronics package 104a. From left to right, the first electronics package 104a includes a cap 402. The cap 402 may be made from titanium or other suitable material. In some embodiments, the cap 402 is machined from a solid block of material (for example, titanium). In some embodiments, the cap 402 has a curvature continuous surface. In some embodiments, at least a portion of the cap 402 has a curvature continuous surface.

The first electronics package 104a further includes a cable printed circuit board 404. The first cable portion 112a includes multiple wires 406 that are attached to the cable printed circuit board 404. In some embodiments, the first cable portion 112a includes eleven wires. Several of the multiple wires 406 may be for carrying power and/or data from an external device to which the connector 116 is connected to, such as a phone or a desktop or laptop computer. Several of the multiple wires 406 may be for carrying data to and from the first electronics package 104a.

The first electronics package 104a further includes a printed circuit board 408. The printed circuit board 408 includes multiple electronics components such as a microcontroller, memory, an inertial measurement unit (IMU)-based sensor system (which may be referred to as an IMU), a magnetometer, codecs with audio digital signal processors (DSPs), multiple microphones, and the second set of electrical contacts 308.

In some embodiments, the printed circuit board 408 includes nine microphones. The nine microphones on the printed circuit board 408 may be utilized for different purposes. In some embodiments, eight of the nine microphones are digital and may be utilized to create a transparency mode by capturing external noises that are processed by the first electronics package 104a and output by first acoustic package 108a. In some embodiments, one microphone is a high signal-to-noise ratio analog microphone that may be utilized for feedforward active noise cancellation.

The first electronics package 104a also includes a first pressure-sensitive adhesive layer 410, an electrical connector spacer 412, the magnet 306, and a first pressure-sensitive adhesive layer 416.

The first electronics package 104a also includes a microphone manifold 418 having an opening 426 with a continuously increasing radius that may reduce or eliminate a Helmholtz resonance. The first electronics package 104a further includes a microphone cover adhesive layer 420 and a microphone cover 422. The microphone cover 422 includes numerous perforations 424 to allow sounds to pass through and be captured by the multiple microphones on the printed circuit board 408. The microphone cover 422 may be made of any suitable material, such as stainless steel, and the numerous perforations 424 may be created by chemical etching. In some embodiments a perforation has a diameter of approximately 150 microns.

The components of the first electronics package 104a may be attached or coupled using any suitable means, such as adhesives, mechanical fasteners, ultrasonic welding, and the like. Although not depicted in FIG. 4, the second electronics package 104b may include generally similar components as the first electronics package 104a.

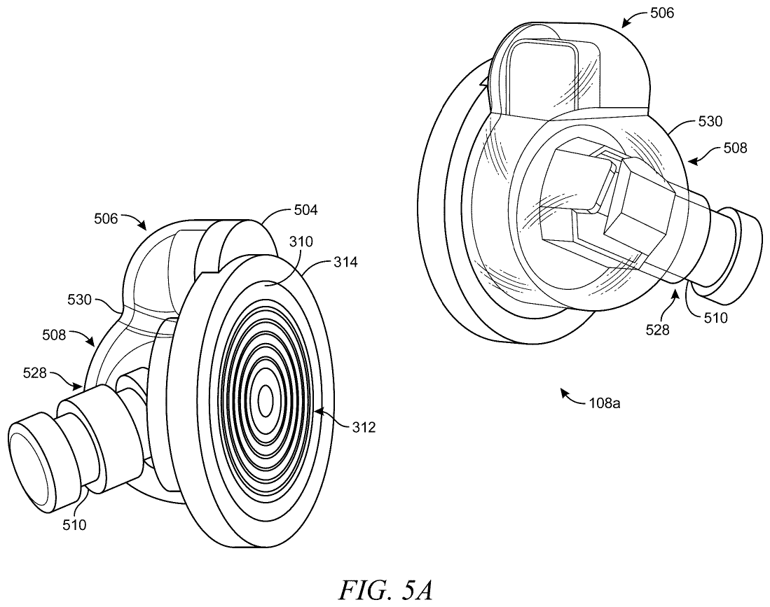

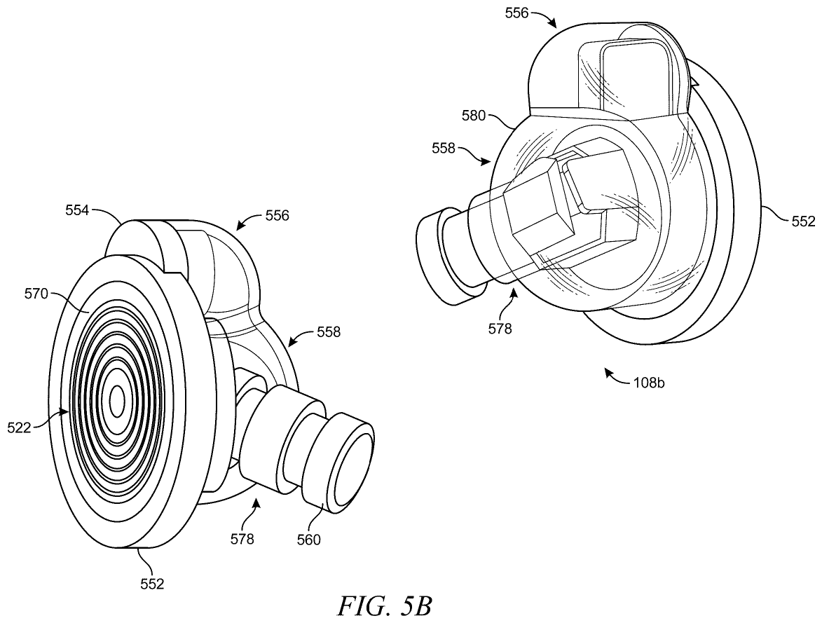

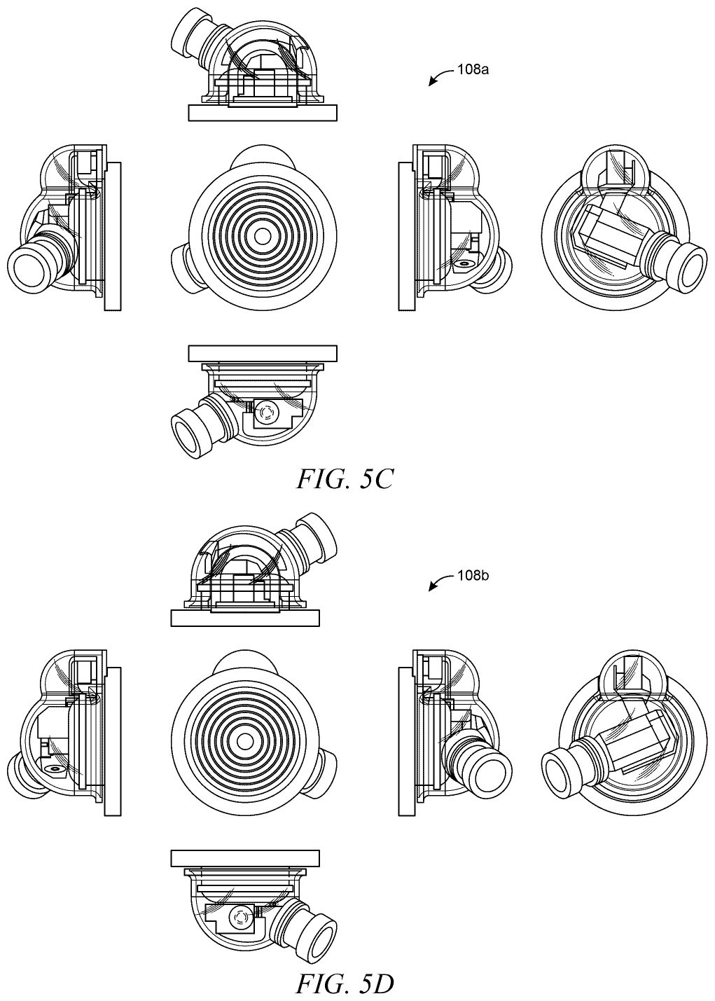

FIG. 5A depicts a front perspective view and a rear perspective view of the first acoustic package 108a. The first acoustic package 108a is for a left ear of a wearer. The first acoustic package 108a includes a housing 530 that includes a first housing portion 508 having a first partial generally capsule shape and a second housing portion 506 having a second partial generally capsule shape. The first partial generally capsule shape of the first housing portion 508 may include a first partial generally cylindrical portion and a first partial generally hemispherical portion. Similarly, the second partial generally capsule shape of the second housing portion 506 may include a second partial generally cylindrical portion and a second partial generally hemispherical portion.

The housing 530 also includes a third housing portion 528 having a generally cylindrical shape. Positioned within the housing 530 are various components including one or more speakers, such as a driver and a balanced armature. The housing 530 may be made of any suitable material, such as polycarbonate, and may be transparent, translucent, or opaque.

The first acoustic package 108a further includes the magnet 314, the connector 310, the first set of electrical contacts 312, and a cap 504. The first acoustic package 108a further includes a snout 510, a portion of which is positioned in the third housing portion 528.

FIG. 5B depicts a front perspective view and a rear perspective view of the second acoustic package 108b. The second acoustic package 108b is for a right ear of a wearer. The second acoustic package 108b includes a housing 580 that includes a first housing portion 558 having a first partial generally capsule shape and a second housing portion 556 having a second partial generally capsule shape. The first partial generally capsule shape of the first housing portion 558 may include a first partial generally cylindrical portion and a first partial generally hemispherical portion. Similarly, the second partial generally capsule shape of the second housing portion 556 may include a second partial generally cylindrical portion and a second partial generally hemispherical portion.

The housing 580 also includes a third housing portion 578 having a generally cylindrical shape. Positioned within the housing 580 are various components including one or more speakers, such as a driver and a balanced armature. The housing 580 may be made of any suitable material, such as polycarbonate, and may be transparent, translucent, or opaque.

The second acoustic package 108b further includes a magnet 552, a connector 570, a set of annular electrical contacts 522 on the connector 570, and a cap 554. The second acoustic package 108b further includes a snout 560, a portion of which is positioned in the third housing portion 578. The components of the first acoustic package 108a and the second acoustic package 108b may be attached or coupled using any suitable means, such as adhesives, mechanical fasteners, ultrasonic welding, and the like.

FIG. 5C depicts multiple views of the first acoustic package 108a, including a front elevational view, a rear elevational view, a left-side elevational view, a right-side elevational view, a top plan view, and a bottom plan view. Similarly, FIG. 5D depicts multiple views of the second acoustic package 108b, including a front elevational view, a rear elevational view, a left-side elevational view, a right-side elevational view, a top plan view, and a bottom plan view.

Example dimensions of the first acoustic package 108a are as follows. In front elevational view, the housing 530 may have a length from an extremity of the first housing portion 508 to an extremity of the second housing portion 506 of about approximately 16 mm to about approximately 18 mm, such as approximately 16.4 mm, the first housing portion 508 may have a width of about approximately 12 mm to about approximately 14 mm, such as approximately 13.1 mm, and the second housing portion 506 may have a width of about approximately 6 mm to about approximately 8 mm, such as approximately 7.3 mm. In side view, the housing 530 may have a height of about approximately 8 mm to about approximately 10 mm, such as approximately 8.8 mm. The third housing portion 578 may have an outside diameter of about approximately 4 mm to about approximately 6 mm, such as approximately 5.0 mm. The second acoustic package 108b may have similar example dimensions.

Other embodiments of the acoustic package may have a different shape. For example, in one embodiment, an acoustic package may have a housing that has an asymmetric teardrop shape in front elevational view. The housing of the acoustic package for the left ear may be larger towards the left of the housing and smaller towards the right of the housing in front elevational view. Similarly, the housing of the acoustic package for the right ear may be larger towards the right of the housing and smaller towards the left of the housing in front elevational view. Other shapes for the acoustic package that fit the anatomy of an ear are possible. Accordingly, the first acoustic package 108a may have any suitable configuration and corresponding dimensions that fits a left ear and the second acoustic package 108b may have any suitable configuration and corresponding dimensions that fits a right ear.

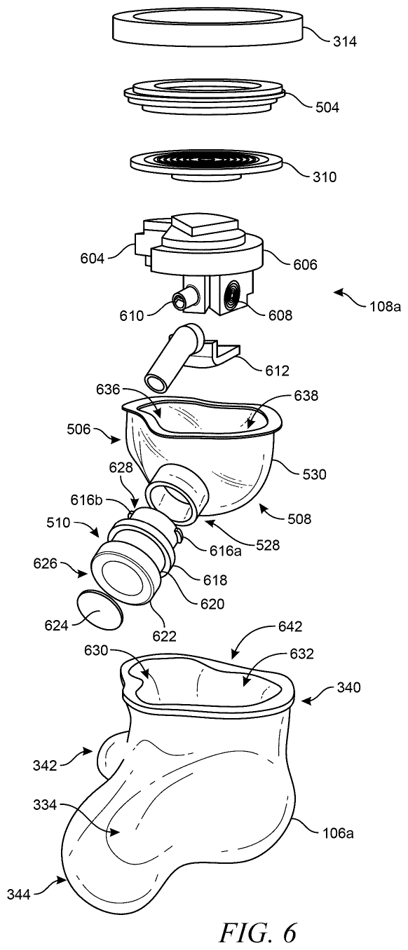

FIG. 6 is an exploded view of the first acoustic package 108a and the first ear interface 106a. The first acoustic package 108a includes the magnet 314, the cap 504, and the connector 310. The first acoustic package 108a also includes a flexible printed circuit board 604, a driver 606, a balanced armature 610, and an in-ear canal microphone 608. The first acoustic package 108a also includes a balanced armature port 612 into which a portion of the balanced armature 610 is positioned.

The in-ear canal microphone 608 may be utilized as an error reference microphone for feedback active noise cancellation. The driver 606 may serve as a woofer and may provide a suitable low-frequency response. The balanced armature 610 may serve as a tweeter and may provide a suitable high-frequency response. In some embodiments the first acoustic package 108a includes only analog components, which may allow for long usage of the first acoustic package 108a.

The first housing portion 508 and the second housing portion 506 of the housing 530 define a first housing cavity 638 and a second housing cavity 636. The flexible printed circuit board 604, the driver 606, the balanced armature 610, the in-ear canal microphone 608, and the balanced armature port 612 may be positioned at least partially in the first housing cavity 638 and the second housing cavity 636. The snout 510 is generally cylindrically shaped and includes a snout proximal portion 628 positioned at least partially within the third housing portion 528 and a snout distal portion 626. A first wing 616a and a second wing 616b positioned at the snout proximal portion 628 may function to secure the snout proximal portion 628 to the third housing portion 528.

The snout 510 further includes a first flange 618, an intermediate snout portion 620, and a second flange 622. The first flange 618 is positioned flush against the third housing portion 528. The snout 510 has a first opening at the snout proximal portion 628, a second opening at the snout distal portion 626, and a snout passage therebetween such that the sound emitted by driver 606 and the balanced armature 610 may pass through the first opening, the snout passage, and the second opening.

The snout 510 further includes one or more acoustic mesh layers 624, which may be made of any suitable material, such as stainless steel, and have oleophobic and hydrophobic properties. The one or more acoustic mesh layers 624 may provide suitable acoustic resistance so that the effect of external acoustics on the components of the first acoustic package 108a is reduced or eliminated. The one or more acoustic mesh layer 624 may also not interfere with sound generated by the first acoustic package 108a and allow air to pass through.

The first ear interface 106a includes the proximal portion 340, the upper portion 342, and the distal portion 344. The first ear interface 106a further includes a first opening 642 at the proximal portion 340 and a first cavity 632 and a second cavity 630 extending away, or inwardly, from the first opening 642. The first cavity 632 has a partial generally capsule shape generally matching the partial generally capsule shape of the first housing portion 508. The second cavity 630 has a partial generally capsule shape generally matching the second partial generally capsule shape of the second housing portion 556. The matching shapes of the first cavity 632 and the second cavity 630 allow the first acoustic package 108a to be positioned within the first ear interface 106a.

The first ear interface 106a further includes a second opening (not illustrated in FIG. 6) at the distal portion 344. Sound emitted by the driver 606 and the balanced armature 610 may pass through the passage 334 and the second opening.

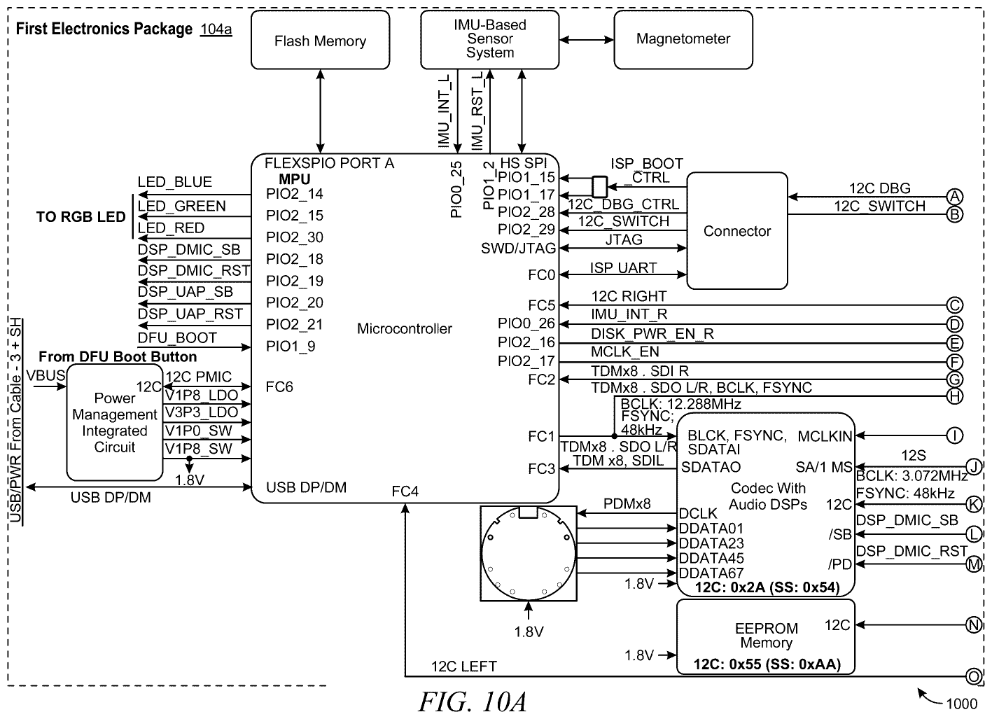

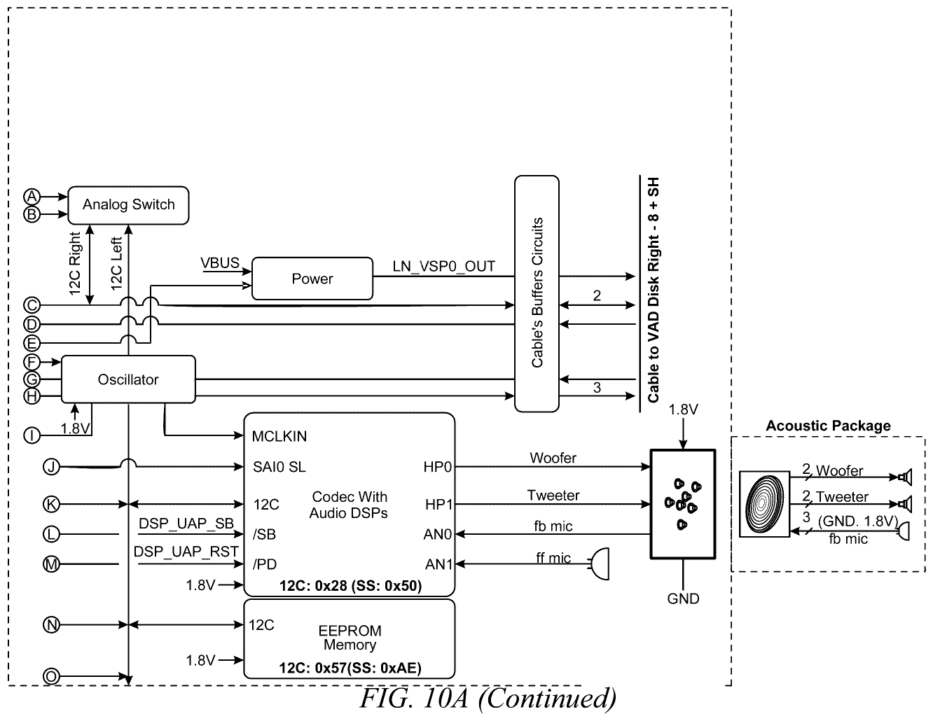

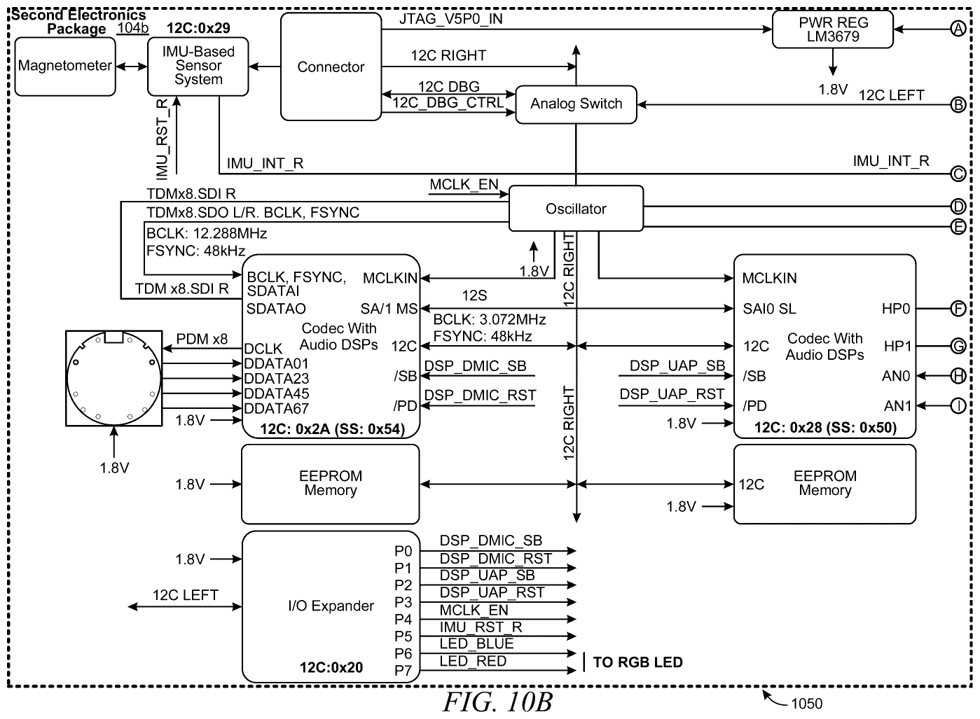

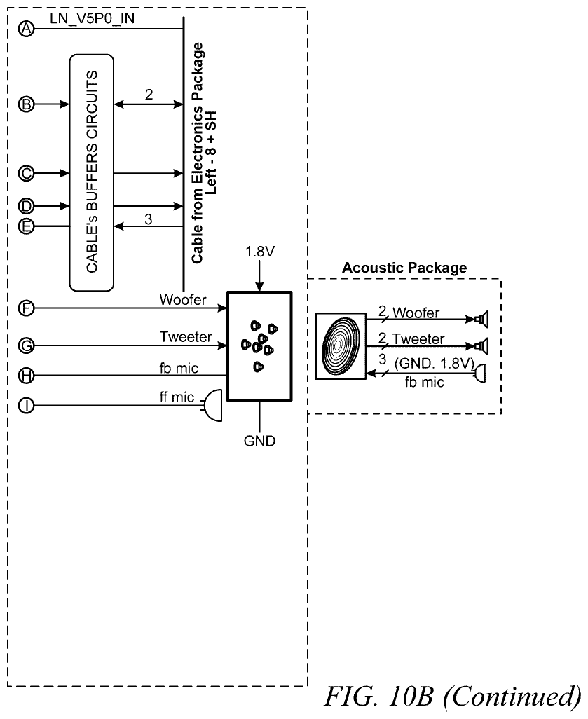

FIG. 10A is a logic block diagram 1000 of the first electronics package 104a. The logic block diagram 1000 depicts the first electronics package 104a as including multiple electronic components that perform various functions. The multiple electronic components include memory, both flash and EEPROM, an IMU-based sensor system, a magnetometer, a microcontroller which may include one or more processors, a power management integrated circuit, codecs with audio digital signal processors (DSPs), an oscillator, microphones, and switches. The various functions that the multiple electronic components may perform include receiving a digital audio signal, processing the audio signal by applying digital filters to the audio signal, generating an analog signal based on the processed digital signal, and providing the analog signal to first acoustic package 108a. The electronic components may perform functions other than those described herein.

FIG. 10B is another logic block diagram 1050 of the second electronics package 104b. The logic block diagram 1050 depicts the second electronics package 104b as including multiple electronic components that perform various functions. The multiple electronic components include EEPROM memory, an IMU-based sensor system, a magnetometer, codecs with audio DSPs, an oscillator, microphones, and a switch. The various functions that the multiple electronic components may perform include receiving a digital audio signal, processing the audio signal by applying digital filters to the audio signal, generating an analog signal based on the processed digital signal, and providing the analog signal to the second acoustic package 108b.

The memories of the first electronics package 104a and/or the second electronics package 104b may store instructions that may be executed by the microcontroller and/or the DSPs. In some embodiments, the memory may store virtual auditory display filters that the microcontroller processor and/or the DSPs may apply to audio signals that the first electronics package 104a and the second electronics package 104b receive.

One or more components of the first electronics package 104a and/or the second electronics package 104b (for example, the IMU-based sensor system, the magnetometer, an accelerometer, a gyroscope, or other suitable components) may be configured to capture head orientation data for a head orientation of a wearer of the first ear-worn device and the second ear-worn device. The memories of the first electronics package 104a and/or the second electronics package 104b may store instructions that when executed by the microcontroller and/or the DSPs may cause the microcontroller and/or the DSPs to determine the head orientation of the wearer based on the head orientation data captured by the one or more components.

The memories of the first electronics package 104a and/or the second electronics package 104b may store instructions that when executed by the microcontroller and/or the DSPs may also cause the microcontroller and/or the DSPs to perform active noise cancellation of the sounds of the wearer captured by the in-canal microphone in the first acoustic package 108a and/or the second acoustic package 108b and/or active noise cancellation of external sounds captured by the high signal-to-noise ratio analog microphone in the first electronics package 104a and/or the second electronics package 104b.

Electronic components of the first electronics package 104a, such as the microcontroller, may control electronic components of the second electronics package 104b. Accordingly, the first electronics package 104a may be considered as a primary electronics package and the second electronics package 104b may be considered as a secondary electronics package.

The virtual auditory display device 100 may interface with a virtual auditory display system as described herein to render virtual auditory display sound for a wearer. Virtual auditory display sound may be considered as immersive, panoramic sound that is capable of being perceived as emanating from any point in space surrounding the wearer. The virtual auditory display system may apply digital filters to a multi-channel audio signal to generate audio signals that are sent to the virtual auditory display device 100. The virtual auditory display device 100 generates, based on the audio signals, the virtual auditory display sound.

Virtual auditory display sound may be especially desirable for a music creator, who may create music with multiple channels (for example, 9.1.6). The music creator may use a digital audio workstation to create music. The music creator may then use the virtual auditory display system to apply digital filters to the music so that the music may be rendered as virtual auditory display sound by the virtual auditory display device 100. The virtual auditory display system may allow the music creator to apply different acoustic environment filters so that the virtual auditory display sound may be heard in different simulated acoustic environments (for example, in a car, in a night club).

The music creator may then remix or modify the music based on their hearing the music rendered as virtual auditory display sound. For example, the music creator may move the location of certain sounds, emphasize certain sounds, de-emphasize certain sounds, and the like. In this fashion, the music creator may utilize the virtual auditory display device 100 as part of an iterative process of creating music until the music creator achieves the desired effect for the music.

The virtual auditory display device 100 may switch between a transparency mode and an immersion mode by detecting interactions of the wearer with the virtual auditory display device 100. For example, the wearer may tap once on either the first electronics package 104a or the second electronics package 104b to cause the virtual auditory display device 100 to enter a transparency mode. In the transparency mode one or more microphones of the first electronics package 104a and the second electronics package 104b may capture external sounds, signals based on the captured external sounds may be generated, and the one or more speakers of the first acoustic package 108a and the second acoustic package 108b may output sound based on the generated signals.

As another example, the wearer may also tap twice on either the first electronics package 104a or the second electronics package 104b to cause the virtual auditory display device 100 to enter the immersion mode. In the immersion mode the first electronics package 104a and the second electronics package 104b may perform active noise cancellation on signals corresponding to sound captured by one or more microphones of the first electronics package 104a and the second electronics package 104b.

The virtual auditory display device 100 may provide other functionality enabled by components of the virtual auditory display device 100. For example, the arrays of microphones may enable the virtual auditory display device 100 to selectively amplify certain sounds and selectively cancel certain sounds. The DSPs may enable sound detection and the arrays of microphones may enable the virtual auditory display device 100 to locate detected sounds. The virtual auditory display device 100 may then amplify the detected sounds. As another example, the microphones of the virtual auditory display device 100 may enable active noise cancellation of sounds generated by the wearer, such as the wearer's voice. The virtual auditory display device 100 may also provide functionality other than what is described herein.

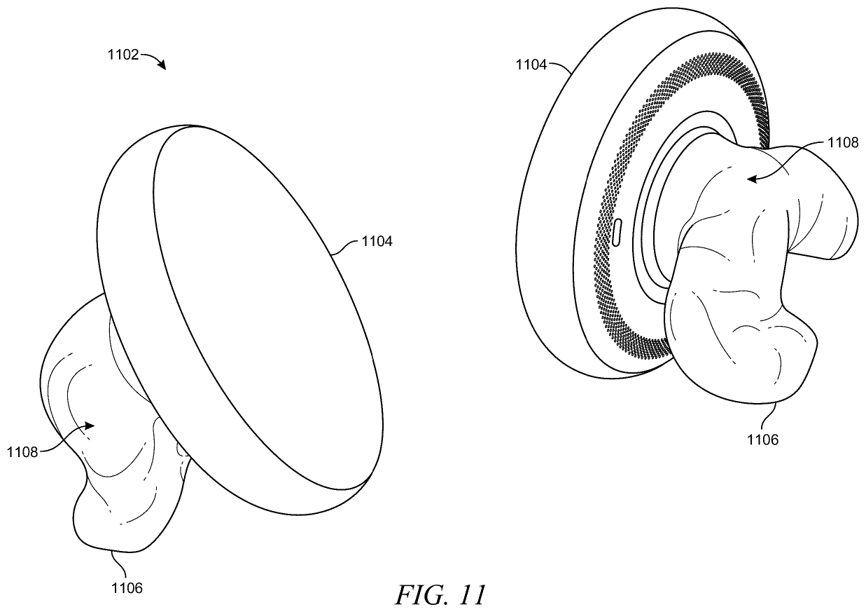

FIG. 11 depicts a front perspective view and a rear perspective view of an ear-worn device 1102 of another virtual auditory display device according to another embodiment. The ear-worn device 1102 is for a left ear of a wearer. The ear-worn device 1102 includes an electronics package 1104, an ear interface 1106, and an acoustic package 1108 (not illustrated in FIG. 11) positioned within the ear interface 1106. The virtual auditory display system may include the ear-worn device 1102 and another ear-worn device (not illustrated in FIG. 11) for the right ear of the wearer.

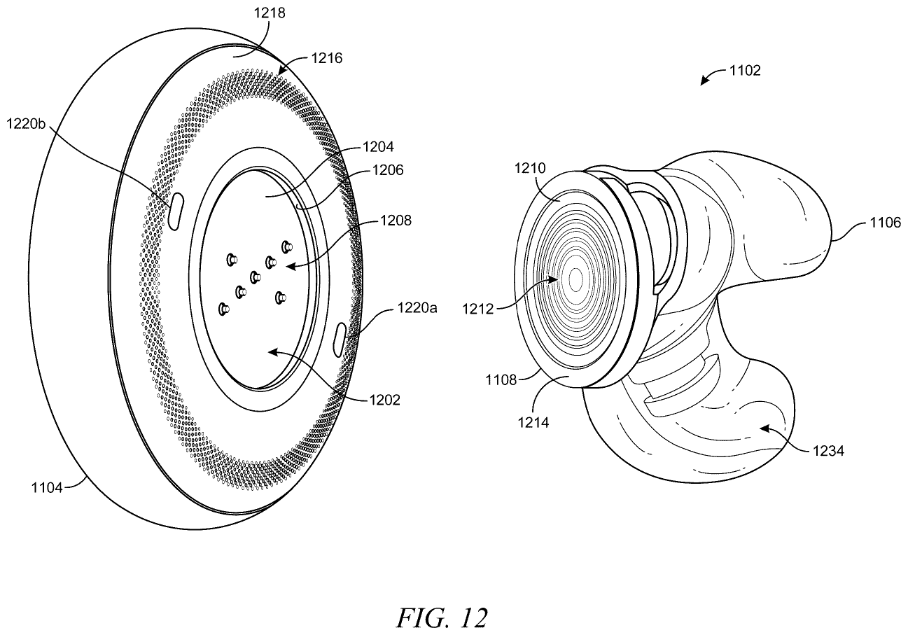

FIG. 12 is an exploded view of the ear-worn device 1102 showing the ear interface 1106, the acoustic package 1108, and the electronics package 1104. The acoustic package 1108 includes a connector 1210 having a generally planar surface. The connector 1210 includes a set of annular electrical contacts 1212 on the generally planar surface. In some embodiments, the set of annular electrical contacts 1212 includes seven annular electrical contacts. The acoustic package 1108 also includes a magnet 1214 having a generally hollow cylindrical shape. The ear interface 1106 and the acoustic package 1108 may be generally similar to the first ear interface 106a and the first acoustic package 108a, respectively, of the virtual auditory display device 100. Also depicted is a passage 1234 between a cavity of the ear interface 1106 and an opening at a distal portion of the ear interface 1106.

The electronics package 1104 includes a microphone cover 1218 including multiple perforations 1216, a first proximity sensor window 1220a and a second proximity sensor window 1220b. The electronics package 1104 also includes a magnet 1206 positioned inward relative to the microphone cover 1218. The microphone cover 1218 and the magnet 1206 form a generally cylindrical recess 1202 having a generally planar surface 1204. A set of electrical connectors 1208 extend outwards from the generally planar surface 1204. Each electrical connector is configured to connect with an electrical contact of the set of annular electrical contacts 1212. In some embodiments, the set of electrical connectors 1208 includes seven electrical connectors. In some embodiments, the set of electrical connectors 1208 includes a set of seven pogo pins.

The generally cylindrical recess 1202 has the same general shape as the magnet 1214 and the connector 1210. The electronics package 1104 may thus removably couple to the acoustic package 1108. The electronics package 1104 is removably magnetically coupleable to the acoustic package 1108 due to attractive magnetic forces between the magnet 1214 and the magnet 1206.

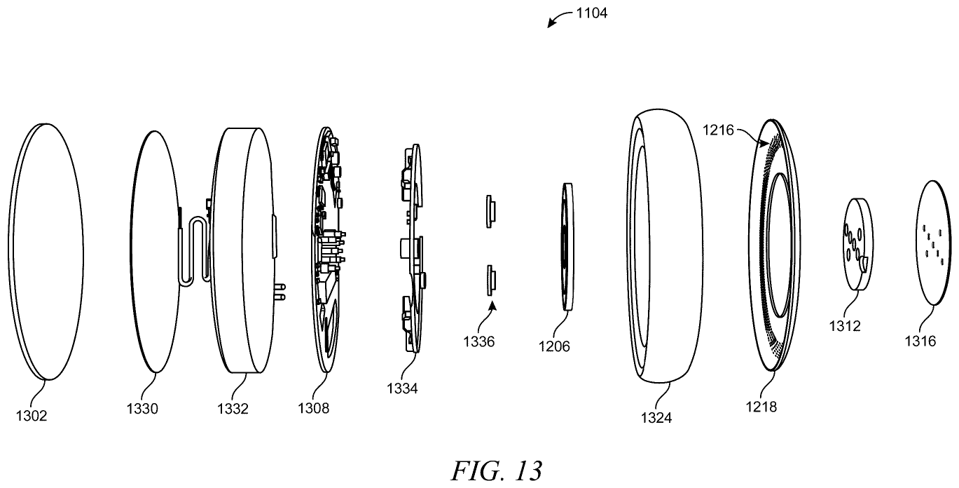

FIG. 13 is an exploded view of the electronics package 1104. From left to right, the electronics package 1104 includes a cap 1302. The cap 1302 may be made from glass or other suitable material that allows wireless signals to pass through the cap 1302. The cap 1302 may have a generally convex surface. In some embodiments, the cap 1302 may have a generally planar surface.

The electronics package 1104 also includes an antenna component 1330 and a battery 1332. The antenna component 1330 may include one or more antennas configured to receive and transmit wireless signals (for example, Wi-Fi, Bluetooth, cellular signals). The battery 1332 may be a pouch or coin cell battery and provide power to multiple electronics components of the electronics package 1104. The battery 1332 may be or include a rechargeable battery. In some embodiments, the electronics package 1104 may be removed from the ear-worn device and placed in a charging case having electrical contacts that connect with the set of electrical connectors 1208, so that the charging case may charge the electronics package 1104.

The electronics package 1104 also includes a printed circuit board 1308 which may include multiple electronics components such as a microcontroller, memory, codecs with audio digital signal processors (DSPs), multiple microphones, and the set of electrical connectors 1208. In some embodiments, the printed circuit board 1308 includes nine microphones. The electronics package 1104 further includes a circuit board 1334, which may include multiple electronics components such as an inertial measurement unit (IMU)-based sensor system (which may be referred to as an IMU), a magnetometer, and/or other sensors, such as accelerometers and/or gyroscopes to aid head orientations detections, and proximity sensors to detect proximity to a wearer. The electronics package 1104 further includes one or more sensor lenses 1336.

The electronics package 1104 also includes the magnet 1206 and a housing 1324 including a microphone manifold. The microphone manifold may have a continuously increasing radius like the microphone manifold 418 so as to reduce or eliminate a Helmholtz resonance. The electronics package 1104 further includes the microphone cover 1218, which includes the multiple perforations 1216. The multiple perforations 1216 allow sounds to pass through and be captured by the multiple microphones on the printed circuit board 1308. The microphone cover 1218 may be made of any suitable material, such as stainless steel, and the multiple perforations 1216 may be created by chemical etching. In some embodiments a perforation has a diameter of approximately 150 microns.

The electronics package 1104 further includes an electrical connector spacer 1312, which functions to space apart the electrical connectors of the set of electrical connectors 1208, and a glide film layer 1316, which functions to reduce a friction of the generally planar surface 1204.

Although not depicted in FIG. 13, the other electronics package of the other ear-worn device of the other virtual auditory display device may include generally similar components as the electronics package 1104.

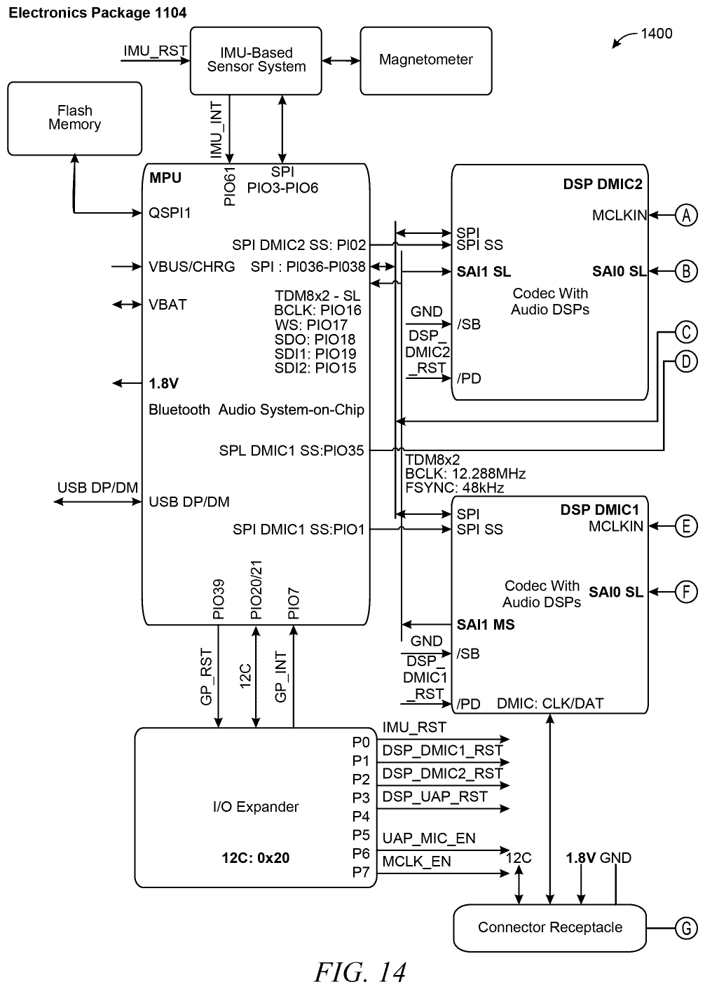

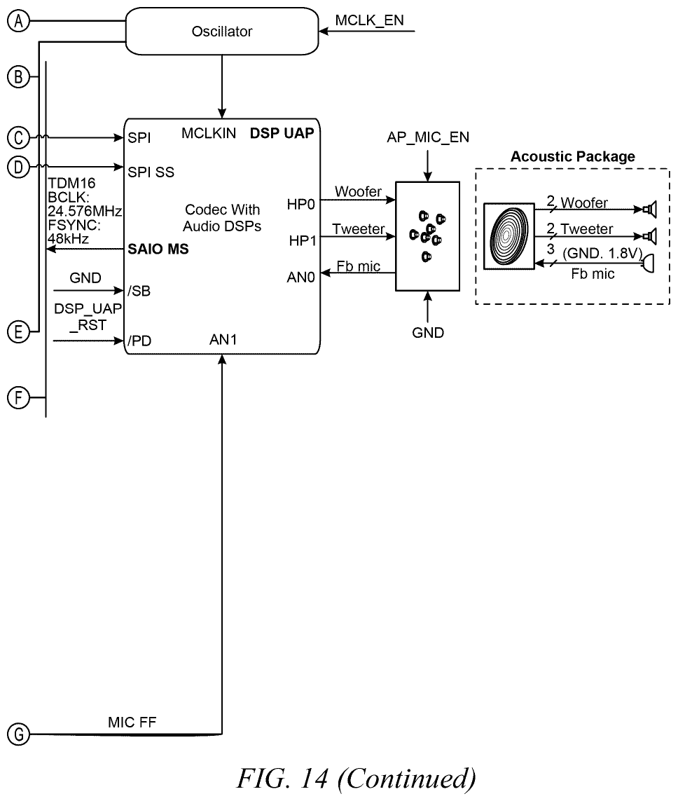

FIG. 14 is a logic block diagram 1400 of components of the electronics package 1104. The logic block diagram 1400 depicts the electronics package 1104 including multiple electronic components that perform various functions. The multiple electronic components include flash memory, an IMU-based sensor system, a magnetometer, a system-on-chip (SOC), codecs with audio digital signal processors (DSPs), an oscillator, and a switch. The various functions that the multiple electronic components may perform include receiving a digital audio signal, processing the audio signal by applying digital filters to the audio signal, generating an analog signal based on the processed digital signal, and providing the analog signal to the second acoustic package 108b. The electronic components may perform functions other than those described herein.

The other virtual auditory display device that comprises the ear-worn device 1102 and a corresponding ear-worn device for the right ear may provide the same functionality as the virtual auditory display device 100. In addition, the other virtual auditory display device may provide acoustic zoom functionality that may be static, adaptive, or directional. For example, the other virtual auditory display device may enhance sounds based on a head orientation of the wearer. As another example of additional functionality, the other virtual auditory display device may provide gradual noise cancellation when starting or playing sound received from another device. Other functionality will be apparent.

In addition, the electronics package 1104 of the ear-worn device 1102 may be rotatable relative to the acoustic package 1108. The ear-worn device 1102 may thus provide a rotatable user interface for the wearer. The wearer may thus rotate the electronics package 1104 to cause the ear-worn device to perform certain functions, such as to adjust a sound volume. Other functionality will be apparent.

As described herein, an acoustic package (for example, the first acoustic package 108a) may be removed from the ear interface (for example, the first ear interface 106a). The ear interface may be made of a material (for example, silicone) that may be subject to degradation from use. On some occasions, the acoustic package may not be positioned within the ear interface as securely as desired. Accordingly, a mechanism for further securing the acoustic package within the ear interface may be desirable.

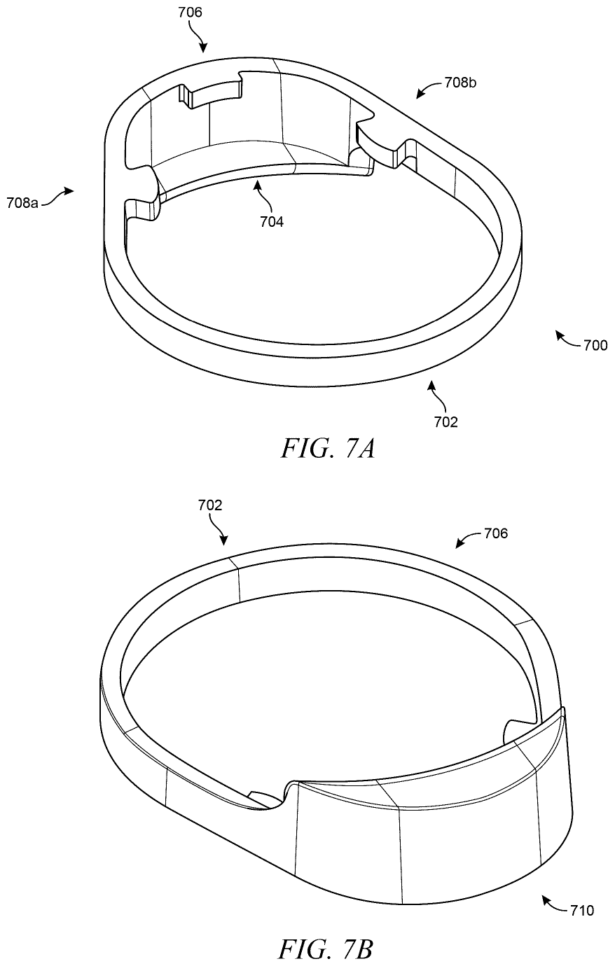

FIG. 7A is a rear bottom perspective view and FIG. 7B is a front top perspective view of a collar 700 for an ear-worn device in some embodiments. The collar 700 includes a strap portion 702 having a generally annular shape. A lifter portion 710 and a shelf portion 704 is opposite the apex of the strap portion 702. Protruding from the lifter portion 710 is a first wing portion 706. Protruding from the strap portion 702 is a second wing portion 708a and a third wing portion 708b.

The collar 700 is removably coupleable to the first ear interface 106a. When coupled to the first ear interface 106a, the collar 700 extends generally circumferentially around the proximal portion 340 proximate to the first opening 642. The shelf portion 704 abuts the cap 554 and the lifter portion 710 abuts a portion of the first ear interface 106a. The inner perimeter of the collar 700 may be generally the same or slightly smaller than the outer perimeter of the proximal portion 340 proximate to the first opening 642, so as to result in the collar 700 exerting pressure upon the proximal portion 340.

A function of the collar 700 is to further secure the first acoustic package 108a in the first ear interface 106a. The first wing portion 706, the second wing portion 708a, and the third wing portion 708b may mate with corresponding notches or grooves in the proximal portion 340 and assist with the securing function. Accordingly, the collar 700 may further secure the first acoustic package 108a within the first ear interface 106a. The collar 700 may also be used with the second ear interface 106b and the other ear interfaces described herein.

The ear interfaces described herein may provide a generally sealed acoustic fit between the ear interface and the ear in which the ear interface is positioned. The generally sealed acoustic fit may prevent exterior noises from reaching the ear canal, thus preventing exterior noises from interfering with the sound produced by the acoustic package.

However, changes in air pressure, such as when the wearer of a virtual auditory display device is changing elevation (for example, when the wearer is traveling in an airplane) may affect the sound produced by the acoustic package. For example, the dynamic driver may become pinned and unable to move, thus affecting the low frequency response of the acoustic package.

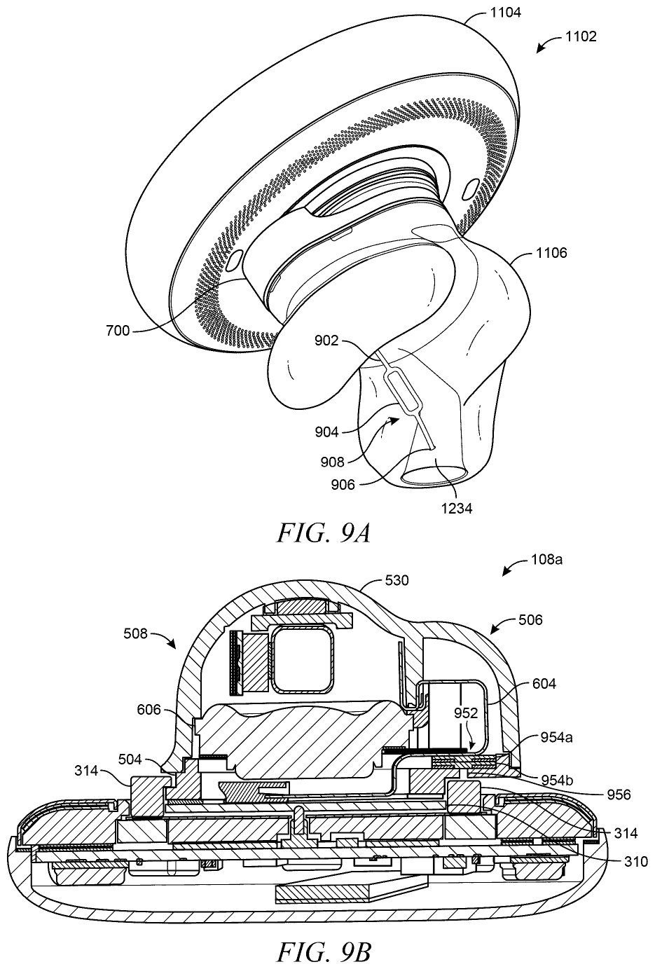

FIG. 9A is a rear perspective view of the ear-worn device 1102 including the collar 700, the electronics package 1104, the ear interface 1106, and a pressure-equalization vent 908 in the ear interface 1106 in some embodiments. The pressure-equalization vent 908 includes a first opening (not depicted in FIG. 9A) at an exterior of the ear interface 1106. For example, the first opening may be at a middle portion of the ear interface 1106 between the proximal portion and the distal portion.

The pressure-equalization vent 908 also includes a second opening 906 at the passage 1234 and a passage 902 between the first opening and the second opening 906. The diameter of the first opening or the second opening 906 may be approximately 0.1 mm. The diameter of the first opening or the second opening 906 may be approximately 0.1 mm, although the diameter of the first opening or the second opening may have other suitable sizes to allow for air passage. The passage 902 may have a diameter of approximately 0.1 mm at certain portions of the passage 902. A hollow plug 904 is positioned in the passage 902. The hollow plug 904 may function to ensure that air may travel through the passage 902. Air may pass through the first opening, the passage 902, and the second opening 906 to allow for static air pressure equalization between an air pressure in an ear canal of the wearer and an exterior air pressure without affecting the sound produced by the acoustic package. Furthermore, the pressure-equalization vent 908 may be sized to prevent undue ingress of particulate matter.

Although FIG. 9A depicts the pressure-equalization vent 908 having the second opening 906 in the passage 1234, the second opening 906 may be in the first cavity 632, in the second cavity 630, or in another suitable cavity in the ear interface 1106. The first opening may be at any suitable position in the ear interface 1106. Accordingly, the pressure-equalization vent 908 may be in any suitable position in the ear interface 1106 that allows for static air pressure equalization and provides acoustic resistance.

The pressure-equalization vent 908 may have any passage size or combination of passage sizes that allows for air flow between the exterior and the cavities of the ear interface 1106 while maintaining the desired acoustic resistance properties. Furthermore, in some embodiments, the pressure-equalization vent 908 may include one or more layers of acoustic mesh. For example, the pressure-equalization vent 908 may have a passage size larger than 0.1 mm and include one or more layers of acoustic mesh. It will be appreciated that the pressure-equalization vent 908 may have varying passage sizes and/or configurations to allow for the passage of air while achieving desired acoustic resistance properties.

FIG. 9B is a cross-sectional view of the first acoustic package 108a having another pressure-equalization vent 952 in the cap 504 in some embodiments. The pressure-equalization vent 952 is positioned in the cap 504 of the first acoustic package 108a. The pressure-equalization vent 952 includes a passage 956 in the cap 504 in a portion of the cap 504 that is proximate to the magnet 552. The passage 956 may have a diameter of about 0.4 mm to about 0.5 mm, such as approximately 0.44 mm. The pressure-equalization vent 952 also includes a first opening proximate to the flexible printed circuit board 604 and a second opening proximate to the magnet 314.

The pressure-equalization vent 952 may also include a first layer of acoustic mesh 954a and a second layer of acoustic mesh 954b. The acoustic mesh 954a and the acoustic mesh 954b are positioned between the cap 504 and the flexible printed circuit board 604. Each layer of acoustic mesh may be generally circular and have a rayl value of 900. The two layers of acoustic mesh may function as acoustic resistors that prevent interference from external noises while still allowing air to pass through the passage 956. The layers of acoustic mesh act as acoustic resistors in parallel, so that their values are additive. Acoustic meshes that have other rayl values may be utilized in some embodiments to provide the desired acoustic resistance. The pressure-equalization vent 952 may allow for static air pressure equalization between an air pressure in the second housing portion 506 of the housing 530 and an exterior air pressure without unduly affecting the acoustic performance of the first acoustic package 108a or allowing undue transmission of unwanted acoustic energy. Furthermore, the pressure-equalization vent 952 may be sized to prevent undue ingress of particulate matter.

The configuration of the pressure-equalization vent 952 may be varied to achieve static pressure equalization across a range of operational environments for the first acoustic package 108a, while providing sufficient resistance to acoustic energy. For example, the diameter of the passage 956 may be reduced and total resistive value of the one or more layers of acoustic mesh may be reduced in order to achieve these objectives. As another example, the diameter of the passage 956 may be increased and the number of layers of acoustic mesh may be increased in order to achieve these objectives. It will be appreciated that the pressure-equalization vent 952 may have varying passage sizes and/or configurations to allow for the passage of air while achieving desired acoustic resistance properties.

Although FIG. 9B depicts the pressure-equalization vent 952 as in the cap 504, the pressure-equalization vent 952 may be in any suitable position in the first acoustic package 108a that allows for static air pressure equalization and provides acoustic resistance.

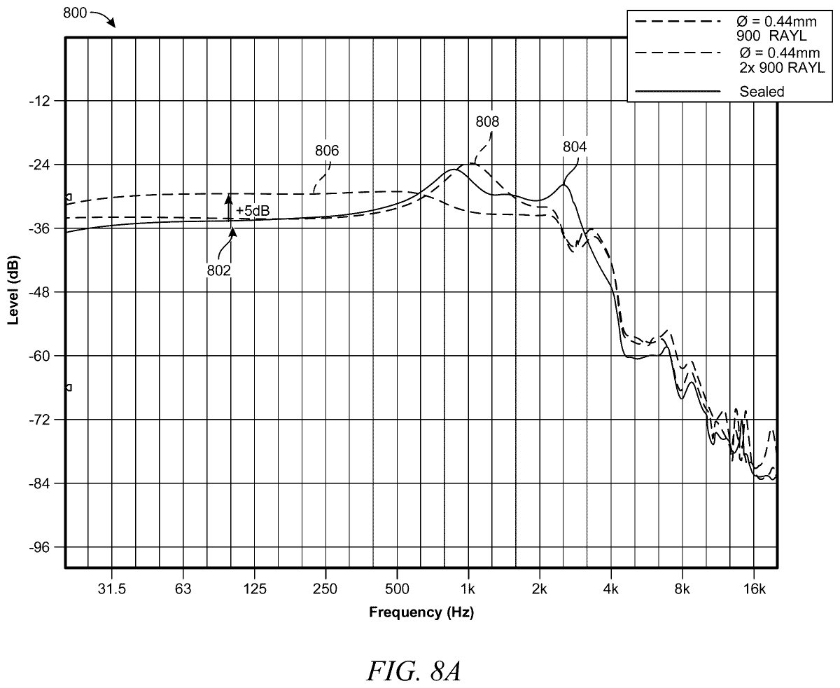

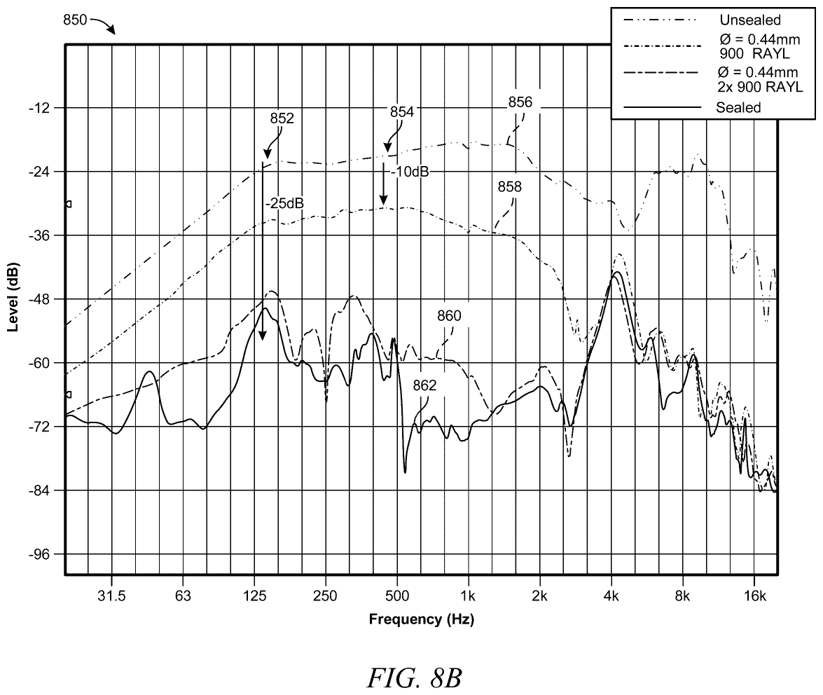

FIG. 8A is a graph 800 depicting frequency responses of multiple audio signals for acoustic packages according to various embodiments. A first audio signal 804 is for a first acoustic package without the pressure-equalization vent 952. A second audio signal 806 is for a second acoustic package with the pressure-equalization vent 952, having a single layer of acoustic mesh having a rayl value of 900. A third audio signal 808 is for a third acoustic package with the pressure-equalization vent 952 having two layers of acoustic mesh, each layer having a rayl value of 900.

The graph 800 indicates a difference in level between the second audio signal 806 and the third audio signal 808 of approximately five (5) decibels (dB) at a frequency region 802 between 63 hertz (Hz) and 125 Hz. Accordingly, the third acoustic package has an improved frequency response relative to that of the second acoustic package. However, the graph 800 indicates that that each of the frequency response of the second audio signal 806 and the frequency response of the third audio signal 808 generally corresponds to the frequency response of the first audio signal 804 throughout wide ranges of frequencies.

FIG. 8B is a graph 850 depicting frequency responses of multiple audio signals for acoustic packages according to various embodiments. A first audio signal 862 is for a first acoustic package without the pressure-equalization vent 952. A second audio signal 856 is for a second acoustic package with the pressure-equalization vent 952 but without any layers of acoustic mesh. A third audio signal 858 is for a third acoustic package with the pressure-equalization vent 952 having a single layer of acoustic mesh having a rayl value of 900. A fourth audio signal 860 is for a fourth acoustic package with the pressure-equalization vent 952 having two layers of acoustic mesh, each layer having a rayl value of 900.

The graph 850 indicates a difference in level between the second audio signal 856 and the first audio signal 862 of approximately 25 dB at a frequency region 852 between approximately 125 Hz and approximately 250 Hz. Accordingly, the frequency response of the second acoustic package does not track the frequency response of the first acoustic package well in the frequency region 852.

The graph 850 further indicates a difference in level between the second audio signal 856 and third audio signal 858 of approximately 10 dB at a frequency region 854 between approximately 250 Hz and approximately 500 Hz. Accordingly, the third acoustic package, with the pressure-equalization vent 952 having a single layer of acoustic mesh, has an improved frequency response relative to that of the second acoustic package with the pressure-equalization vent 952 but without any layers of acoustic mesh.

The graph 850 further indicates the frequency response of the fourth audio signal 860 generally corresponds to the frequency response of the first audio signal 862. Accordingly, the fourth acoustic package, with the pressure-equalization vent 952 having a double layer of acoustic mesh, has an improved frequency response relative to that of the second acoustic package and the third acoustic package.

Therefore, an ear-worn device having one or more pressure-equalization vents such as the pressure-equalization vent 908 and the pressure-equalization vent 952 may have desirable acoustic properties. Such an ear-worn device may be able to maintain a quality of the audio produced by the ear-worn device while blocking external sounds from being heard by a wearer and interfering with the audio.

Furthermore, an ear-worn device with one or more pressure-equalization vents such as the pressure-equalization vent 908 and the pressure-equalization vent 952 may allow for air pressure differentials between an air pressure in the cavities of the ear-worn device and an external air pressure to be reduced or eliminated. Such an ear-worn device may thus be more comfortable to wear during times when a wearer may experience changes in air pressure, such as when traveling in an airplane.

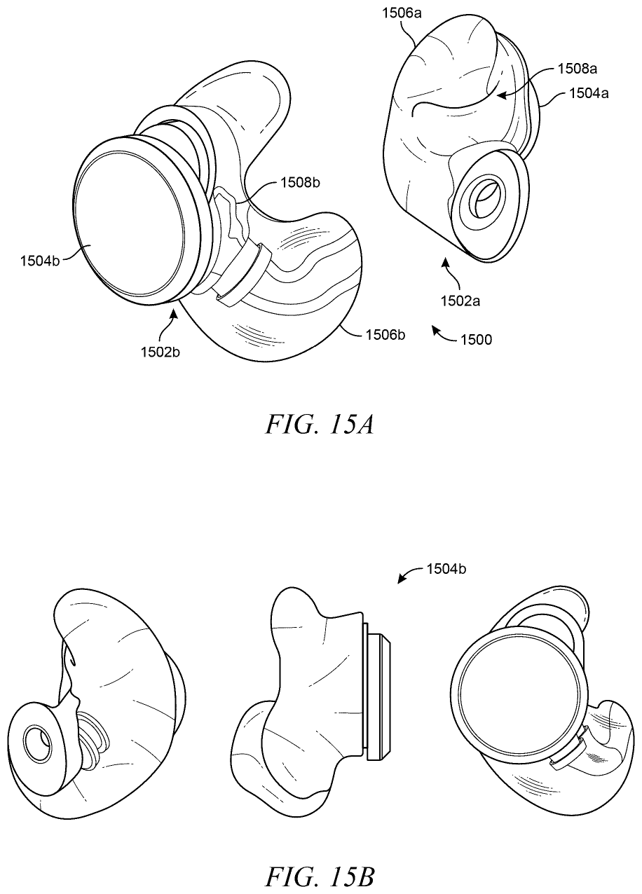

FIGS. 15A and 15B depict a virtual auditory display device 1500 according to another embodiment. The virtual auditory display device 1500 includes a first ear-worn device 1502a and a second ear-worn device 1502b. The first ear-worn device 1502a is for a left ear of a wearer and the second ear-worn device 1502b is for a right ear of the wearer.

Each of the first ear-worn device 1502a and the second ear-worn device 1502b includes an electronics package (shown as a first electronics package 1504a and a second electronics package 1504b), an ear interface (shown as a first ear interface 1506a and a second ear interface 1506b), and an acoustic package (shown individually as a first acoustic package 1508a and a second acoustic package 1508b). Certain components of each of the first ear-worn device 1502a and the second ear-worn device 1502b may be generally similar to certain components of the ear-worn device 1102 of FIG. 11.

The virtual auditory display device 1500 may be utilized for various purposes, such as providing passive noise protection for military personnel and first responders, as well as active noise enhancement. The virtual auditory display device 1500 may provide additional functionality.

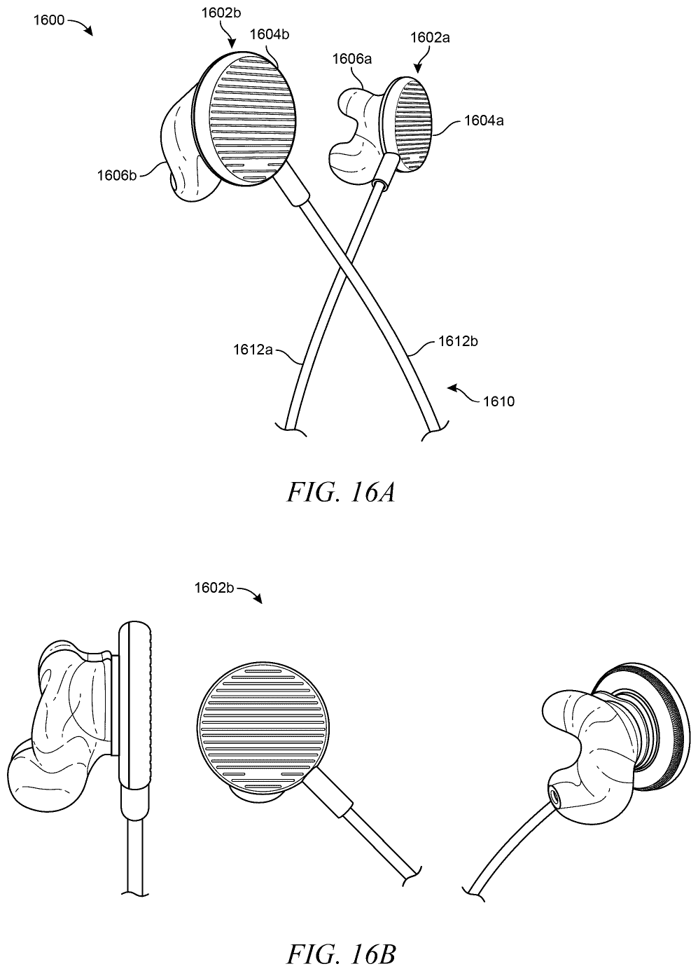

FIGS. 16A and 16B depict multiple views of a virtual auditory display device 1600 according to another embodiment. The virtual auditory display device 1600 includes a first ear-worn device 1602a, a second ear-worn device 1602b, and a cable 1610 that includes a first cable portion 1612a and a second cable portion 1612b. The first ear-worn device 1602a includes a first electronics package 1604a to which the first cable portion 1612a is connected, a first ear interface 1606a, and a first acoustic package (not illustrated in FIGS. 16A and 16B) positioned within the first ear interface 1606a that is removably magnetically coupleable to the first electronics package 1604a. The second ear-worn device 1602b also includes a second electronics package 1604b to which the second cable portion 1612b is connected, a second ear interface 1606b, and a second acoustic package (not illustrated in FIGS. 16A and 16B) positioned within the second ear interface 1606b that is removably magnetically coupleable to the second electronics package 1604b.

Certain components of each of the first ear-worn device 1602a and the second ear-worn device 1602b may be generally similar to certain components of the first ear-worn device 102a and of the second ear-worn device 102b of FIG. 1A.

The virtual auditory display device 1600 may be utilized for various purposes, such as for providing hyper-realistic training of military personnel and facilitating multi-threaded communications amongst military personnel.

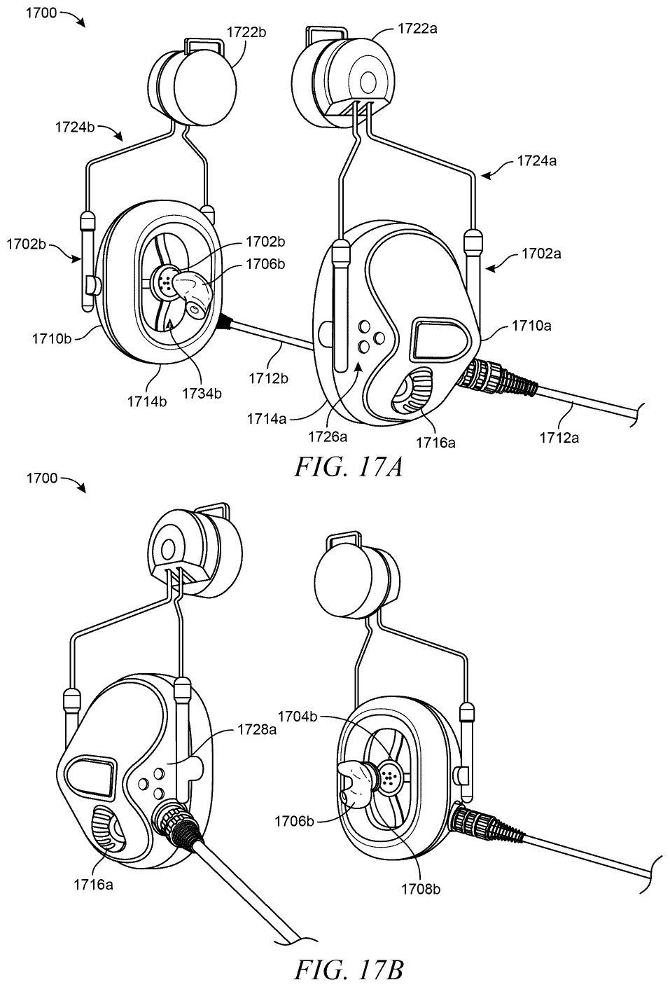

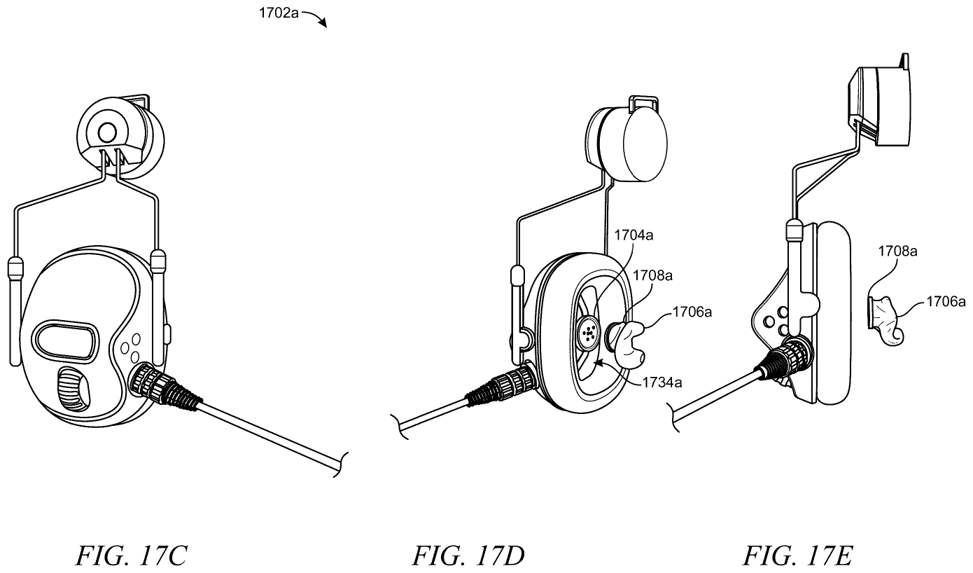

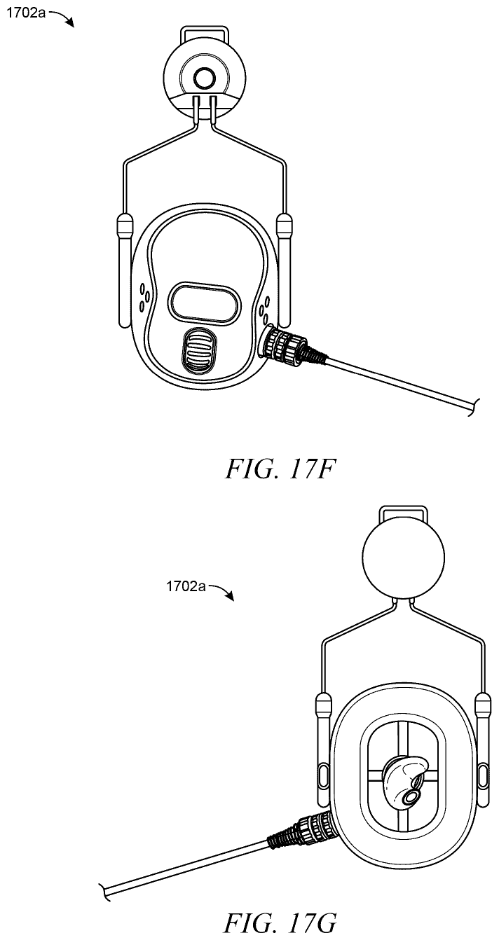

FIGS. 17A and 17B depict a front perspective view and a rear perspective view, respectively, of a virtual auditory display device 1700 including a first ear-worn device 1702a and a second ear-worn device 1702b according to an embodiment. FIGS. 17C through 17G depict views of the first ear-worn device 1702a. The first ear-worn device 1702a includes a main housing 1710a that includes a first set of microphones 1726a, a second set of microphones 1728a, and a volume control knob 1716a. The first ear-worn device 1702a also includes a compute housing 1722a connected to the main housing 1710a by multiple rigid connectors 1724a. The first ear-worn device 1702a also includes a first cable 1712a.

The first ear-worn device 1702a also includes an ear cup 1714a coupled to the main housing 1710a. A first electronics package 1704a is positioned in a center of the ear cup 1714a and is coupled to the ear cup 1714a by multiple bands 1734a. The first ear-worn device 1702a also includes a first ear interface 1706a that includes a first acoustic package 1708a.

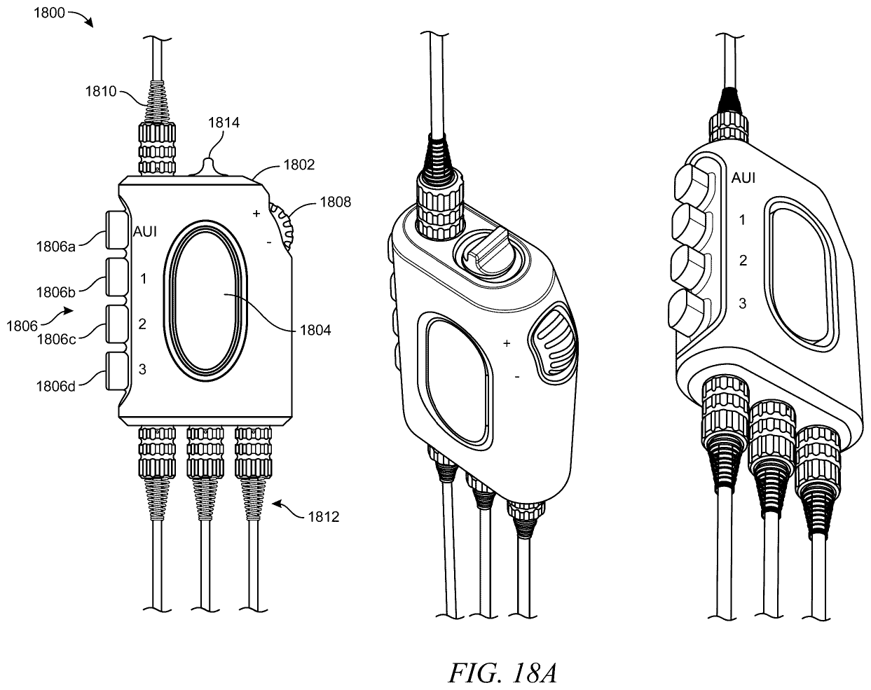

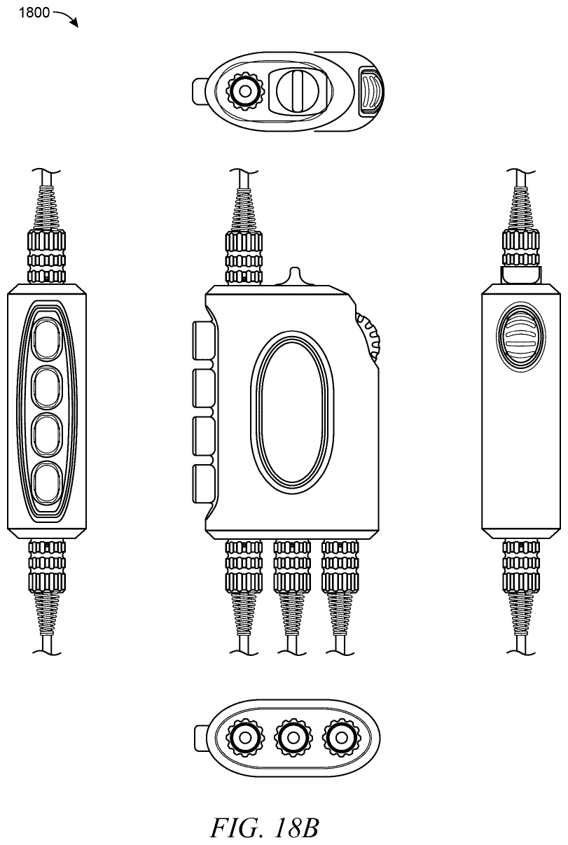

The second ear-worn device 1702b includes a main housing 1710b, an ear cup 1714b coupled to the main housing 1710b, and a compute housing 1722b connected to the main housing 1710b by multiple rigid connectors 1724b. The second ear-worn device 1702b also includes two sets of microphones and a volume control knob (not illustrated in FIGS. 17C through 17G) on the main housing 1710b. The second ear-worn device 1702b also includes a second electronics package 1704b, multiple bands 1734b, and a second ear interface 1706b containing a second acoustic package 1708b. The second ear-worn device 1702b also includes a second cable 1712b. The first cable 1712a and the second cable 1712b may join at a junction and the joined cable may connect to another device, such as a controller described with reference to, for example, FIGS. 18A and 18B.

The first electronics package 1704a and the second electronics package 1704b may be generally similar to the electronics package 1104 of the ear-worn device 1102 of FIG. 11. Similarly, the first acoustic package 1708a and the second acoustic package 1708b may be generally similar to the acoustic packages of the other virtual auditory display devices described herein.

Each of the compute housing 1722a and the compute housing 1722b may include multiple electronics components (for example, one or more processors, memory). The electronics package of the first ear-worn device 1702a may be electrically connected to the multiple electronics components of the compute housing 1722a. The second electronics package 1704b may be electrically connected to the multiple electronics components of the compute housing 1722b. Compute functionality may be shared between the electronics package and the multiple electronics components in the compute housing.

A wearer may insert the first ear interface 1706a into a left ear and the second ear interface 1706b into a right ear. The wearer may then place the first ear-worn device 1702a over the wearer's left ear and the second ear-worn device 1702b over the wearer's right ear, and the attractive magnetic forces between the first acoustic package 1708a and the first electronics package 1704a and between the second acoustic package 1708b and the second electronics package 1704b will cause the first acoustic package 1708a and the first electronics package 1704a to couple together and the second acoustic package 1708b and the second electronics package 1704b to couple together.

The generally sealed acoustic fit of the first ear interface 1706a and of the second ear interface 1706b, in combination with the ear cup 1714a and the ear cup 1714b, may provide passive ear protection for a wearer of the first ear-worn device 1702a and the second ear-worn device 1702b. The microphones on the main housing 1710a and the main housing 1710b may capture external sounds and use active noise cancellation technology to provide active ear protection for the wearer.

Additionally or alternatively, the first ear-worn device 1702a and/or the second ear-worn device 1702b may amplify external sounds captured by the microphones. The virtual auditory display device 1700 may thus enhance the hearing of the wearer of the first ear-worn device 1702a and the second ear-worn device 1702b, allowing the wearer to hear sounds that the wearer may not otherwise hear.

FIGS. 18A and 18B depict multiple views of a controller 1800 for the virtual auditory display device 1700 of FIGS. 17A through 17G. The controller 1800 includes a housing 1802 which includes a switch 1814, a volume control knob 1808, a push-to-talk button 1804, and multiple control buttons 1806. A first cable 1810 may be coupled to the controller 1800 and extend to the junction of the first cable 1712a and the second cable 1712b of the virtual auditory display device 1700. A set 1812 of multiple cables may also be coupled to the controller 1800 and to other devices (not illustrated in FIGS. 18A and 18B) that provide audio to the controller 1800, such as communications devices.

A wearer of the virtual auditory display device 1700 may turn the controller 1800 on and off using the switch 1814 and adjust an audio volume using the volume control knob 1808. When on, the controller 1800 may control audio interactions that a wearer of the virtual auditory display device 1700 may have. For example, the virtual auditory display device 1700 may have a transparency mode and an active noise cancellation mode. The wearer may select the transparency mode by selecting a button 1806a labeled “AUI” (auditory user interface). In this mode the virtual auditory display device 1700 may enhance the sounds captured by the first set of microphones on the virtual auditory display device 1700, thereby allowing the wearer to hear sounds that the wearer may not otherwise hear.

The wearer may also select either a button 1806b labeled “1”, a button 1806c labeled “2”, or a button 1806d labeled “3”. Selecting one of these three buttons may switch the virtual auditory display device 1700 into the active noise cancellation mode and cause the virtual auditory display device 1700 to emit audio received from an external device corresponding to the selected button. The wearer may push the push-to-talk button 1804 to transmit communications to the external device.

The form factor, ergonomics, and ability to switch between an enhanced hearing mode and multiple communications channels may make the virtual auditory display device 1700 and the controller 1800 suitable for challenging use cases, such as military use cases.

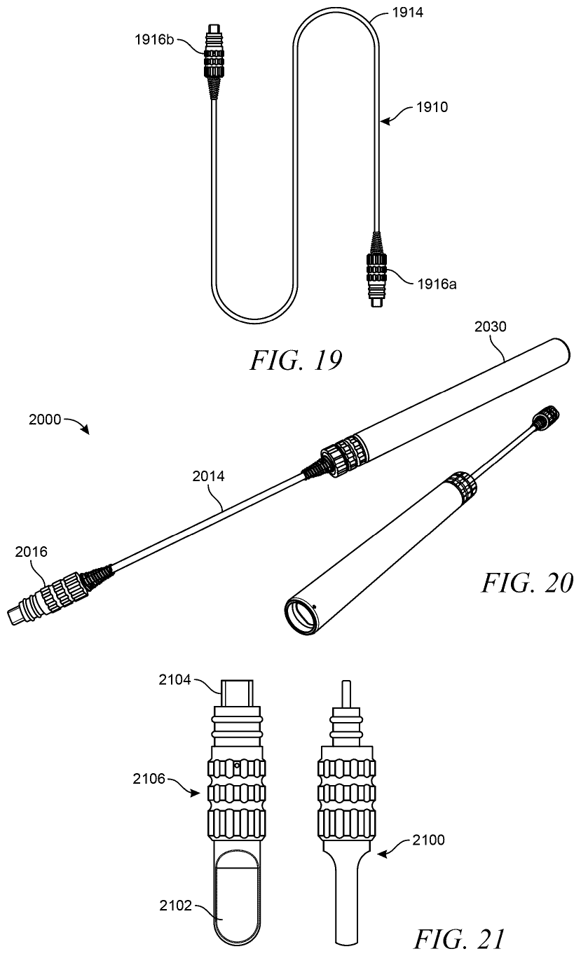

FIG. 19 depicts a cable 1910 that may be utilized with the virtual auditory display device 1700 and the controller 1800. The cable 1910 includes a first connector 1916a, a second connector 1916b, and a cable portion 1914. In some embodiments, the first connector 1916a and the second connector 1916b include USB-C connectors. The cable 1910 may provide power, data and communications interconnectivity for the virtual auditory display device 1700 and/or the controller 1800. For example, the first connector 1916a may be plugged into the controller 1800 and the second connector 1916b may be plugged into an external device, such as a communications device (for example, a military radio).

FIG. 20 depicts a battery assembly 2000 that may be utilized with the controller 1800 and the virtual auditory display device 1700. The battery assembly 2000 includes a battery housing 2030, a cable portion 2014, and a connector 2016. In some embodiments, the battery housing 2030 is sized to include AAA batteries. Additionally or alternatively, the battery housing 2030 may include lithium chemistry batteries. The connector 2016 may be plugged into the virtual auditory display device 1700 and/or the controller 1800 to provide an external power source in addition to the internal power sources of these devices.

FIG. 21 depicts a wireless communications device 2100 in some embodiments. The wireless communications device 2100 includes a connector 2104, a body portion 2106, and an end portion 2102. The wireless communications device 2100 may include wireless communications components such as Wi-Fi, Bluetooth, and/or cellular communications components. The wireless communications device 2100 may be connected to the virtual auditory display device 1700 and/or the controller 1800 and facilitate wireless communications between the device the wireless communications device 2100 is plugged into and any other device capable of wireless communications, such as another device into which another wireless communications device 2100 is plugged.

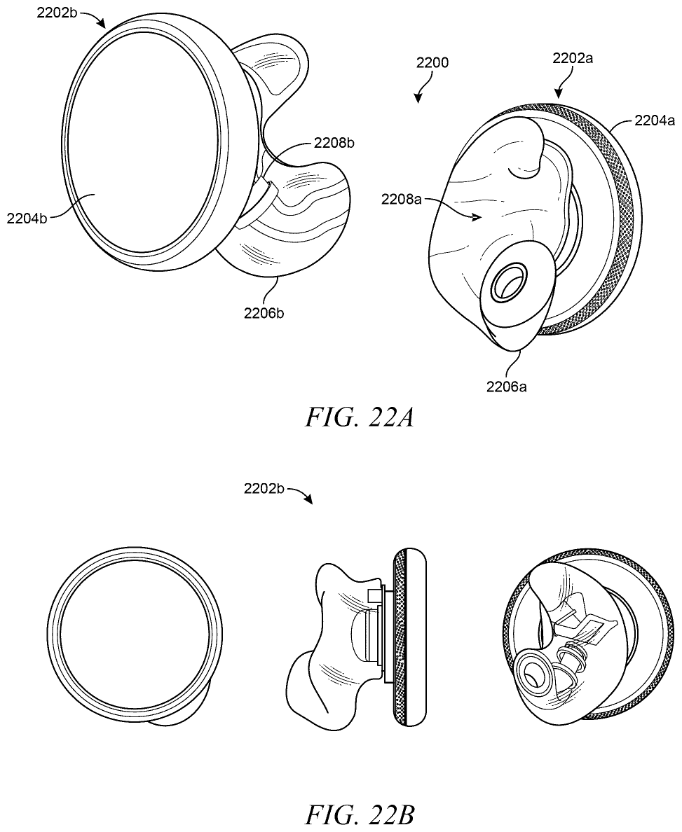

FIGS. 22A and 22B depict a virtual auditory display device 2200 according to another embodiment. The virtual auditory display device 2200 includes a first ear-worn device 2202a and a second ear-worn device 2202b. The first ear-worn device 2202a is for a left ear of a wearer and the second ear-worn device 2202b is for a right ear of the wearer.

Each of the first ear-worn device 2202a and the second ear-worn device 2202b includes an electronics package (shown as a first electronics package 2204a and a second electronics package 2204b), an ear interface (shown as a first ear interface 2206a and a second ear interface 2206b), and an acoustic package (shown individually as a first acoustic package 2208a and a second acoustic package 2208b). Certain components of each of the first ear-worn device 2202a and the second ear-worn device 2202b may be generally similar to certain components of the ear-worn device 1102 of FIG. 11.

The virtual auditory display device 2200 may provide the auditory user interface controls of the controller 1800. For example, a wearer of the virtual auditory display device 2200 may tap on the first electronics package 2204a and/or the second electronics package 2204b to switch between a first, transparency, mode and a second, active noise cancellation, mode. The first electronics package 2204a and/or the second electronics package 2204b may be touch-sensitive. Accordingly, the wearer may be able to move between different communications channels using touch gestures.

The first ear interface and the second ear interface of the virtual auditory display device 1500, the virtual auditory display device 1600, the virtual auditory display device 1700, and the virtual auditory display device 2200 may be custom made for the wearer's ears so as to provide a generally acoustically sealed fit for the wearer's ears. Accordingly, the virtual auditory display device 1500, the virtual auditory display device 1600, the virtual auditory display device 1700, and the virtual auditory display device 2200 may thus provide passive protection for wearer's ears.

Each of the virtual auditory display device 1500, the virtual auditory display device 1600, the virtual auditory display device 1700, and the virtual auditory display device 2200 may include components that allow for wireless transmission and reception of signals over IP-based networks and/or radio communication networks, such as those used by military personnel and public safety officers.

One advantage of the virtual auditory display devices described herein is that the virtual auditory display devices may enable wearers to hear sounds that are beyond the visible spectrum, hear sounds that may be too high or too low for human ears, and feel vibrations that may be too subtle to notice. For example, military personnel, such as military personnel on a battlefield, in a rescue mission, or performing normal duties, may utilize the virtual auditory display devices to detect threats before they become visible, hear enemy movements before they are audible, and feel changes in the environment before they are noticeable. Such virtual auditory display devices may provide military personnel with a competitive advantage and allow them to complete their missions with greater efficiency and safety.

As an example, military personnel could use the sensory augmentation features of the devices to identify the location of an enemy target. One possible scenario is that an enemy has made a brief sound that can be identified by digital signal processing. Examples of these sounds could be a gunshot, a footstep or other noise. The devices may identify the location of the sound and inform the military personnel the location of the target. Guidance to the military personnel could include a notification or continuous sound beacon placed in virtual auditory space or a spoken notification from a conversational user interface.

Another advantage of the virtual auditory display devices described herein is that such virtual auditory display devices may allow wearers to communicate with others in even loud environments and reduce interference. The virtual auditory display devices may filter out background noise and amplify the wearer's voice, thereby allowing the wearer to easily communicate with others and reducing distractions. The virtual auditory display devices may allow wearers to communicate with others clearly and effectively even if the wearers are in loud environments such as concerts and construction sites.

An HRTF may be for one person. Generating an individual HRTF typically requires a highly specialized environment and acoustic testing equipment. A person must remain still for approximately 30 minutes in an anechoic chamber while audio signals are emitted from different known locations. A microphone is placed in each ear of the person to capture the audio signals. However, this method presents challenges as there may be spurious responses due to factors such as the chamber, the audio signal source(s) and the microphone, that need to be eliminated in order to obtain an accurate Head Related Impulse Response (HRIR) which can then be converted to an HRTF. Furthermore, any movement by the person may affect the measurements, which may result in an inaccurate HRTF for the person. Another practical limitation of measuring an HRIR is that the time to collect directly scales with the number of discrete coordinates and practically limits the resolution of the resulting HRTF.

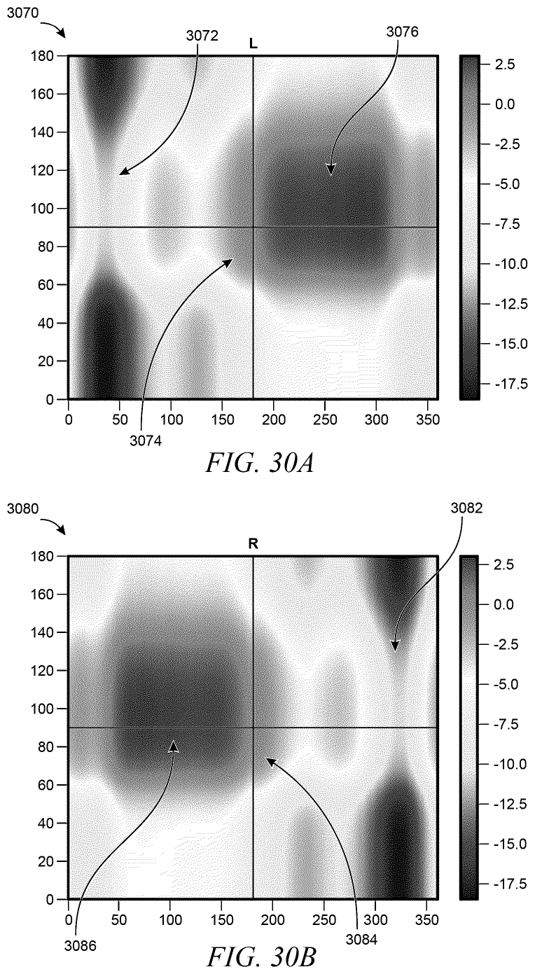

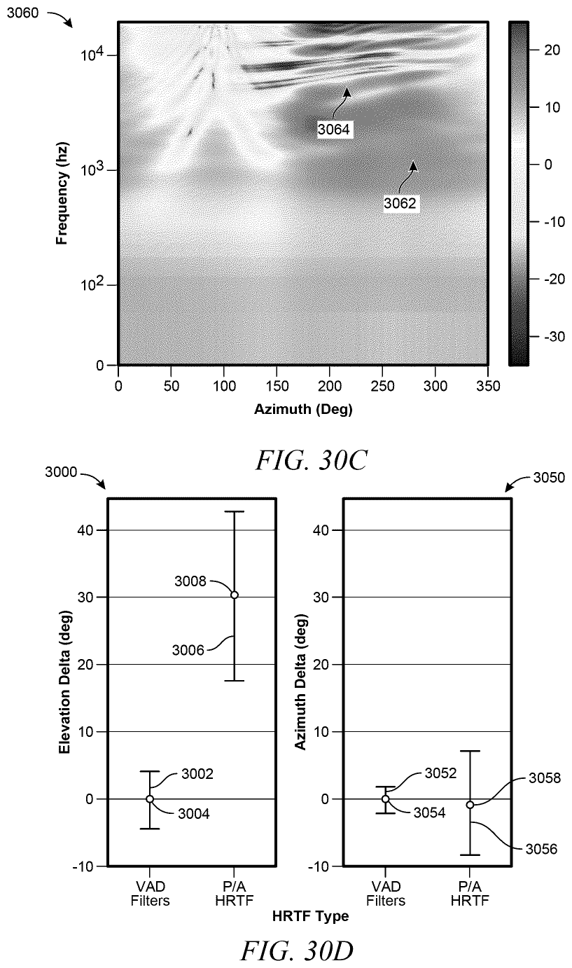

So-called universal HRTFs have been utilized to overcome disadvantages of individual HRTFs. Such universal HRTFs may be produced by averaging or otherwise combining measurements from multiple persons. However, such combining typically results in losing the individual characteristics of each person that are necessary to produce accurate virtual 3D sound for the person. As a result, such universal HRTFs may not accurately locate sound in virtual 3D space for all users, especially sound that is located directly in front of a user at approximately zero degrees azimuth and zero degrees elevation. FIG. 30E depicts an example HRTF 3010.

Another prior approach has attempted to simulate a personalized HRTF using photogrammetry of the head, torso, and pinna, or using other methods with highly precise head, torso, and pinna scanning via time of flight or structured light. A physical acoustics model is then generated based on the resulting scanned form. However, this approach may not yield convincing rendering of virtual 3D space, because after the physical scan is measured, the physics-based simulation of sound interacting with the modeled surface may introduce complexity and inaccuracy in the resulting psychoacoustic cues.

The technology described herein provides technical solutions to the technical problems of the prior approaches described above. The technology may utilize virtual auditory display filters that may result in accurately rendered sounds in their locations in virtual auditory space. The virtual auditory display filters may utilize spectral shaping techniques, using equalizers, filters, and/or dynamic range compression, to manipulate the frequency spectrum of audio signals. Virtual auditory display filters may be generated without resort to direct physical measurements (for example, measurements in an anechoic chamber, photogrammetry, etc.).

Virtual auditory display filters may be or include functions that manipulate a frequency spectrum of an audio signal. Virtual auditory display filters may be or include digital filters, such as parametric equalization (EQ) filters that allow for adjustment of parameters such as the center frequency, gain, quality (Q or q), cutoff frequency, slope, bandwidth and/or filter type. The parameters may be set as a function of a location of a sound in virtual auditory space. The functions or the digital filters may affect the frequency spectrum of an audio signal by creating notches and peaks in the audio signal. The notches, peaks, and other spectral shaping of the audio signal accurately places the resulting sound in virtual auditory space. Furthermore, the notches, peaks, and other spectral shaping of the audio signal produces a processed audio signal that may be used to output high-quality clear sound that, in the example of music recordings, may accurately represent the original recorded performance and allow listeners to hear subtleties and nuances of the original recorded performance. As described herein, a digital filter may refer to a digital filter, a function, and/or some combination of one or more functions or one or more digital filters.

Virtual auditory space may be described as a virtual 3D sound environment of a person in which the person may perceive a sound as emanating from any location in the virtual 3D sound environment. In the described technology, each location in virtual auditory space may have an associated function or digital filter that is applied to audio signals that have that location. The application of the function or digital filter to an audio signal with a location results in sound, which may be referred to as virtual auditory display sound, that is perceived by the person as coming from that location. Accordingly, the person, who may be wearing headphones, earbuds, or other ear-worn devices, may experience virtual auditory display sound. Other advantages of the described technology will be apparent.

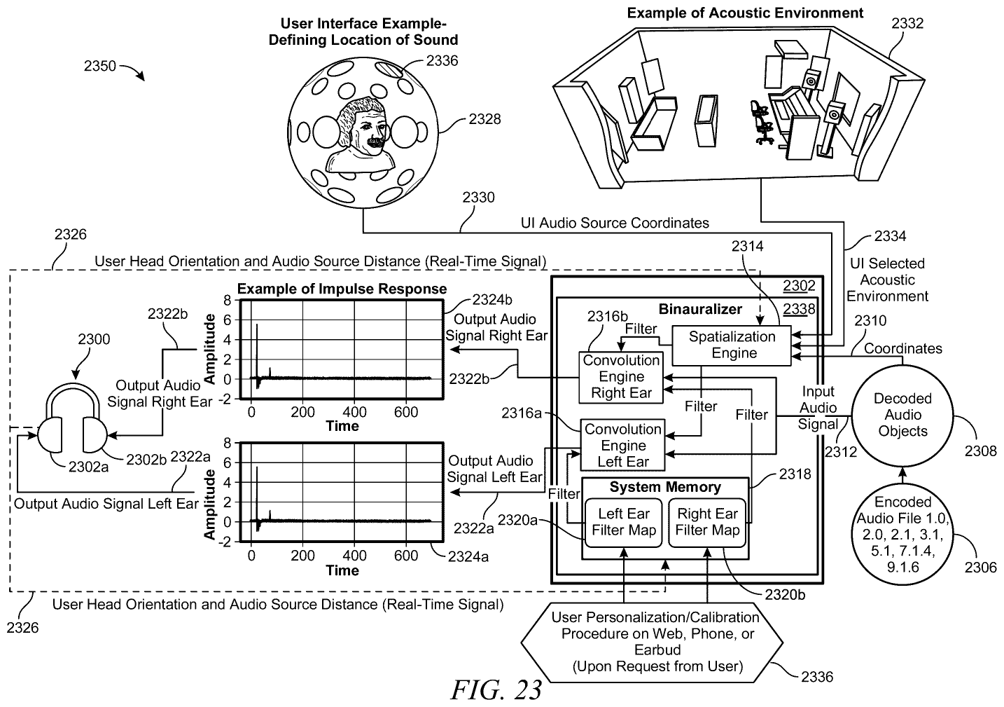

FIG. 23 is a diagram of an environment 2350 in which a virtual auditory display system and virtual auditory display devices that interface with the virtual auditory display system may operate in some embodiments. As depicted, the environment 2350 includes a virtual auditory display system 2302 and a virtual auditory display device 2300. The virtual auditory display system 2302 and the virtual auditory display device 2300 may together comprise a system. The virtual auditory display system 2302 and the virtual auditory display device 2300 may together render sounds in virtual auditory space for a wearer of the virtual auditory display device 2300.

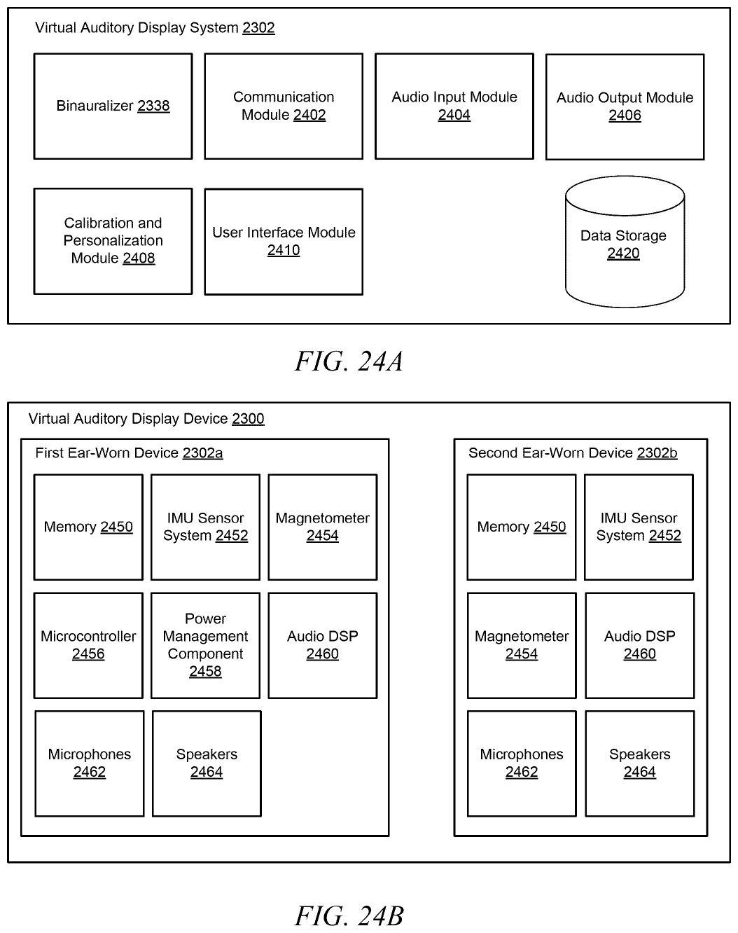

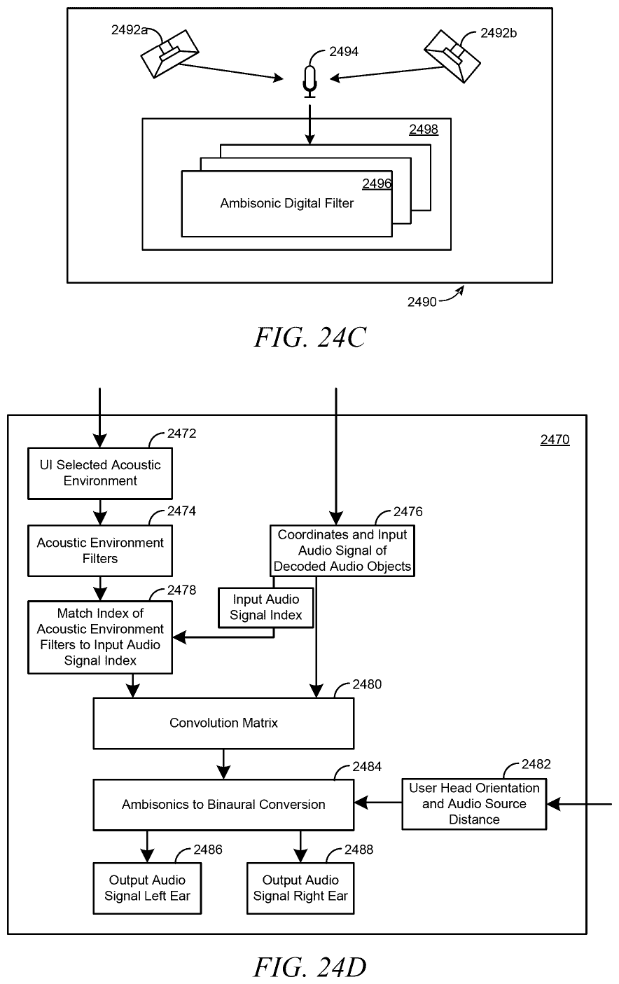

The virtual auditory display system 2302 may include a binauralizer 2338. The binauralizer may include a system memory 2318, which may include a left ear digital filter map 2320a and a right ear digital filter map 2320b. The binauralizer 2338 may also include a left ear convolution engine 2316a, a right ear convolution engine 2316b, and a spatialization engine 2314. The virtual auditory display system 2302 may also include other components, modules and/or engines, such as those described with reference to, for example, FIG. 24A.

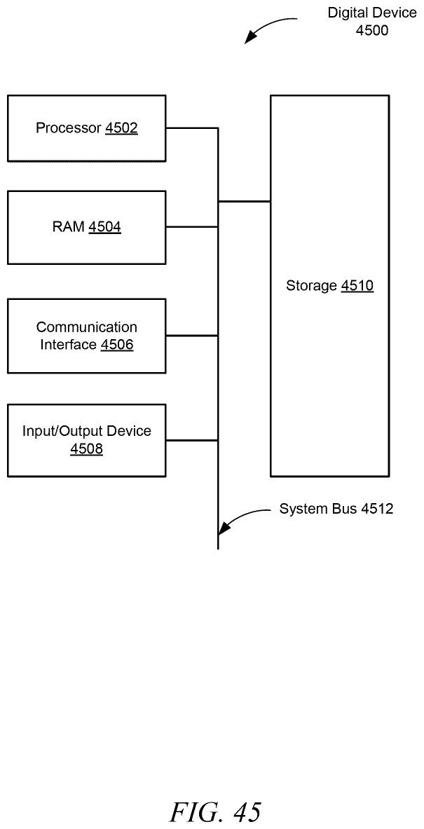

In some embodiments, the virtual auditory display system 2302 may be or include a software application that may execute on a digital device. A digital device is any device with at least one processor and memory. Digital devices are discussed further herein, for example, with reference to FIG. 45. For example, the virtual auditory display system 2302 may be a software application that executes on a general-purpose computing device, such as a laptop or desktop computer. As another example, the virtual auditory display system 2302 may be a software application that executes on a mobile device such as a phone or a tablet. In other embodiments, the virtual auditory display system 2302 be or include a software application or a firmware application that executes on a special-purpose computing device, such as on the virtual auditory display device 2300.

The virtual auditory display device 2300 may include a first ear-worn device 2302a and a second ear-worn device 2302b. The first ear-worn device 2302a and the second ear-worn device 2302b may each be any ear-worn, ear-mounted or ear-proximate device such as an earphone of a pair of earphones, an earbud of a pair of earbuds, a headphone of a headset, a speaker of a virtual reality headset, and the like. In some embodiments, the virtual auditory display device 2300 may be an embodiment of the virtual auditory display devices described herein. The first ear-worn device 2302a and/or the second ear-worn device 2302b may include components, such as an inertial measurement unit (IMU), an accelerometer, a gyroscope, and/or a magnetometer, that detect a head orientation of a wearer wearing the first ear-worn device 2302a and the second ear-worn device 2302b.

In some embodiments, a digital device (for example, a laptop or desktop computer) may receive an encoded audio file 2306 that has one or more channels of audio. Examples of an encoded audio file 2306 include 2.0 (two channels of audio), 2.1 (three channels of audio), 5.1 (six channels of audio), 7.1.4 (12 channels of audio), and 9.1.6 (16 channels of audio). The digital device may decode the encoded audio file 2306 to obtain decoded audio objects 2308 and an input audio signal 2312 that includes one or more audio sub-signals (alternately, audio channels). Each of the decoded audio objects 2308 and/or the audio sub-signals may have associated coordinates which identify the location of the audio object in virtual auditory space. The coordinates may be cartesian coordinates, spherical coordinates, and/or polar coordinates. Although specific examples of encoded audio files are described herein, the technology is not limited to such examples, and may be used with audio files that have any number of channels.

The digital device may send the coordinates 2310 to the spatialization engine 2314 and the input audio signal 2312 to the left ear convolution engine 2316a and the right ear convolution engine 2316b. In some embodiments, the virtual auditory display system 2302 receives the encoded audio file 2306 and decodes the encoded audio file 2306 to obtain the decoded audio objects 2308 and the input audio signal 2312.

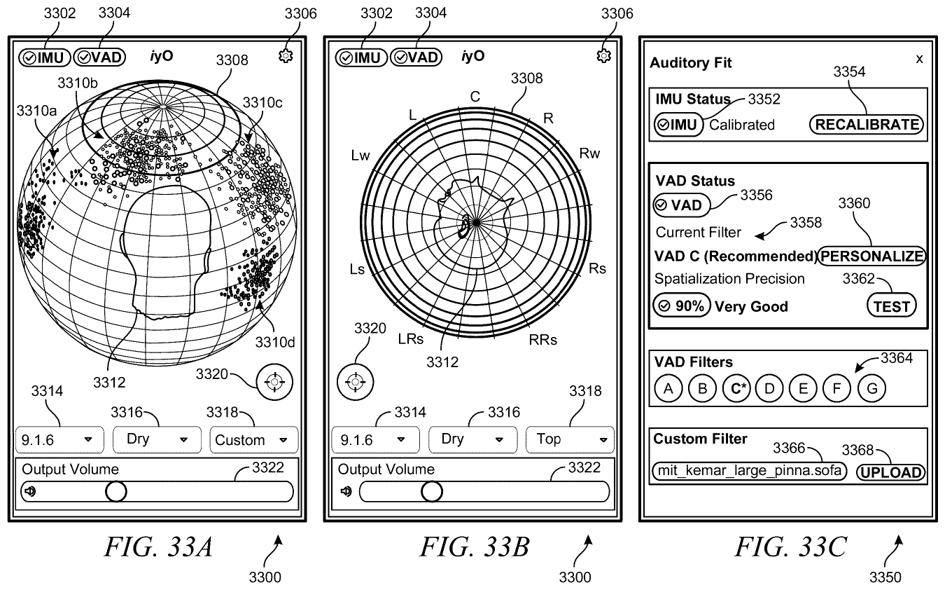

As described with reference to, for example, FIGS. 33A and 33B, a user interface component of the virtual auditory display system 2302 may provide a user interface that allows the user to select an acoustic environment. The spatialization engine 2314 may receive a selection 2334 of the acoustic environment 2332 via the user interface component from the wearer and utilize the selection 2334 to process audio signals that are sent to the first ear-worn device 2302a and the second ear-worn device 2302b of the virtual auditory display device 2300.

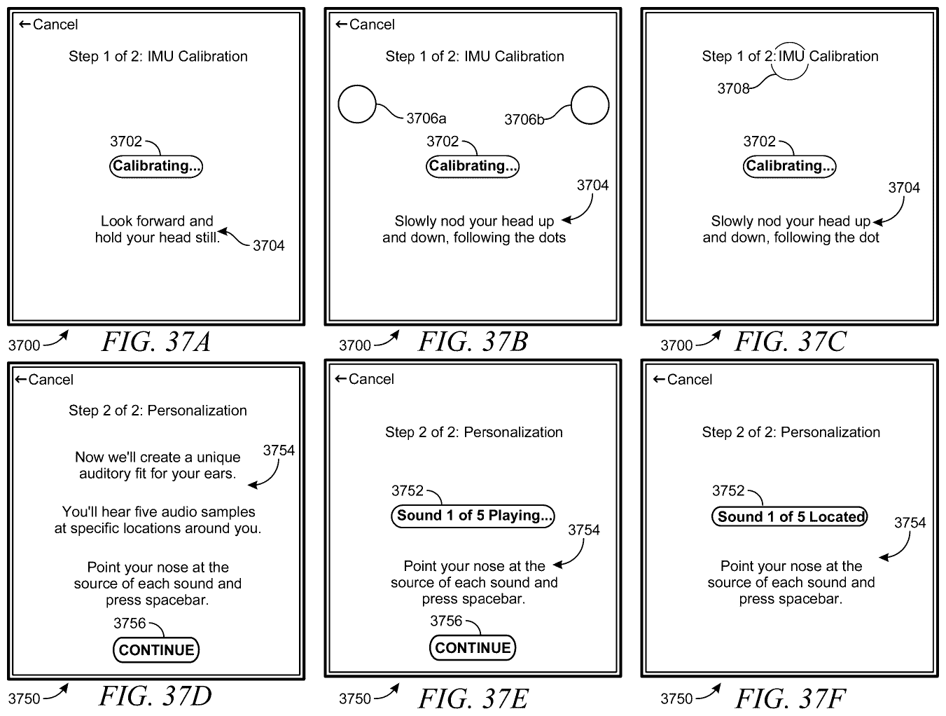

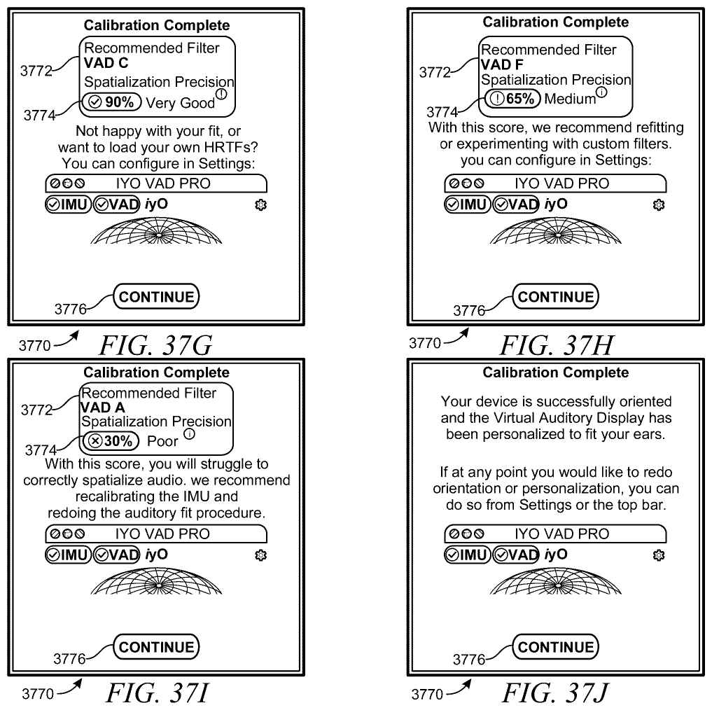

As described with reference to, for example, FIGS. 37A through 37J, the user interface component of the virtual auditory display system 2302 may provide a user interface 2328 that allows the user to perform a calibration and/or personalization procedure 2336 to calibrate and/or personalize the virtual auditory display system 2302. The wearer may use the user interface 2328 to personalize the virtual auditory display system 2302 so that the user's perception of the location of a sound matches the location of the sound in virtual auditory space. The user-perceived location of the sound may be sent in a signal 2330 to the spatialization engine 2314.

The spatialization engine 2314 may determine, based on the acoustic environment 2332, a first acoustic environment digital filter and a second acoustic environment digital filter. An acoustic environment digital filter may be or include a digital filter that is applied to an audio signal to manipulate the audio signal so as to produce the effect of the audio being played, generated or produced in a particular acoustic environment. The spatialization engine 2314 may provide the first acoustic environment digital filter to the left ear convolution engine 2316a and the second acoustic environment digital filter to the right ear convolution engine 2316b.

While the virtual auditory display system 2302 is receiving the input audio signal 2312, one or both of the first ear-worn device 2302a and the second ear-worn device 2302b may detect a head orientation of a wearer of the virtual auditory display device 2300 and provide the head orientation and an audio source distance 2326 (which may be specified by the wearer) to the virtual auditory display system 2302.

The binauralizer 2338 may, for each audio sub-signal of the one or more audio sub-signals, obtain multiple first processed audio sub-signals and multiple second processed audio sub-signals. The binauralizer 2338 may do so by determining, based on the virtual auditory space location associated with the audio sub-signal and the head orientation, a particular first location in the virtual auditory space for the audio sub-signal. The left ear digital filter map 2320a maps locations in virtual auditory space to digital filters and/or functions for the first ear-worn device 2302a and the right ear digital filter map 2320b maps locations in virtual auditory space to digital filters and/or functions for the second ear-worn device 2302b.

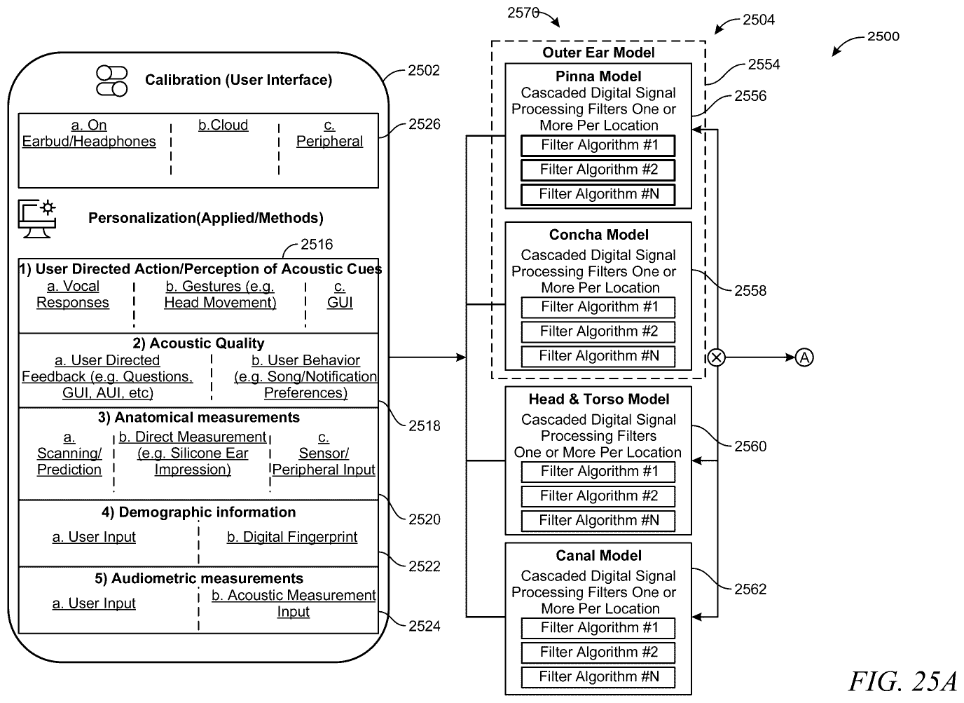

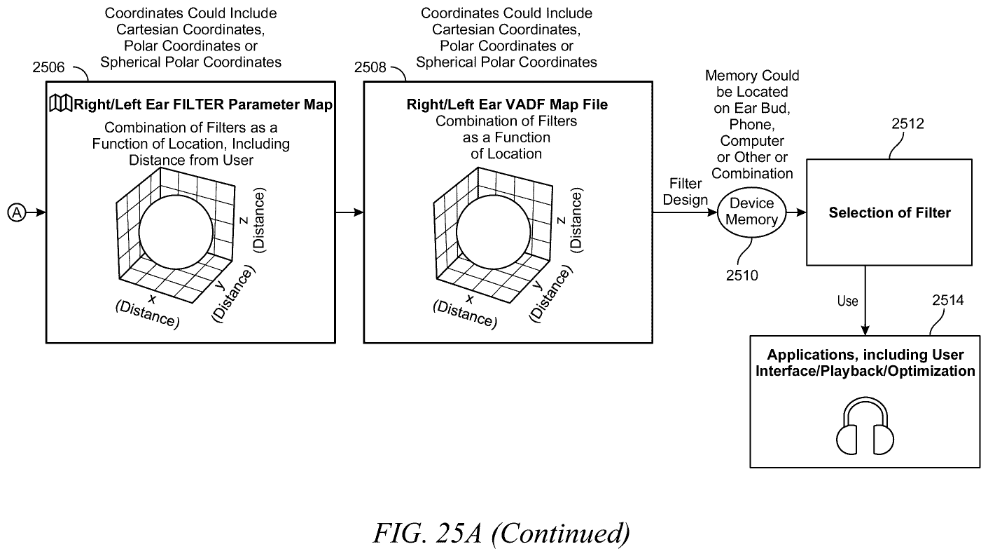

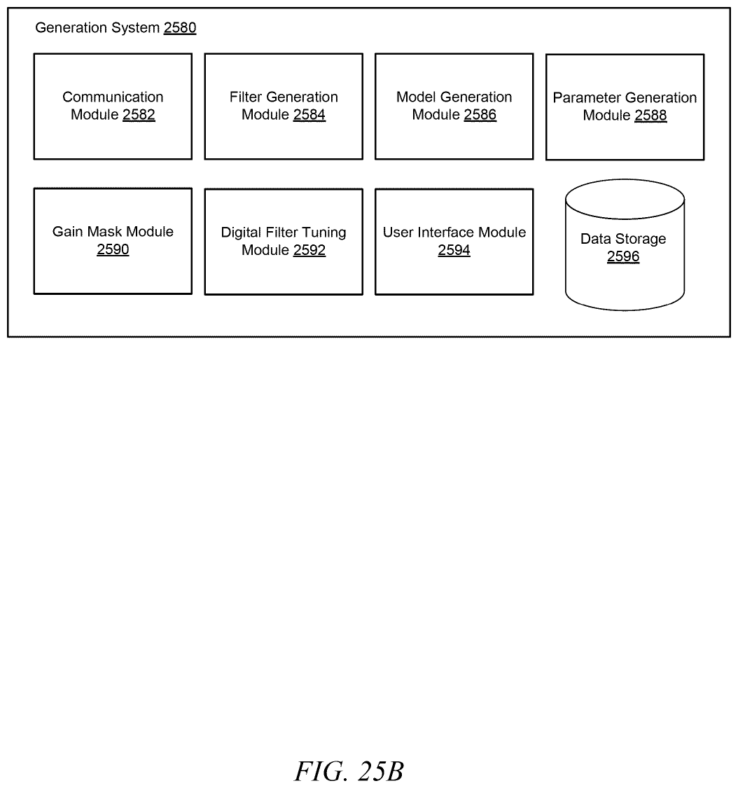

Virtual auditory display filters may be or include functions and/or digital filters that the virtual auditory display system 2302 applies to audio signals to create virtual auditory display sound. A generation system, discussed in more detail with reference to, for example, FIGS. 25A and 25B, may generate the virtual auditory display filters that the virtual auditory display system 2302 applies to audio signals.

The binauralizer 2338 may select a particular first digital filter and/or function from the left ear digital filter map 2320a and a particular second digital filter and/or function from the right ear digital filter map 2320b in the system memory 2318. The binauralizer 2338 may provide the particular first digital filter and/or function to the left ear convolution engine 2316a and the particular second digital filter and/or function to the right ear convolution engine 2316b.

The left ear convolution engine 2316a may apply the particular first digital filter and/or function and the first acoustic environment digital filter to the audio sub-signal to obtain a first processed audio sub-signal. The left ear convolution engine 2316a may then generate, based on the multiple first processed audio sub-signals, an output audio signal 2322a for the first ear-worn device 2302a. The right ear convolution engine 2316b may apply the particular second digital filter and/or function and the second acoustic environment digital filter to the audio sub-signal to obtain a second processed audio sub-signal. The right ear convolution engine 2316b may then generate, based on the multiple second processed audio sub-signals, an output audio signal 2322b for the second ear-worn device 2302b. The graph 2324a depicts an example impulse response for the output audio signal 2322a and the graph 2324b depicts an example impulse response for the output audio signal 2322b.

FIG. 24A is a block diagram depicting components of the virtual auditory display system 2302 in some embodiments. The virtual auditory display system 2302 may include the binauralizer 2338, a communication module 2402, an audio input module 2404, an audio output module 2406, a calibration and personalization module 2408, a user interface module 2410, and a data storage 2420.

The communication module 2402 may send requests and/or data between components of the virtual auditory display system 2302 and any other components or devices, such as the virtual auditory display device 2300 and a generation system 2580 (described with reference to, for example, FIGS. 25A and 25B). The communication module 2402 may also receive requests and/or data between components of the virtual auditory display system 2302 and any other components or devices.

The audio input module 2404 may receive the input audio signal 2312 from, for example, the general purpose computing device on which the virtual auditory display system 2302 executes. The audio output module 2406 may provide the output audio signal 2322a to the first ear-worn device 2302a and the output audio signal 2322b to the second ear-worn device 2302b.

The calibration and personalization module 2408 may calibrate IMUs and/or other sensors of the first ear-worn device 2302a and the second ear-worn device 2302b. The calibration and personalization module 2408 may also generate personalization audio signals and receive personalization information for personalizing filters. The user interface module 2410 may provide user interfaces that allow users to, among other things, select an acoustic environment, select an audio visualization, control audio volume, and request calibration and/or personalization procedures be performed by the virtual auditory display system 2302.

The data storage 2420 may include data stored, accessed, and/or modified by any of the engines, components, modules or the like of the virtual auditory display system 2302. The data storage 2420 may include any number of data storage structures such as tables, databases, lists, and/or the like. The data storage 2420 may include data that is stored in memory (for example, random access memory (RAM)), on disk, or some combination of in-memory and on-disk.

FIG. 24B is a block diagram depicting components of the first ear-worn device 2302a and the second ear-worn device 2302b in some embodiments. The first ear-worn device 2302a may include a memory 2450, an IMU sensor system 2452 (inertial measurement unit sensor system), a magnetometer 2454, a microcontroller 2456, a power management component 2458, an audio DSP 2460 (audio digital signal processor), microphones 2462, and speakers 2464. The second ear-worn device 2302b may include a memory 2450, an IMU sensor system 2452 (inertial measurement unit sensor system), a magnetometer 2454, an audio DSP 2460, microphones 2462, and speakers 2464.

The memory 2450 may store software and/or firmware. The IMU sensor system 2452 and/or the magnetometer 2454 may detect a head orientation of a wearer of the virtual auditory display device 2300 and/or user interactions with the virtual auditory display device 2300. The microcontroller 2456 may execute software and/or firmware stored in the memory 2450 or in the storage of the microcontroller 2456.

The power management component 2458 may provide power management. The audio DSP 2460 may process audio signals to perform functions such as noise cancellation. The microphones 2462 may capture audio, such as environmental audio and/or audio from a wearer of the first ear-worn device 2302a. The speakers 2464 may output sound based on the output audio signal 2322a and the output audio signal 2322b.

The first ear-worn device 2302a and/or the second ear-worn device 2302b may include components other than those depicted in FIG. 24B, such as switches, interconnects, and oscillators. The first ear-worn device 2302a may be the primary device and the second ear-worn device 2302b may be the secondary device. As such, the second ear-worn device 2302b may not include a microcontroller 2456. In some embodiments, the second ear-worn device 2302b includes a microcontroller 2456.

An engine, component, module, or the like of the virtual auditory display system 2302, the first ear-worn device 2302a, the second ear-worn device 2302b, or a generation system 2580 (described with reference to, for example FIG. 25B) may be hardware, software, firmware, or any combination. For example, each engine, component, module or the like may include functions performed by dedicated hardware (for example, an Application-Specific Integrated Circuit (ASIC), a Field Programmable Gate Array (FPGA), or the like), software, instructions maintained in memory, and/or any combination. Software and/or firmware may be executed by one or more processors.

Although a limited number of engines, components, and modules are depicted in FIGS. 24A and 24B and FIG. 25B, there may be any number of engines, components, and modules or the like. Further, individual engines, components, and modules may perform any number of functions, including functions of multiple modules as described herein. Moreover, although the virtual auditory display system 2302, the first ear-worn device 2302a, the second ear-worn device 2302b, and the generation system 2580 may be depicted as having a single one of several engines, components, or modules, the virtual auditory display system 2302, the first ear-worn device 2302a, the second ear-worn device 2302b, and the generation system 2580 may have multiple engines, components, modules, or the like that perform a particular function. For example, the first ear-worn device 2302a is depicted as having a single one of the audio DSP 2460, but the first ear-worn device 2302a may include multiple of the audio DSP 2460.

FIG. 25A is a block diagram of a method 2500 of personalizing, generating and applying digital filters in some embodiments. A generation system 2580 (see FIG. 25B) may perform the generation of digital filters (step 2504 through step 2510), and the virtual auditory display system 2302 may perform the personalization of digital filters (step 2502) and the application of digital filters (step 2512 through step 2514).

A digital filter may be or include one or more parametric equalization (EQ) filters that allow for adjustment of parameters such as the center frequency, gain, quality (Q or q), cutoff frequency, slope, bandwidth and/or filter type. The parametric EQ filters may be or include biquad filters. The biquad filters may be or include peaking, low shelf, and high shelf filters. In some embodiments, the digital filters may be or include one or more finite impulse response (FIR) filters. The FIR filters may be generated from or based on one or more infinite impulse response (IIR) filters. In some embodiments, the digital filters may be or include one or more IIR filters, or any other suitable type of digital filter.

The digital filters that the generation system 2580 generates may be organized into multiple groups. The groups of digital filters may include a group of notch filters, a group of head shadow filters, a group of shelf filters, a group of peak filters, a group of beam filters, a group of stereo filters, a group of rear filters, a group of top filters, a group of top transition filters, a group of bottom filters, a group of bottom transition filters, and a group of broadside filters. Other groups are possible. Certain digital filters or groups of digital filters may be utilized for purposes of setting the locations of sounds in virtual auditory space (for example groups of notch filters). Certain digital filters or groups of digital filters may be utilized for purposes of ensuring that sounds meet required thresholds of tonal quality, clarity, brightness, and the like.

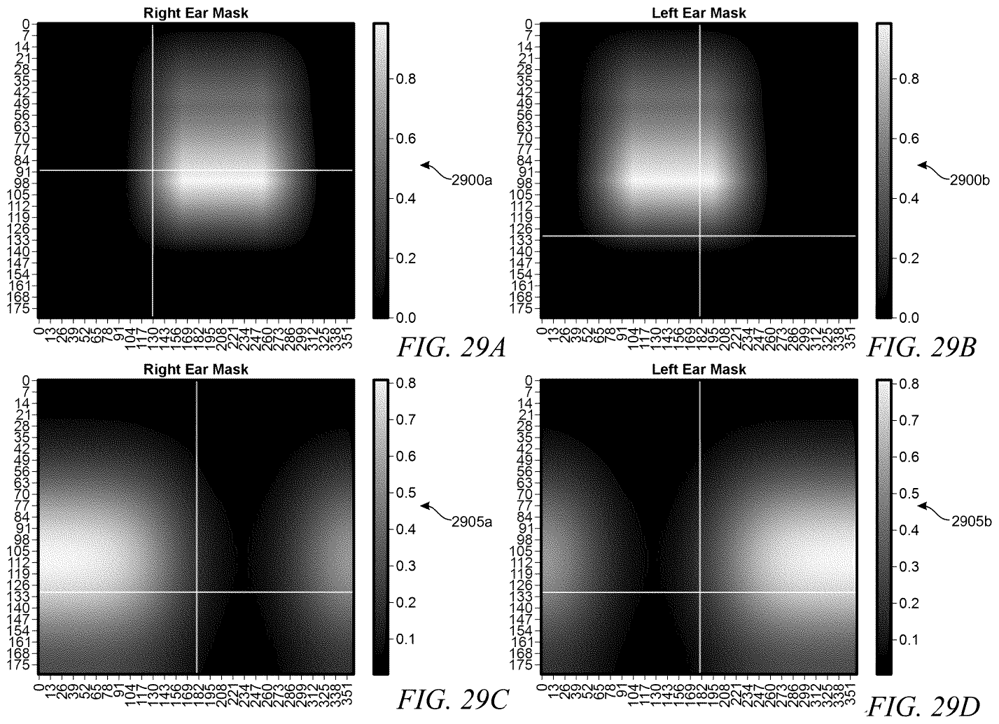

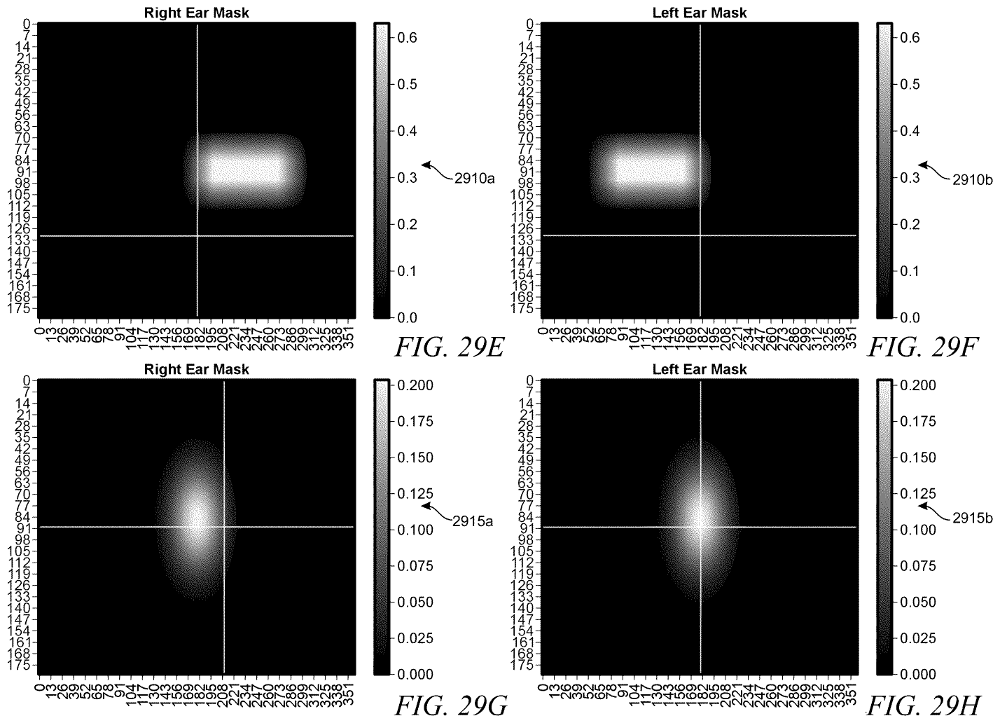

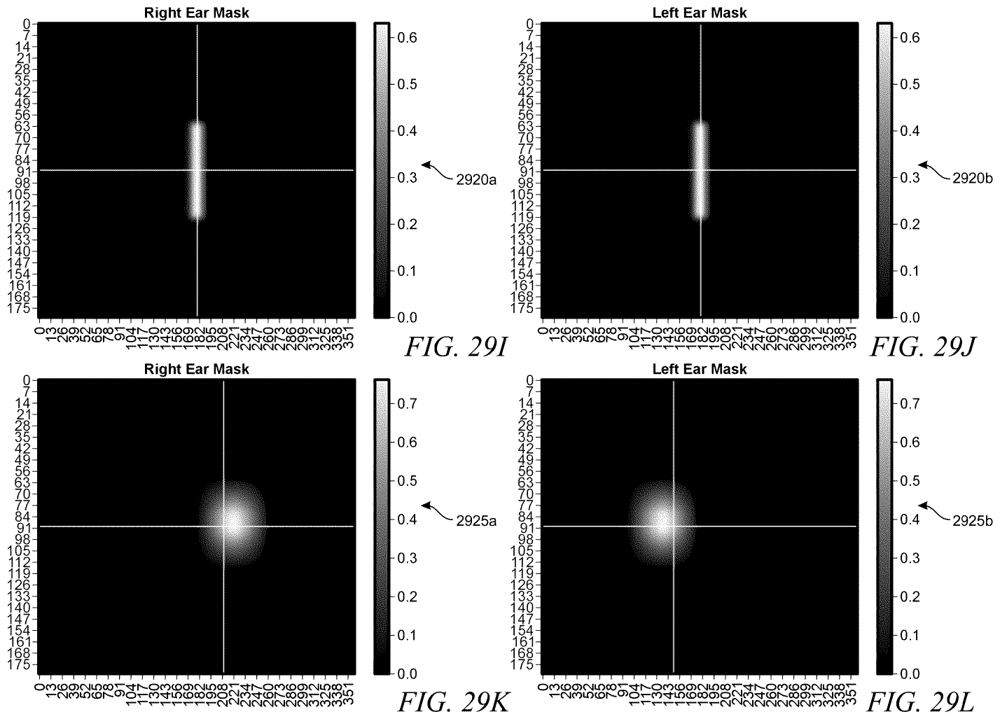

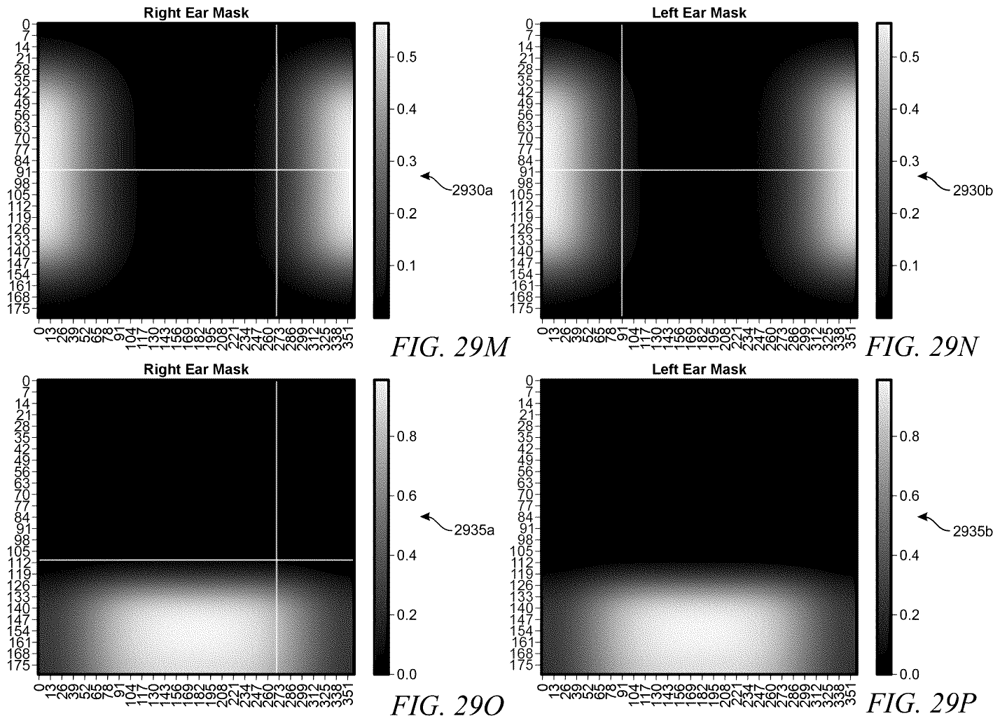

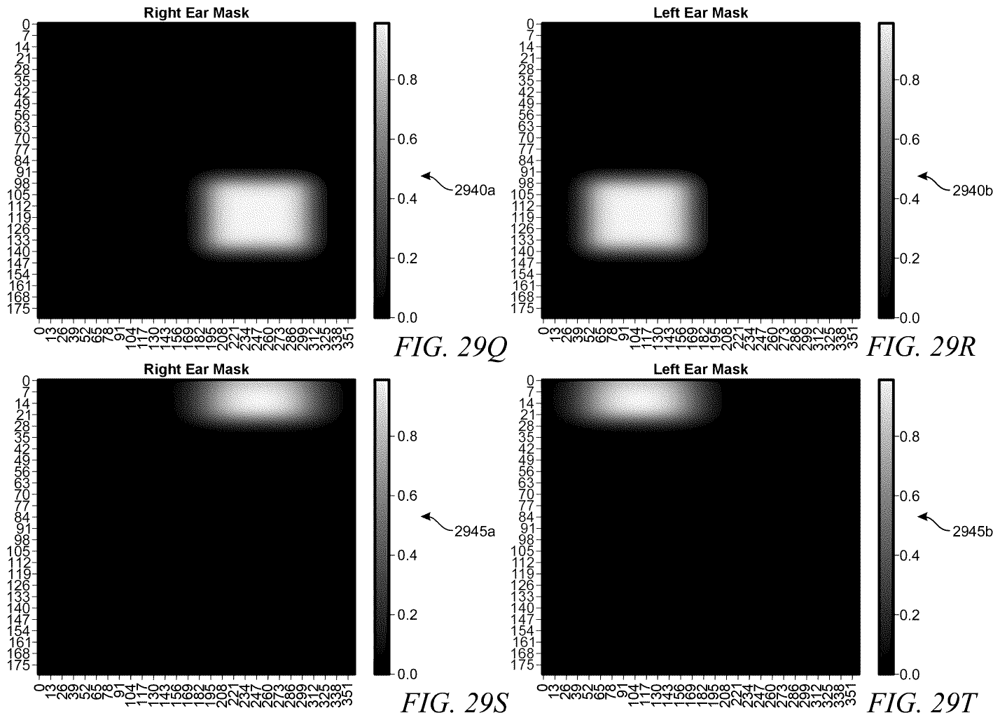

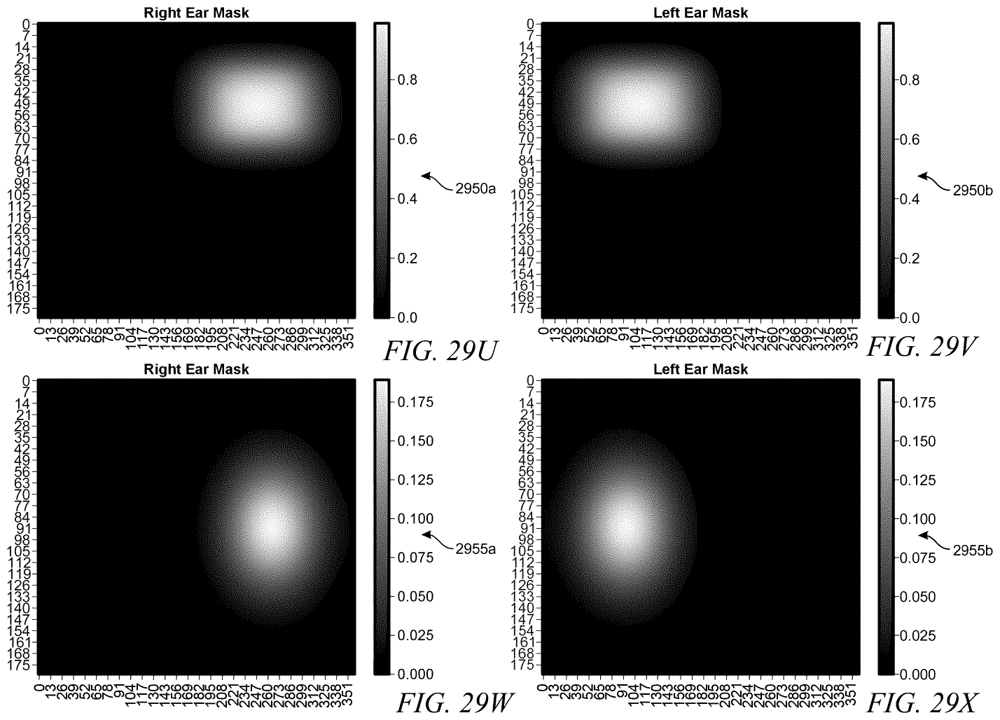

A digital filter may be or include an algorithm and one or more parameters for the algorithm. For example, the algorithm may be or include a high shelf, a low shelf, and a peaking algorithm. The one or more parameters may be or include a center frequency, a quality (Q or q), a gain, and a sampling frequency. For example, a notch digital filter may specify a peaking algorithm, an initial center frequency of 6600 Hz, a Q of 15, and an initial gain of −85 decibels (dB). The one or more parameters may be modified. For example, an initial center frequency may be shifted to obtain a shifted center frequency and an initial gain may be modified by a parameter modifier (see, for example, the discussion with reference to FIGS. 29A through 29X) and a factor that has any value, such as a value between 0 and 1, inclusive. The digital filter may be or include the one or more parameters as modified.

Digital filters may be generated and utilized based on how the digital filters represent individuals' geometries interact with sound waves. For example, a digital filter having a high shelf algorithm may produce a high shelf that may be a virtual representation of how the geometry of individual's concha bowl interacts with sound waves.

The method 2500 may include a step 2502 of calibration and/or personalization. The virtual auditory display system 2302 (for example, the calibration and personalization module 2408) may perform calibration of the IMUs and/or other sensors of the virtual auditory display device 2300 using various devices and/or services 2526, such as one or both of the first ear-worn device 2302a and the second ear-worn device 2302b, a cloud-based computing service, and/or a peripheral to a computing device, such as a camera.

The virtual auditory display system 2302 (for example, the calibration and personalization module 2408) may perform personalization of the virtual auditory display system using various methodologies and/or techniques, such as: 1) a user-directed action and/or perception of acoustic cues 2516; 2) acoustic quality user feedback 2518; 3) anatomical measurements 2520; 4) demographic information 2522; and 5) audiometric measurements 2524.

User-directed action and/or perception of acoustic cues 2516 may include capturing responses of a user to locations of acoustic cues. Responses may be vocal responses of a user captured using a microphone of a computing device, gestures (for example, head and/or arm movements) of a user captured using a camera of a computing device and/or one or both of the first ear-worn device 2302a and the second ear-worn device 2302b, and user input captured via a graphical user interface (GUI) of a computing device.

Acoustic quality user feedback 2518 may include user-directed feedback on acoustic quality (for example, responses to questions on quality metrics such as brightness, warmth, clarity, etc., responses to questions provided by a GUI or an Audio User Interface (AUI)), and observations of user behavior such as user song and/or notification preferences via, for example, a GUI or AUI.

Anatomical measurements 2520 may include measurements of user anatomical features, such as the head, the pinna, and/or the concha, via scanning or prediction. Anatomical measurements 2520 of one or more users may also include direct measurements (for example, via silicone ear impressions) and indirect measurements obtained via sensors and/or computer peripherals.

Demographic information 2522 may include information provided by users such as user age or other demographics and a digital fingerprint of a user generated from one or more user features such as age, gender, and/or other user characteristics.

Audiometric measurements 2524 may include those provided by user input and or obtained via acoustic measurements, such as in an anechoic chamber while audio signals are emitted from different known locations.

The method 2500 may include a step 2504 of the generation system 2580 (for example, a model generation module 2586 of the generation system 2580, see FIG. 25B) generating, modifying, and/or receiving multiple models 2570. The multiple models 2570 may include one or more outer ear models 2554, which may include one or more pinna models 2556 and one or more concha models 2558. The multiple models 2570 may also include one or more head and torso models 2560 and one or more canal models 2562. The generation system 2580 may generate the multiple models 2570 based on the calibration and/or personalization information obtained in step 2502.

For each model of the multiple models 2570, for each location in virtual auditory space, the generation system 2580 may generate one or more first digital filters (for the left ear) and one or more second digital filters (for the right ear) based on the model. Accordingly, for the multiple models 2570, for each location in virtual auditory space, the generation system 2580 may generate multiple first digital filters and multiple second digital filters.

For example, for the one or more head and torso models 2560, the generation system 2580 may generate one or more first digital filters and one or more second digital filters that take into account shoulder width and/or breadth, head diameter, neck height, and other factors. For the one or more concha models 2558 the generation system 2580 may generate one or more first digital filters and one or more second digital filters that represent the acoustic effects of the physical features of the concha. These features include (but are not limited to), concha depth, width, and angle.

As another example, for the one or more pinna models 2556, the generation system 2580 may generate one or more first digital filters and one or more second digital filters that represent the acoustic effects of the physical features of the pinna. These features include (but are not limited to), pinna height, width, depth, location on the head, and flare angle relative to head. For the one or more canal models 2562, the generation system 2580 may generate one or more first digital filters and one or more second digital filters that take into account the physical proportions of the pinna, concha, and other ear components.

Also at the step 2504, for each location in virtual auditory space, the generation system 2580 may sum, aggregate, or otherwise combine the multiple first digital filters into combined first digital filters, and may sum, aggregate, or otherwise combine the multiple second digital filters into combined second digital filters. The combined first digital filters may be or include one or more finite impulse response (FIR) filters. The combined second digital filters may also be or include one or more FIR filters. Accordingly, at the conclusion of the step 2504, for all the locations in virtual auditory space, there may be a set of combined first digital filters and a set of combined second digital filters.

At a step 2506, the generation system 2580 may generate a mapping or association of the combined first digital filters to their corresponding locations in virtual auditory space for the left ear. The generation system 2580 may also generate a mapping or association of the combined second digital filters to their corresponding locations in virtual auditory space for the right ear. The generation system 2580 may utilize cartesian, polar, and/or spherical polar coordinates for the mapping or association.

At a step 2508, the generation system 2580 may generate a file, a database, or other data structure that includes the mapping or association of the combined first digital filters to their corresponding locations in virtual auditory space and the mapping or association of the combined second digital filters to their corresponding locations in virtual auditory space.

At a step 2510, the generation system 2580 may provide or store the file, the database, or other data structure on one or more non-transitory computer-readable media of a device. The device may be the first ear-worn device 2302a and/or the second ear-worn device 2302b, a mobile device such as a phone or a tablet, a laptop or desktop computer, another device, or any combination of the foregoing.

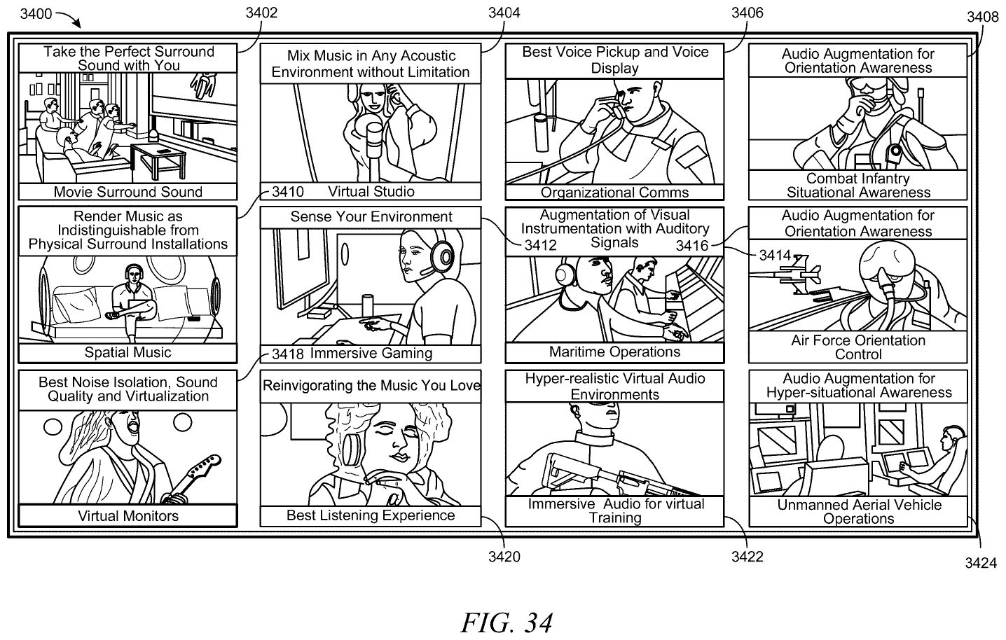

At a step 2512, the virtual auditory display system 2302 may select the combined first digital filters and the combined second digital filters for use. After selection, at a step 2514, the virtual auditory display system 2302 may utilize the combined first digital filters and the combined second digital filters in various applications, such as to render music. Various applications of the disclosed technology are discussed with reference to, for example, FIG. 34.

In some embodiments, at step 2504, for each model of the multiple models 2570, the generation system 2580 may generate one or more first digital filters and one or more second digital filters for each azimuth and elevation combination at locations in virtual auditory space of one degree increments of azimuth and elevation at a distance of one meter (1 m) from a center point representing a virtual listener in virtual auditory space. The one degree increments of azimuth are from approximately negative 180 degrees, inclusive, to approximately positive 180 degrees, inclusive. The one degree increments of elevation are from approximately negative 90 degrees, inclusive, to approximately 90 degrees, inclusive. Accordingly, there are 65,160 combinations of azimuth and elevation, and therefore 65,160 locations in virtual auditory space, each location being at a distance of 1 m from the center point. Therefore, the generation system 2580 may generate 65,160 sets of one or more first digital filters and 65,160 sets of one or more second digital filters.

In some embodiments, the method 2500 may include a step of the generation system 2580 reducing the number of locations in virtual auditory space for which digital filters are generated or stored. For example, after step 2504, the generation system 2580 may a select a proper subset from the set of combined first digital filters and a proper subset from the set of combined second digital filters.

In embodiments where there are 65,160 locations in virtual auditory space, the generation system 2580 may select a proper subset from the set of combined first digital filters that includes approximately 7,000, such as 7,220, combined first digital filters. Similarly, the generation system 2580 may select a proper subset from the set of combined second digital filters that includes approximately 7,000, such as 7,220, combined second digital filters.

The generation system 2580 may select a proper subset that adequately represent locations in virtual auditory space, while reducing the amount of storage required for the sets of digital filters and reducing the amount of time to select and process digital filters. The generation system 2580 may achieve these objectives in other ways, such as by generating mapping or associations for a reduced number of locations in virtual auditory space or storing the mapping or associations for a reduced number of locations in virtual auditory space.

In some embodiments, at step 2504 the generation system 2580 does not sum, aggregate, or otherwise combine the multiple first digital filters into combined first digital filters and the multiple second digital filters into combined second digital filters. Accordingly, at the conclusion of the step 2504, for all the locations in virtual auditory space, there may be a set of multiple first digital filters and a set of multiple second digital filters. A proper subset of the set of multiple first digital filters and a proper subset of the set of multiple second digital filters may be utilized as described herein.

In such embodiments, at step 2506 the generation system 2580 may instead generate a mapping or association of the multiple first digital filters to their corresponding locations in virtual auditory space for the left ear and generate a mapping or association of the multiple second digital filters to their corresponding locations in virtual auditory space for the right ear.

Further in such embodiments, at step 2508 the generation system 2580 may instead generate a file, a database, or other data structure that includes the mapping or association of the multiple first digital filters to their corresponding locations in virtual auditory space and the mapping or association of the multiple combined second digital filters to their corresponding locations in virtual auditory space.

In some embodiments, the generation system 2580 generates multiple sets of digital filters for the locations in virtual auditory space. The generation system 2580 may generate a first set of digital filters for the left ear and a first set of digital filters for the right ear as described herein. The generation system 2580 may then generate one or more second sets of digital filters for the left ear and one or more second sets of digital filters for the right ear based on the first set of digital filters for the left ear and the first set of digital filters for the right ear. Each pair of sets may be for a different archetype representing a different user population or grouping of users.

The generation system 2580 may generate the one or more second sets of digital filters for the left ear and the one or more second sets of digital filters for the right ear by modifying one or more parameters of the digital filters for the left ear and the digital filters for the right ear. For example, the generation system 2580 may modify the center frequency of notch filters that are included in the first set of digital filters for the left ear and the first set of digital filters for the right ear. The generation system 2580 may modify the center frequency of notch filters to personalize digital filters to a user, as described with reference to, for example, FIGS. 37A through 37F. The generation system 2580 may do so to adjust for a delta between an actual location of a sound in virtual auditory space and the location of the sound the wearer perceives.

In some embodiments, the generation system 2580 may generate a first set of digital filters for the left ear and a first set of digital filters for the right ear for a distance of 1 m from a center point representing a virtual listener in virtual auditory space, as described herein. The generation system 2580 may generate one or more second sets of digital filters for the left ear and the one or more second sets of digital filters for the right ear for other distances from the center point. The generation system 2580 may generate one or more second sets of digital filters for the left ear based on the first set of digital filters for the left ear and one or more second sets of digital filters for the right ear based on the first set of digital filters for the right ear. For example, the generation system 2580 may increase the gain of digital filters for distances closer than 1 m from the center point and may decrease the gain of digital filters for distances further than 1 m from the center point. Other methods will be apparent.

FIG. 25B is a block depicting components of the generation system 2580 in some embodiments. The generation system 2580 may include a communication module 2582, a filter generation module 2584, a model generation module 2586, a parameter generation module 2588, a parameter mask module 2590, a digital filter tuning module 2592, a user interface module 2594, and a data storage 2596.

The communication module 2582 may send requests and/or data between components of the generation system 2580 and any other systems, components or devices, such as the virtual auditory display system 2302. The communication module 2582 may also receive requests and/or data between components of the generation system 2580 and any other systems, components or devices.

The filter generation module 2584 may generate digital filters and the acoustic environment digital filters. A filter may be or include one or more algorithms and, optionally, one or more parameters for the one or more algorithms.

The model generation module 2586 may generate, modify, or access multiple models. The parameter generation module 2588 may generate parameters for digital filters.

The parameter mask module 2590 may generate parameter modifier masks. The parameter mask module 2590 may use image processing techniques to generate parameter modifier masks. The parameter mask module 2590 may determine one or more parameter modifiers to one or more parameter of filters using the parameter modifier masks. The parameter mask module 2590 may modify the one or more parameter using the one or more parameter modifiers.

The digital filter tuning module 2592 may receive parameters for digital filters from users and modify digital filters based on the received parameters. The user interface module 2594 may provide user interfaces that allow users to, among other things, listen to sound output from audio signals generated by application of digital filters and modify parameters of digital filters.

The data storage 2596 may include data stored, accessed, and/or modified by any of the engines, components, modules or the like of the generation system 2580. The data storage 2596 may include any number of data storage structures such as tables, databases, lists, and/or the like. The data storage 2596 may include data that is stored in memory (for example, random access memory (RAM)), on disk, or some combination of in-memory and on-disk.

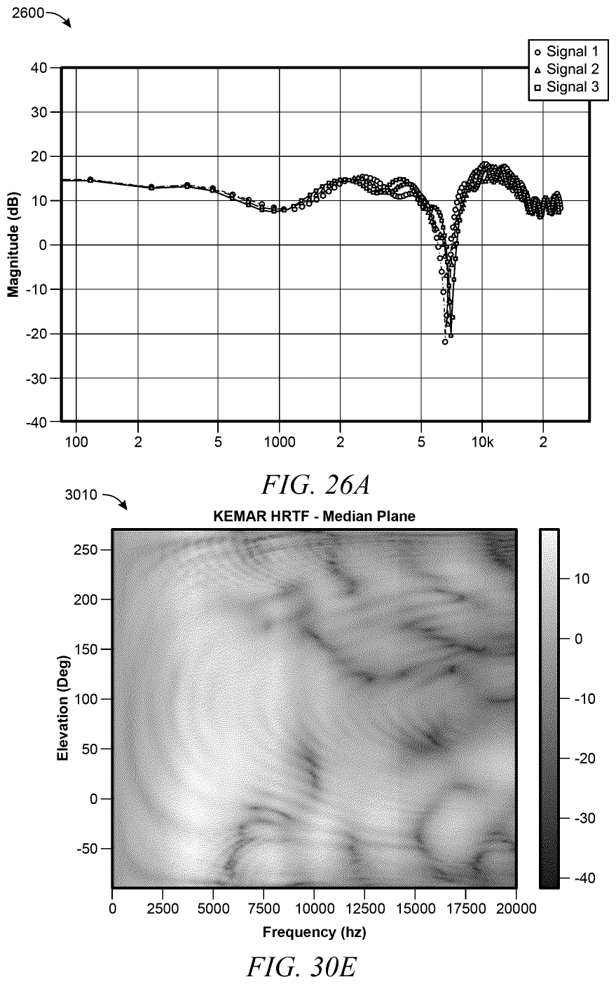

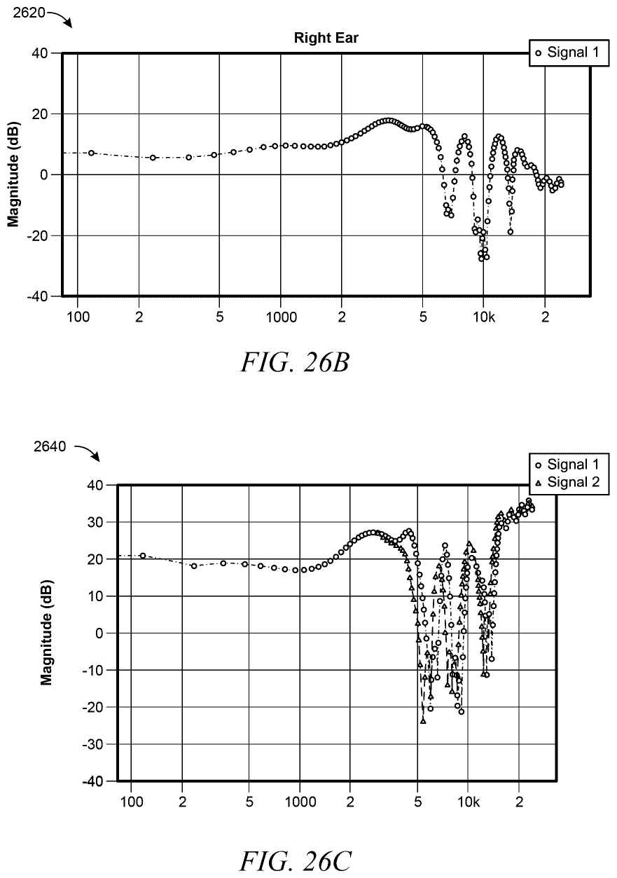

FIGS. 26A-26C are graphs of frequency responses of digital audio signals in some embodiments. FIG. 26A is a graph 2600 the frequency response for three audio signals. Each audio signal has a notch at a different center frequency. The center frequency of the notch is a factor in specifying the location in virtual auditory space of the sound corresponding to the audio signal, meaning where a user (for example, a wearer of the first ear-worn device 2302a and the second ear-worn device 2302b) perceives the location of the sound to be.

The first audio signal is for a first sound that has a first location in virtual auditory space at a distance of one (1) meter (m), zero degrees (0°) azimuth and zero degrees (0°) elevation. The second audio signal is for a second sound that has a second location in virtual auditory space at a distance of one (1) m, five degrees (5°) azimuth and zero degrees (0°) elevation The third audio signal is for a third sound that has a third location in virtual auditory space at a distance of one (1) m, ten degrees (10°) azimuth and zero degrees (0°) elevation. FIG. 26A shows the variation of the center frequency notch in the three signals due to the differences in locations in virtual auditory space. The virtual auditory display system 2302 has applied a notch filter to the three audio signals produce each notch in each of the three frequency responses in order to produce the three sounds at the specified locations in virtual auditory space. The notch filter may be or include parametric EQ filters with the parameters being the center frequency, the gain, and the bandwidth.

FIG. 26B is a graph 2620 of a frequency response of an audio signal to which digital filters have been applied according to some embodiments. The frequency response has three notches at three different center frequencies. The audio signal is for a sound that has a location in virtual auditory space at a distance of one (1) meter (m), zero degrees (0°) azimuth and zero degrees (0°) elevation. The virtual auditory display system 2302 has applied three notch filters to produce the three notches in the frequency response of the audio signal. The notch filters may be or include parametric EQ filters with the parameters being the center frequency, the gain, and the bandwidth.

FIG. 26C is a graph 2640 of frequency responses of two audio signals to which digital filters have been applied according to some embodiments. Each frequency response has a notch at a different center frequency. The virtual auditory display system 2302 has applied three notch filters to produce the three notches in each frequency response. The notch filters may be or include parametric EQ filters with the parameters being the center frequency, the gain, and the bandwidth.

In the examples depicted in FIGS. 26A-26C, the peak-to-trough decibel values of notches of the azimuthal values between negative ten degrees (−10°) to ninety-five degrees (95°) and the elevation values of between negative thirty degrees (−30°) to forty-five degrees (45°) reach <negative thirty (−30) decibels (dB). When a virtual sound-source exists within the proposed azimuth-elevation bounds, the peak-to-trough decibel value of −30 dB or more may be beneficial for producing accurate sound-source localization for the hearer.

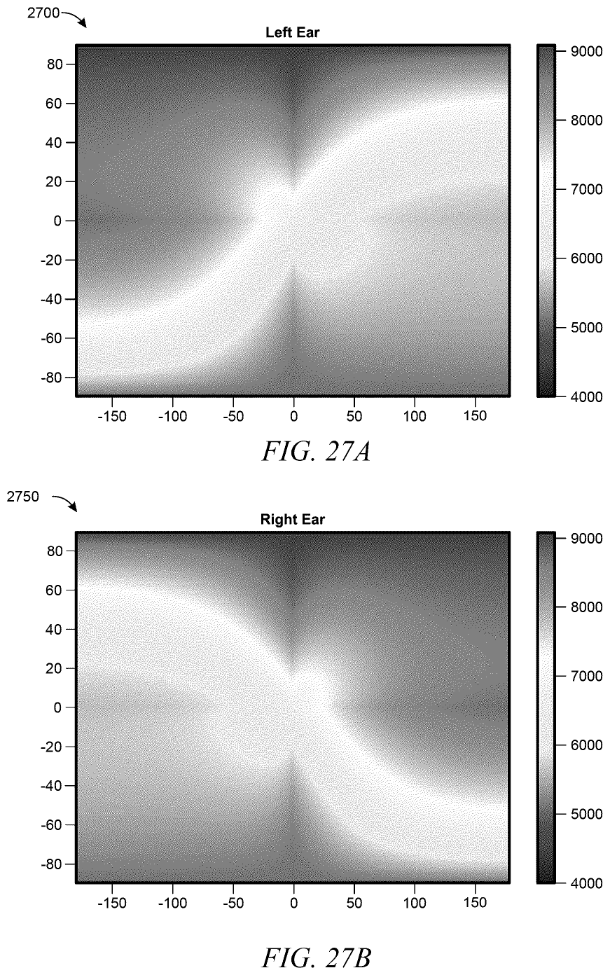

FIG. 27A depicts a distribution 2700 of center frequencies as a function of azimuth (x-axis) and elevation (y-axis) for the left ear. FIG. 27B depicts a distribution 2750 of center frequencies as a function of azimuth (x-axis) and elevation (y-axis) for the right ear. The distribution 2700 and the distribution 2750 indicate that, for any particular azimuth, the center frequencies follow a generally sigmoidal curve or have a generally sigmoidal shape or distribution. Similarly, for any particular elevation, the center frequencies follow a generally sigmoidal curve or have a generally sigmoidal shape or distribution.

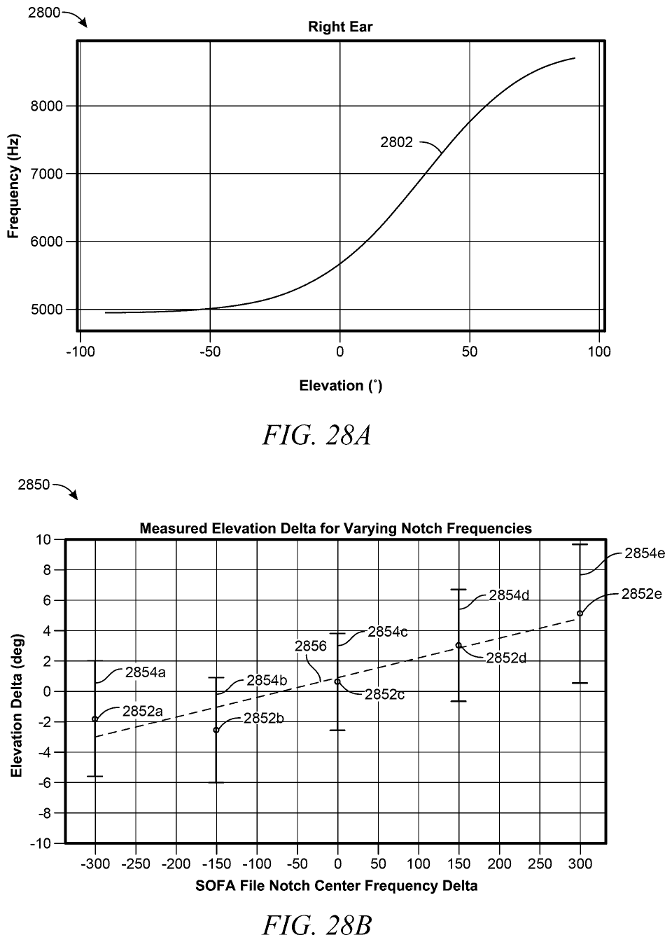

For example, FIG. 28A is a graph 2800 of a center frequency curve 2802 as a function of elevation (x-axis) for the right ear where the azimuth is zero degrees (0°). The center frequency values range from about approximately 4900 Hz to about approximately 8700 Hz from negative 90 degrees elevation to 90 degrees elevation. The center frequency curve 2802 has a generally sigmoidal shape or distribution.

Returning to FIGS. 27A and 27B, the virtual auditory display system 2302 may utilize the distribution 2700 and/or the distribution 2750 to determine the center frequencies for one or more notches in the frequency spectrums of audio signals. The virtual auditory display system 2302 may determine the center frequences for the one or more notches based on the location of the sounds in virtual auditory space that the audio signal will cause the first ear-worn device 2302a and the second ear-worn device 2302b to produce.

That is, based on the location (as specified by, for example, azimuth and elevation) of the sounds in virtual auditory space, the virtual auditory display system 2302 may determine the center frequencies for one or more notches in a frequency spectrum of the audio signals that cause the first ear-worn device 2302a and the second ear-worn device 2302b to produce the sounds. The virtual auditory display system 2302 may determine the center frequencies of the first notches in the frequency spectrums of the audio signals by accessing the distribution 2700 and the distribution 2750. The virtual auditory display system 2302 may determine the center frequencies of the second notches and subsequent notches in the frequency spectrums of the audio signals based on the distribution 2700 and the distribution 2750 and on one or more shifts from the center frequencies obtained from the distribution 2700 and the distribution 2750.

In some embodiments, in addition to or as an alternative to utilizing the distribution 2700 and/or the distribution 2750, the virtual auditory display system 2302 may utilize one or more center frequency curves, each of which may be for a different azimuth value, like the center frequency curve 2802 of FIG. 28A, or a different elevation value. The virtual auditory display system 2302 determines the center frequencies for one or more notches in a frequency spectrum of an audio signal, based on the location of the resulting sounds in virtual auditory space.

FIG. 28B is a graph 2850 of user experience data of multiple trials with five different digital filters, which vary as a function of notch center frequency, in some embodiments. Each of the point 2852a, the point 2852b, the point 2852c, the point 2852d, and the point 2852e is the mean of 15 user trials that collected real-time user feedback on perceived sound location in virtual auditory space, for a total of 75 user trials. The bar 2854a, the bar 2854b, the bar 2854c, the bar 2854d, and the bar 2854e each represent plus or minus one (1) standard deviation. The point 2852b, the point 2852c, the point 2852d and the point 2852e demonstrate that there is an observed delta of approximately 2.5° for each 150 Hz added to the notch center frequencies. The line 2856 can be fit to the points 2852. The virtual auditory display system 2302 may utilize the linear function that produced the line 2856 to determine the center frequency to use for one or more notches based on the elevation of the sound to be produced. For example, for certain ranges of elevations (for example, between approximately zero degrees and approximately 50 degrees, or between approximately 10 degrees and approximately 40 degrees), the virtual auditory display system 2302 may utilize the linear that produced the line 2856 to determine one or more shifts from a center frequency in the ranges. The virtual auditory display system 2302 may do so in addition to or as an alternative to utilizing the distribution 2700 and/or the distribution 2750 depicted in FIGS. 27A and 27B.

FIGS. 29A through 29X depict parameter modifier masks that may be applied to modify parameters used in generating digital filters in some embodiments. FIG. 29A depicts a right ear parameter modifier mask 2900a and FIG. 29B depicts a left ear parameter modifier mask 2900b for notch filters. FIG. 29C depicts a right ear parameter modifier mask 2905a and FIG. 29D depicts a left ear parameter modifier mask 2905b for head shadow filters. FIG. 29E depicts a right ear parameter modifier mask 2910a and FIG. 29F depicts a left ear parameter modifier mask 2910b for shelf filters. FIG. 29G depicts a right ear parameter modifier mask 2915a and FIG. 29H depicts a left ear parameter modifier mask 2915b for peak filters. FIG. 29I depicts a right ear parameter modifier mask 2920a and FIG. 29J depicts a left ear parameter modifier mask 2920b for beam filters. FIG. 29K depicts a right ear parameter modifier mask 2925a and FIG. 29L depicts a left ear parameter modifier mask 2925b for stereo filters.

FIG. 29M depicts a right ear parameter modifier mask 2930a and FIG. 29N depicts a left ear parameter modifier mask 2930b for rear filters. FIG. 29O depicts a right ear parameter modifier mask 2935a and FIG. 29P depicts a left ear parameter modifier mask 2935b for top filters. FIG. 29Q depicts a right ear parameter modifier mask 2940a and FIG. 29R depicts a left ear parameter modifier mask 2940b for top transition filters. FIG. 29S depicts a right ear parameter modifier mask 2945a and FIG. 29T depicts a left ear parameter modifier mask 2945b for bottom filters. FIG. 29U depicts a right ear parameter modifier mask 2950a and FIG. 29V depicts a left ear parameter modifier mask 2950b for bottom transition filters. FIG. 29W depicts a right ear parameter modifier mask 2955a and FIG. 29X depicts a left ear parameter modifier mask 2955b for broadside filters.

The parameter modifier masks depicted in FIGS. 29A-29X specify parameter modifier values as a function of a location in virtual auditory space as specified by, for example, azimuth and elevation. The parameter modifier values may range from between any two values. In some embodiments, the parameter modifier values range between zero (0), inclusive, and another value, such as one (1), 0.2, 0.4, 0.8, inclusive. The parameter mask module 2590 may generate the parameter modifier masks by specifying a particular region in virtual auditory space in which the values are to be one (1), and by specifying that regions other than the particular region have values of zero (0). For example, for the right ear parameter modifier mask 2900a of FIG. 29A, the particular region in virtual auditory space may be from approximately negative 50 (−50) degrees azimuth to approximately 110 degrees azimuth and from approximately negative 290 (−290) degrees elevation to approximately 30 degrees elevation. The parameter mask module 2590 may use other particular regions for the parameter modifier mask 2900a and the other parameter modifier masks in FIGS. 29A-29X.

The parameter mask module 2590 may use image processing algorithms to create continuous transitions of values between the particular region and the other regions to generate the parameter modifier masks with the parameter modifier values. For example, the parameter mask module 2590 may use image processing algorithms such as a gaussian function, a sharpening function, a contrast adjustment function, a color correction function, a thresholding function, an edge detection function, and/or a segmentation function. In some embodiments, the parameter mask module 2590 uses a gaussian blur mask to generate the parameter modifier values. The parameter mask module 2590 may generate the parameter modifier mask for a right ear and then reflect the parameter modifier mask for the right ear about a vertical axis at an azimuth value of zero (0) to obtain the parameter modifier mask for the right ear.

The filter generation module 2584 may utilize the parameter modifier masks depicted in FIGS. 29A-29X to select, based on a location for a sound in virtual auditory space, one or more parameter modifiers that the filter generation module 2584 may use to modify one or more parameters to obtain one or more modified parameters. For example, the filter generation module 2584 may utilize one or more parameter modifiers to modify the gain of digital filters. In some embodiments, the filter generation module 2584 multiplies the one or more parameters by the one or more parameter modifiers to obtain the one or more modified parameters. Other uses of parameter modifiers will be apparent.

FIG. 30A depicts a gain distribution 3070 for a head shadow for a left ear and FIG. 30B depicts a gain distribution 3080 for a head shadow for a right ear according to some embodiments. The gain distribution 3070 depicts how a gain changes as a sound source transitions from a location 3072 generally by the right ear to a location 3074 generally in front of the wearer to a location 3076 generally by the left ear. The gain distribution 3080 depicts how a gain changes as a sound source transitions from a location 3082 generally by the left ear to a location 3084 generally in front of the wearer to a location 3086 generally by the left ear.

FIG. 30C depicts a gain distribution 3060 of the application of digital filters to an audio signal according to some embodiments. The gain distribution 3060 shows several notches 3064 across a head shadow 3062. The several notches 3064 are at center frequencies between 10\hat{ }3 Hz and 10\hat{ }4 Hz.

FIG. 30D depicts user experience data for digital filters according to some embodiments and user experience data for a prior art head-related transfer function (HRTF). The prior art HRTF is used as a standard model for many past and present HRTF applications. Panel 3000 of FIG. 30D reports the difference between the user-perceived elevation of a virtual sound object and the actual elevation of the sound object for both the digital filters for 150 trials and the prior art HRTF for 150 trials. For the digital filters trials, point 3004 is the mean user-perceived elevation and band 3002 is the standard deviation of the user-perceived elevation. For the HRTF trials, point 3008 is the mean user-perceived elevation and band 3006 is the standard deviation of the user-perceived elevation.

Panel 3050 of FIG. 30D reports the difference between the user-perceived azimuth of a virtual sound object and the actual azimuth of the sound object for both the digital filters for 150 trials and the prior art HRTF for 150 trials. For the digital filters trials, point 3052 is the mean user-perceived azimuth and band 3054 is the standard deviation of the user-perceived azimuth. For the HRTF trials, point 3058 is the mean user-perceived azimuth and band 3056 is the standard deviation of the user-perceived azimuth.

For the elevation trials, the closer the elevation delta is to 0°, the more accurate the representation of the virtual sound object. Similarly, for the azimuth trials, the closer the elevation delta is to 0°, the more accurate the representation of the virtual sound object. The user experience data shows that the digital filters improve the elevation delta from a mean of approximately 30.19° with a standard deviation of approximately 12.54° to a mean of approximately −0.03° with a standard deviation of approximately 4.12°. The user experience data also shows the digital filters improves the azimuth delta from a mean of approximately −0.64° with a standard deviation of approximately 7.76° to a mean of approximately −0.02° with a standard deviation of approximately 2.04°. The data shows that the digital filters according to some embodiments improve the accuracy and precision of virtual sound objects.

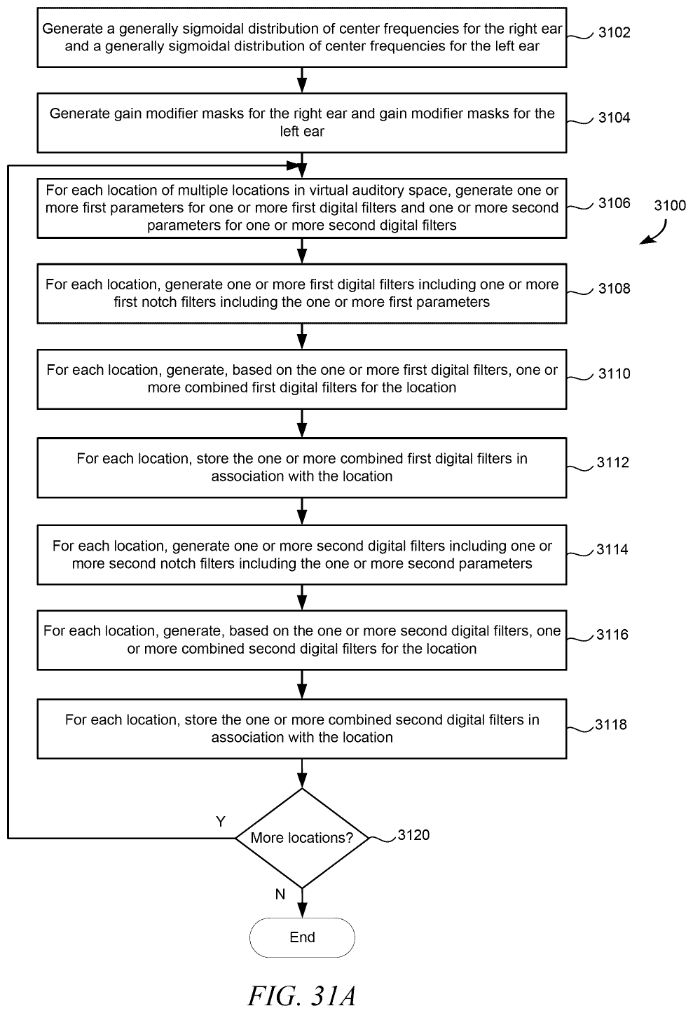

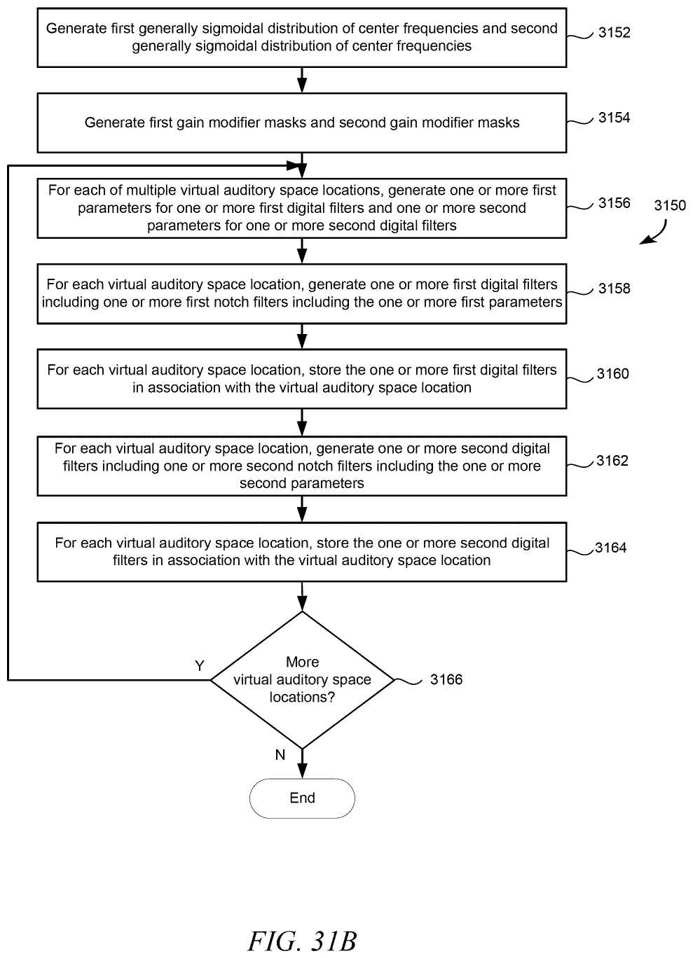

FIG. 31A depicts a method 3100 of generating digital filters according to some embodiments. The generation system 2580 may perform the method 3100. The generation system 2580 may perform the method 3100 to generate a set of combined first digital filters and a set of combined second digital filters. The method 3100 begins at a step 3102, where the generation system 2580 (for example, the filter generation module 2584) may generate a generally sigmoidal distribution of center frequencies for the right ear (see, for example, FIG. 27A) and a generally sigmoidal distribution of center frequencies for the left ear (see, for example, FIG. 27B).

At a step 3104 the generation system 2580 (for example, the parameter mask module 2590) generates parameter modifier masks for the right ear and parameter modifier masks for the left ear (see, for example, FIGS. 29A through 29X). The generation system 2580 may generate the parameter modifier masks using one or more image processing algorithms. The one or more image processing algorithms may include one or more of a gaussian function, a sharpening function, a contrast adjustment function, a color correction function, a thresholding function, an edge detection function, and a segmentation function.

At a step 3106, for each location of multiple locations in virtual auditory space, the generation system 2580 (for example, the parameter generation module 2588) may generate one or more first parameters for one or more first digital filters and one or more second parameters for one or more second digital filters. The one or more first parameters may include one or more first q's, one or more first gains, and one or more first center frequencies. The one or more second parameters may include one or more second q's, one or more second gains, and one or more second center frequencies.

The generation system 2580 may utilize the parameter modifier masks for the right ear and the parameter modifier masks for the left ear to select, based on the location in virtual auditory space, one or more parameter modifiers that the generation system 2580 may use to modify one or more parameter to obtain one or more modified parameter. In some embodiments, the generation system 2580 multiplies the one or more parameter by the one or more parameter modifiers to obtain the one or more modified parameter.

The generation system 2580 may utilize the generally sigmoidal distribution of center frequencies for the right ear and/or the generally sigmoidal distribution of center frequencies for the left ear to determine one or more center frequencies for one or more notches in the frequency spectrums of the audio signal for the right ear and the audio signal for the left ear. The generation system 2580 may determine the center frequences for the one or more notches based on the location in virtual auditory space.

At a step 3108, for each location, the generation system 2580 (for example, the filter generation module 2584) may generate one or more first digital filters including one or more first notch filters including the one or more first parameters. The generation system 2580 may utilize the one or more first q's, the one or more first gains, and the one or more first center frequencies to generate the one or more first notch filters. The one or more first notch filters are configured to produce one or more first notches in a first frequency spectrum of a first audio signal according to the one or more first q's, the one or more first gains, and the one or more first center frequencies when the generation system 2580 applies the one or more notch filters to an audio signal for the right ear.

At a step 3110, for each location, the generation system 2580 (for example, the filter generation module 2584) may generate, based on the one or more first digital filters, one or more combined first digital filters for the location. In some embodiments, the one or more first digital filters are IIR filters, and the one or more combined first digital filters are FIR filters.

At a step 3112, for each location, the generation system 2580 may store the one or more combined first digital filters in association with the location (in, for example, the data storage 2420).

At a step 3114, for each location, the generation system 2580 (for example, the filter generation module 2584) may generate one or more second digital filters including one or more second notch filters including the one or more second parameters. The generation system 2580 may utilize the one or more second q's, the one or more second gains, and the one or more second center frequencies to generate the one or more second notch filters. The one or more second notch filters are configured to produce one or more second notches in a second frequency spectrum of a second audio signal according to the one or more second q's, the one or more second gains, and the one or more second center frequencies when the generation system 2580 applies the one or more notch filters to an audio signal for the left ear.

At a step 3116, for each location, the generation system 2580 (for example, the filter generation module 2584) may generate, based on the one or more second digital filters, one or more combined second digital filters for the location. In some embodiments, the one or more second digital filters are IIR filters, and the one or more combined second digital filters are FIR filters.

At a step 3118, for each location, the generation system 2580 may store the one or more combined second digital filters in association with the location (in, for example, the data storage 2420).

At a step 3120 the generation system 2580 tests to see if there are more locations for which the generation system 2580 is to generate digital filters. If so, the method 3100 returns to step 3106. The generation system 2580 may perform the method 3100 multiple times to generate multiple sets of combined first digital filters and multiple sets of combined second digital filters. Each pair of sets of digital filters may be for a different archetype

In some embodiments, the generation system 2580 may perform the method 3100 several times to generate multiple sets of combined first digital filters and combined second digital filters. Each pair of sets may be for a different archetype representing a different user population or grouping of users.

FIG. 31B depicts a method 3150 of generating digital filters in some embodiments. The generation system 2580 may perform the method 3100. The method 3150 includes certain steps that may be generally similar to certain steps of the method 3100. The generation system 2580 (for example, various components of the generation system 2580) may perform the method 3150. The generation system 2580 may perform the method 3150 to generate a set of first digital filters and a set of second digital filters.

The method 3150 begins at a step 3152, where the generation system 2580 (for example, the parameter generation module 2588) may generate a first generally sigmoidal distribution of center frequencies and a second generally sigmoidal distribution of center frequencies. At a step 3154 the generation system 2580 (for example, the parameter mask module 2590) may generate first parameter modifier masks and second parameter modifier masks.

At a step 3156, for each of multiple virtual auditory space locations, the generation system 2580 (for example, the parameter generation module 2588) may generate one or more first parameters for one or more first digital filters and one or more second parameters for one or more second digital filters. The one or more first parameters may include one or more first q's, one or more first gains, and one or more first center frequencies. The one or more second parameters may include one or more second q's, one or more second gains, and one or more second center frequencies.

At a step 3158, for each virtual auditory space location, the generation system 2580 may generate one or more first digital filters including one or more first notch filters including the one or more first parameters. Step 3158 is generally similar to step 3108 of the method 3100.

At a step 3160, for each virtual auditory space location, the generation system 2580 may store the one or more first digital filters in association with the virtual auditory space location. Step 3160 is generally similar to step 3112 of the method 3100.

At a step 3162, for each virtual auditory space location, the generation system 2580 may generate one or more second digital filters including one or more second notch filters including the one or more second parameters. Step 3162 is generally similar to step 3114 of the method 3100.

At a step 3164, for each virtual auditory space location, the generation system 2580 may store the one or more second digital filters in association with the virtual auditory space location. Step 3164 is generally similar to step 3118 of the method 3100.

At a step 3166 the generation system 2580 tests to see if there are more virtual auditory space locations for which the generation system 2580 is to generate digital filters. If so, the method 3100 returns to step 3156. The generation system 2580 may perform the method 3150 multiple times to generate multiple sets of one or more first digital filters and multiple sets of one or more second digital filters.

The method 3100 and the method 3150 may include additional steps. For example, the generation system 2580 may provide for testing digital filters. The generation system 2580 (for example, the user interface module 2594) may provide a user interface that allows for sound generated by audio signals to which digital filters have been applied to be played. A user may listen to the sounds and determine that one or more parameters of the digital filters should be modified. For example, the user may modify parameters of digital filters to ensure that sounds meet required thresholds of tonal quality, clarity, brightness, and the like. The generation system 2580 may provide another user interface that allows the user to modify the one or more parameters of the digital filters. The generation system 2580 (for example, the digital filter tuning module 2592) may receive the one or more parameters of the digital filters from users and modify digital filters based on the received one or more parameters.

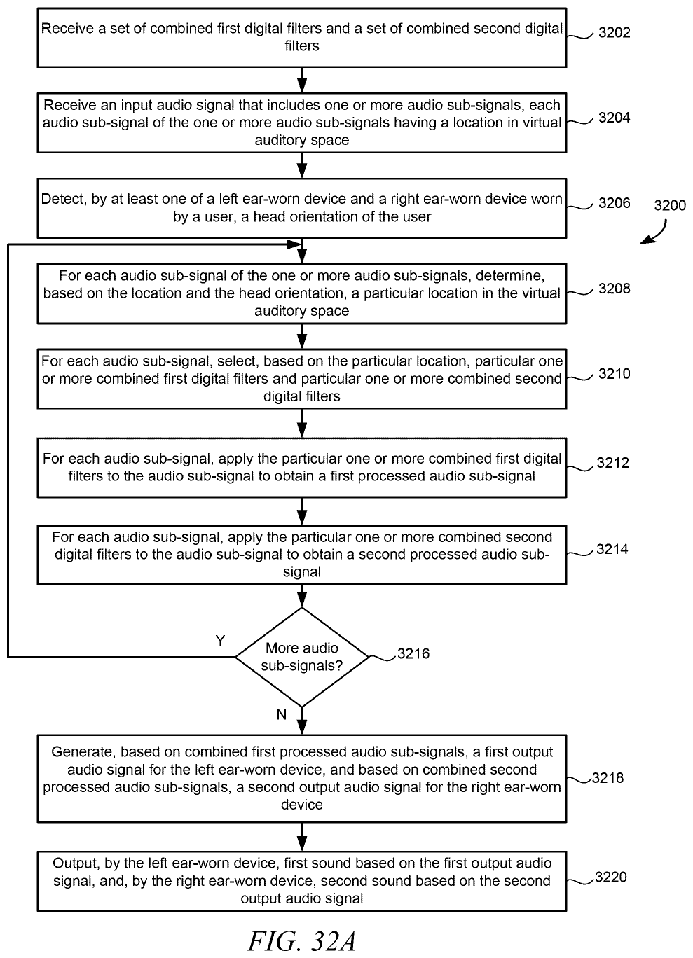

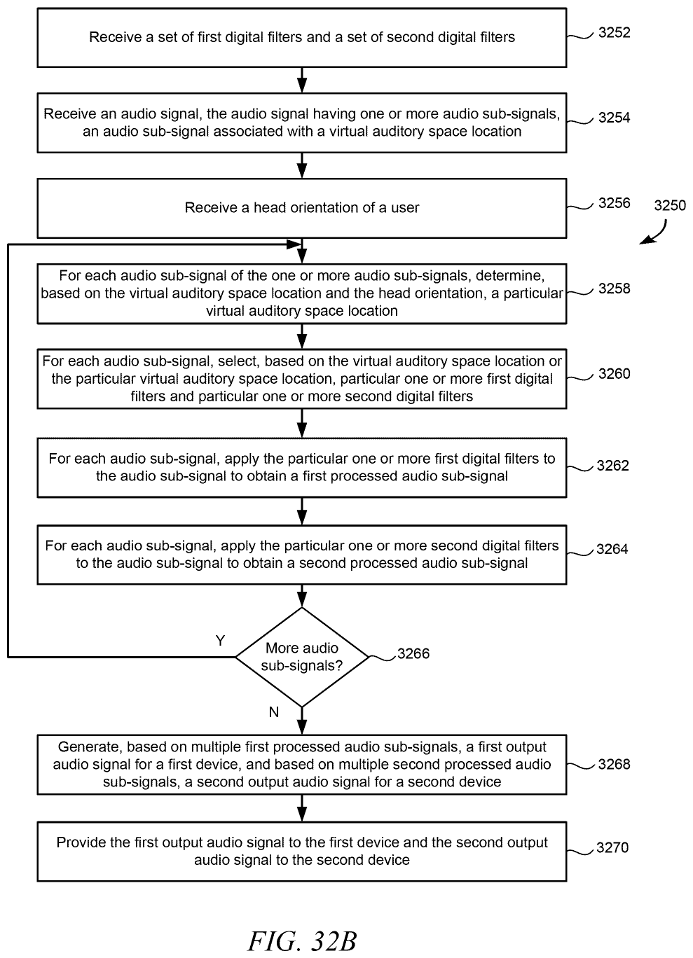

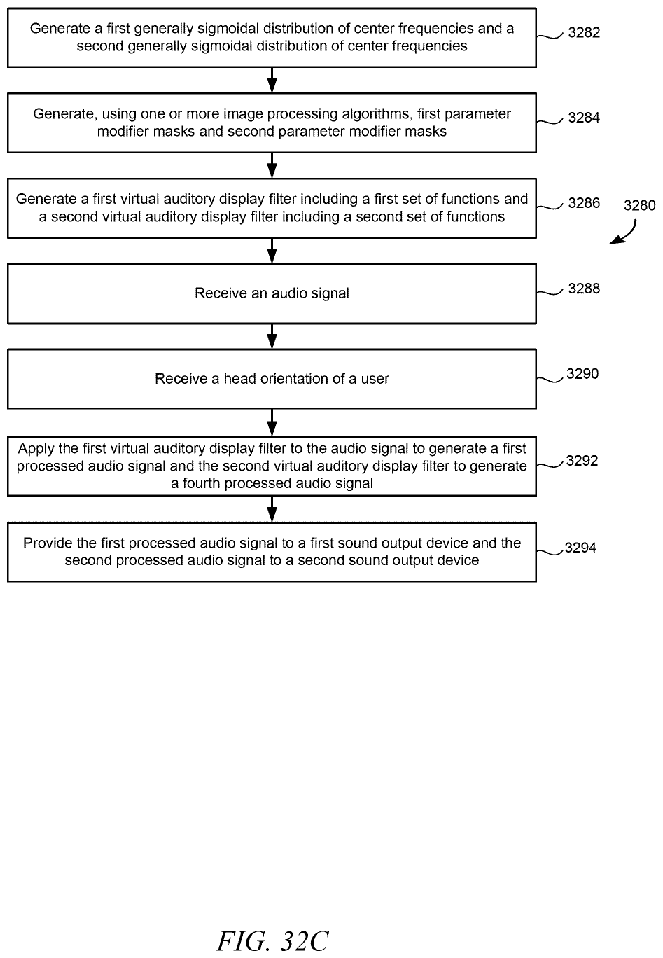

FIG. 32A depicts a method 3200 of applying digital filters according to some embodiments. The virtual auditory display system 2302 and the virtual auditory display device 2300 may perform the method 3200. The method 3200 begins at a step 3202, where the virtual auditory display system 2302 (for example, the binauralizer 2338) receives a set of combined first digital filters and a set of combined second digital filters. At a step 3204 the virtual auditory display system 2302 (for example, the binauralizer 2338) receives an input audio signal that includes one or more audio sub-signals. Each audio sub-signal of the one or more audio sub-signals has a location in virtual auditory space.

While receiving the input audio signal, the virtual auditory display system 2302 performs step 3206 through step 3220 of the method 3200. At step 3206 one or both of the first ear-worn device 2302a and the second ear-worn device 2302b detects a head orientation of the user wearing the first ear-worn device 2302a and the second ear-worn device 2302b. The first ear-worn device 2302a and/or the second ear-worn device 2302b provide the head orientation to the virtual auditory display system 2302.

At a step 3208, for each audio sub-signal of the one or more audio sub-signals, the virtual auditory display system 2302 determines, based on the location of the audio sub-signal and the head orientation, a particular location in the virtual auditory space. At a step 3210, for each audio sub-signal, the virtual auditory display system 2302 selects, based on the particular location, particular one or more combined first digital filters and particular one or more combined second digital filters.

At a step 3212, for each audio sub-signal, the virtual auditory display system 2302 applies the particular one or more combined first digital filters to the audio sub-signal to obtain a first processed audio sub-signal. At a step 3214, for each audio sub-signal, the virtual auditory display system 2302 applies the particular one or more combined second digital filters to the audio sub-signal to obtain a second processed audio sub-signal.

At a step 3216 the virtual auditory display system 2302 tests to see if there are more audio sub-signals to process. If so, the method 3200 returns to step 3208. If not the method 3200 continues to step 3218. After processing all the audio sub-signals the virtual auditory display system 2302 obtains multiple first processed audio sub-signals and multiple second processed audio sub-signals.

At a step 3218 the virtual auditory display system 2302 generates, based on the multiple first processed audio sub-signals, a first output audio signal for the left ear-worn device, and based on the multiple second processed audio sub-signals, a second output audio signal for the right ear-worn device. The virtual auditory display system 2302 provides the first output audio signal to the first ear-worn device 2302a and the second output audio signal to the second ear-worn device 2302b.

At a step 3220 the first ear-worn device 2302a outputs first sound based on the first output audio signal and the second ear-worn device 2302b outputs second sound based on the second output audio signal. The virtual auditory display system 2302 may thus utilize the method 3200 to provide virtual auditory display sound based on an audio signal that may have multiple audio sub-signals (or channels) that would typically require multiple speakers to produce a surround sound effect. The virtual auditory display system 2302 may provide the virtual auditory display sound to the user using only the first ear-worn device 2302a and the second ear-worn device 2302b.

FIG. 32B depicts a method 3250 of applying digital filters according to some embodiments. The method 3250 includes certain steps that may be generally similar to certain steps of the method 3200. The virtual auditory display system 2302 may perform the method 3250.

The method 3250 begins at a step 3252, where the virtual auditory display system 2302 (for example, the binauralizer 2338) receives a set of one or more first digital filters and a set of one or more second digital filters. At a step 3254 the virtual auditory display system 2302 (for example, the binauralizer 2338) receives an audio signal that has one or more audio sub-signals. Each audio sub-signal of the one or more audio sub-signals is associated with a virtual auditory space location.

At a step 3256 the virtual auditory display system 2302 receives a head orientation of a user. At a step 3258, for each audio sub-signal of the one or more audio sub-signals, the virtual auditory display system 2302 determines, based on the virtual auditory space location and the head orientation, a particular virtual auditory space location. At a step 3260, for each audio sub-signal, the virtual auditory display system 2302 selects, based on the virtual auditory space location or the particular virtual auditory space location, particular one or more first digital filters and particular one or more second digital filters.

At a step 3262, for each audio sub-signal, the virtual auditory display system 2302 applies the particular one or more first digital filters to the audio sub-signal to obtain a first processed audio sub-signal. At a step 3264, for each audio sub-signal, the virtual auditory display system 2302 applies the particular one or more second digital filters to the audio sub-signal to obtain a second processed audio sub-signal.

At a step 3266 the virtual auditory display system 2302 tests to see if there are more audio sub-signals to process. If so, the method 3250 returns to step 3258. If not the method 3200 continues to step 3268. After processing all the audio sub-signals the virtual auditory display system 2302 obtains multiple first processed audio sub-signals and multiple second processed audio sub-signals.

At a step 3268 the virtual auditory display system 2302 generates, based on multiple first processed audio sub-signals, a first output audio signal for a first device, and based on multiple second processed audio sub-signals, a second output audio signal for a second device. The first device may be or include, for example, the first ear-worn device 2302a, and the second device may be or include, for example, the second ear-worn device 2302b. At a step 3270 the virtual auditory display system 2302 provides the first output audio signal to the first device and the second output audio signal to the second device.

FIG. 32C depicts a method 3280 of generating and applying virtual auditory display filters in some embodiments. The generation system 2580 and the virtual auditory display system 2302 may perform the method 3200. The method 3280 begins at a step 3282 where the generation system 2580 (for example, the parameter generation module 2588) may generate a first generally sigmoidal distribution of center frequencies and a second generally sigmoidal distribution of center frequencies. At a step 3284 the generation system 2580 (for example, the parameter mask module 2590) may generate first parameter modifier masks and second parameter modifier masks, including a first notch parameter modifier mask and a second notch parameter modifier mask.

At a step 3286 the generation system 2580 (for example, the filter generation module 2584) may generate a first virtual auditory display filter and a second virtual auditory display filter. The first virtual auditory display filter may include a first set of first functions. One or more first functions, when applied to a first audio signal having a first location in virtual auditory space, may generate a first processed audio signal having a first frequency response with one or more first notches at one or more first center frequencies that are based on the first location. The one or more first notches may have one or more first peak-to-trough depths of at most −10 dB (for example, approximately −30 dB).

The second virtual auditory display filter may include a second set of second functions. One or more second functions, when applied to the first audio signal, may generate a second processed audio signal having a second frequency response with one or more second notches at one or more second center frequencies that are based on the second location. The one or more second notches may have one or more second peak-to-trough depths of at most −10 dB (for example, approximately −30 dB).

At a step 3288 the virtual auditory display system 2302 may receive an audio signal having a second location in the virtual auditory space. For example, the virtual auditory display system 2302 may receive the audio signal from a digital device on which the virtual auditory display system 2302 is executing. At a step 3290 the virtual auditory display system 2302 may receive a head orientation of a user, for example, from the virtual auditory display device 2300 that the user is utilizing.

At a step 3292 the virtual auditory display system 2302 may apply the first virtual auditory display filter, including a first subset of first functions selected based on the second location, to the second audio signal to generate a third processed audio signal having a third frequency response. At a step 3294 the virtual auditory display system 2302 may apply the second virtual auditory display filter, including a second subset of second functions selected based on the second location, to the second audio signal to generate a fourth processed audio signal having a fourth frequency response. At a step 3294 the virtual auditory display system 2302 may provide the first processed audio signal to a first sound output device (for example, the first ear-worn device 2302a) and the second processed audio signal to a second sound output device (for example, the second ear-worn device 2302b).

The virtual auditory display system 2302 may perform step 3288 through step 3294 of the method 3280 while the virtual auditory display system 2302 is receiving an input audio signal that may correspond to, for example, a song file, an audio stream, a podcast, or any other audio.

The method 3200, the method 3250, and the method 3280 may include additional steps not illustrated in FIGS. 32A through 32C. For example, these methods may include a step of the virtual auditory display system 2302 receiving a selection of an acoustic environment and a step of the virtual auditory display system 2302 determining, based on the acoustic environment, a first acoustic environment digital filter and a second acoustic environment digital filter. The acoustic environment may be represented by one or more ambisonic arrays. The virtual auditory display system 2302 may determine the acoustic environment digital filters based on the one or more ambisonics arrays. The virtual auditory display system 2302 may apply the digital filters and the acoustic environment digital filters to obtain the processed audio sub-signals. Other modifications to these methods will be apparent.

FIG. 24C is a block diagram depicting a process 2490 for generating acoustic environment digital filters in some embodiments. A first speaker 2492a and a second speaker 2492b may be in a particular acoustic environment, such as a concert hall, a vehicle, a night club, or the like. Sound output by the first speaker 2492a and the second speaker 2492b are captured by a microphone 2494 and converted into signals. The virtual auditory display system 2302 (for example, the filter generation module 2584) generates one or more ambisonics digital filters 2496 based on the signals. The one or more ambisonics digital filters 2496 are a set of one or more acoustic environment digital filters 2498.

FIG. 24D is a block diagram depicting operations of a spatialization engine 2470 of the virtual auditory display system 2302 in some embodiments. The spatialization engine 2470 may be part of the binauralizer 2338 or a separate component. The spatialization engine 2470 receives a user interface (UI) selected acoustic environment at a block 2472 and determines acoustic environment digital filters based on the selected acoustic environment at a block 2474. The spatialization engine 2470 receives coordinates and the input audio signal of decoded audio objects at a block 2476. At a block 2478 the spatialization engine 2470 matches an index of the acoustic environment digital filters to an input audio signal index. At a block 2480 the spatialization engine 2470 applies a convolution matrix to the output of the block 2478 and the coordinates and the input audio signal.

At a block 2482 the spatialization engine 2470 receives the user head orientation and audio source distance signal. At a block 2484 the spatialization engine performs an ambisonics to binaural conversion based on the output of the block 2480 and the user head orientation and audio source distance signal, by applying digital filters to the audio signals received at a block 2476 based on the locations of the audio signals in virtual auditory space. At a block 2486 the spatialization engine 2470 outputs the audio signal for the left ear and at a block 2488 the spatialization engine 2470 outputs the audio signal for the right ear.

FIGS. 33A and 33B depict an example user interface 3300 for displaying a representation of a virtual audio display in some embodiments. The virtual auditory display system 2302 (for example, the user interface module 2410) may provide the user interface 3300. FIGS. 33A and 33B are described with reference to the virtual auditory display device 2300, but the virtual auditory display system 2302 may provide the user interface 3300 for other devices.

The user interface 3300 includes an icon 3304 labeled “VAD” indicating that the virtual auditory display device 2300 is connected to the virtual auditory display system 2302 and an icon 3302 labeled “IMU” indicating that the IMU-based sensor systems of the virtual auditory display device 2300 are calibrated. The user interface 3300 also includes an encoding representation dropdown 3314 that allows the wearer to select how the virtual auditory display system 2302 should represent audio received by the virtual auditory display system 2302. Example encoding representations are mono (a single audio channel), stereo (two channels of audio), 5.1 5.1 (six channels of audio), 7.1 (eight channels of audio), 7.1.4 (12 channels of audio), and 9.1.6 (16 channels of audio).

The user interface 3300 also includes an acoustic environment dropdown 3316 that allows the wearer to select an acoustic environment in which the virtual auditory display system 2302 should render the virtual auditory display. Example acoustic environments include a dry acoustic environment, a studio acoustic environment, a car acoustic environment, a phone acoustic environment, a club acoustic environment, and a headphone acoustic environment. The virtual auditory display system 2302 may select an acoustic environment digital filter based on the selected acoustic environment and apply the acoustic environment digital filter along with the virtual auditory display filters. The virtual auditory display sounds will sound different for the wearer based on the selected acoustic environment. The user interface 3300 also includes an output volume slider 3322 allowing the wearer to adjust the volume of the sound output by the virtual auditory display device 2300.

The user interface 3300 also includes a representation 3308 of a virtual audio display. In FIG. 33A, the virtual auditory display system 2302 depicts the representation 3308 as a virtual sphere surrounding a head 3312 representing the head of the wearer from a top rear perspective. The user interface 3300 also displays sounds at their locations in virtual auditory space relative to the head of the wearer at corresponding locations relative to the head 3312 on the representation 3308. For example, sounds 3310a are depicted as to the left of, below, and to the rear of the head 3312. This is because the actual sounds corresponding to the sounds 3310a have those locations in virtual auditory space. Sounds 3310b are depicted as above, behind, and slightly to the left of the head 3312. Sounds 3310c are depicted as in front of and to the right of the head 3312. Sounds 3310d are depicted as to the right of, below, and to the rear of the head 3312.

While outputting sounds, the virtual auditory display device 2300 detects head orientations of the wearer and sends the head orientation to the virtual auditory display system 2302. The virtual auditory display system 2302 updates the representation 3308 based on the detected head orientations. The virtual auditory display system 2302 may move the head 3312 and the sounds 3310 based on the detected head orientations.

The user interface 3300 also includes a virtual auditory display representation dropdown 3318 that allows the wearer to select how the virtual auditory display system 2302 provides the virtual auditory display representation. Example virtual auditory display representations include a custom representation (depicted in FIG. 33A), which provides the wearer a top right rear perspective of the representation 3308, a top representation (depicted in FIG. 33B), which provides the wearer a top perspective of the representation 3308 (from the top of the sphere in FIG. 33A), and a back representation, which provides the wearer a rear perspective of the representation 3308 (from the rear of the sphere in FIG. 33A).

The user interface 3300 also includes a location button 3320 which, if selected by the wearer, may cause the virtual auditory display system 2302 to change the representation 3308 such that the location specified by a certain coordinate (for example, zero degrees azimuth, zero degrees elevation) may be directly in front of the head 3312. The user interface 3300 also includes a settings icon 3306 which, if selected by the wearer, may cause the virtual auditory display system 2302 to provide an example user interface for adjusting settings for a virtual audio display.

FIG. 33C depicts an example user interface 3350 for adjusting settings for a virtual audio display in some embodiments. The virtual auditory display system 2302 (for example, the user interface module 2410) may provide the user interface 3350. The user interface 3350 includes an icon 3352 labeled “IMU” indicating that the IMU-based sensor systems of the virtual auditory display device 2300 are calibrated. The user interface 3350 also includes a button 3354 labeled “Recalibrate” that the wearer may select to have the virtual auditory display system 2302 perform the calibration part of the calibration and/or personalization process.

The user interface 3350 also includes an icon 3356 labeled “VAD” indicating that the virtual auditory display device 2300 is connected to the virtual auditory display system 2302, a recommendation 3358 of a virtual auditory display filter, and a button 3360 labeled “Personalize” that the wearer may select to have the virtual auditory display system 2302 perform the personalization part of the calibration and/or personalization process. The user interface 3350 also indicates the spatialization precision estimate of the virtual auditory display of the wearer and a button 3362 labeled “Test” that the wearer may select to have the virtual auditory display system 2302 provide a test procedure for the wearer to allow the wearer to test to see if the wearer can accurately locate virtual auditory display sounds.

The user interface 3350 also includes a group 3364 of icons (labeled “A” through “G”) that indicates the set of virtual auditory display filters that create the virtual auditory display for the wearer. As depicted, the current set of virtual auditory display filters is “VAD C.” The wearer may select a different set of virtual auditory display filters by selecting a different icon in the group 3364. The wearer may then perform the calibration part of the calibration and/or personalization process by selecting the button 3354 and/or perform the personalization part of the calibration and/or personalization process by selecting the button 3360.

The user interface 3350 also allows the wearer to select a custom set of digital filters for the virtual auditory display system 2302 to use to generate the virtual auditory display. The wearer may do so by selecting a button 3368 labeled “Upload,” which allows the wearer to upload a file containing a custom set of digital filters to the virtual auditory display system 2302. The user interface element 3366 may then display the name of the file. This functionality may be desirable for wearers who already have a custom HRTF and want the virtual auditory display system 2302 to utilize the custom HRTF.

FIG. 34 is multiple images 3400 depicting example use cases of virtual auditory display filter technology described in this application in some embodiments. One example use case is for improved virtual surround sound for television or movies using only a pair of speakers, as depicted in image 3402. A group of example use cases relates to producing or listening to music. Image 3410 depicts an example use case of listening to music on headphones. The virtual auditory display filter technology may render music played on headphones as indistinguishable from music played using physical surround sound installations.

Image 3418 depicts the use of virtual auditory display filter technology in virtual monitors to provide noise isolation, sound quality, and virtualization to musicians. Image 3404 depicts the use of the virtual auditory display filter technology to mix music in any acoustic environment. Image 3420 depicts how the virtual auditory display filter technology may provide a listening experience that reinvigorates the music that listeners love for them. Image 3412 depicts using virtual auditory display filter technology in games to provide an immersive gaming experience. virtual auditory display filter technology may allow users to hear sounds emanating from locations that are not shown on users' displays and thus improve users' awareness.

Another group of example use cases relate to military, non-military (for example, first responders such as police and firefighters) and/or other organizational applications. For example, military personnel may use military radio systems to communicate with fellow soldiers, commanders, and other military personnel. The present technology may be utilized in scenarios including military operations, emergency services, aviation, marine and others.

Image 3406 depicts virtual auditory display filter technology providing improved voice pickup and voice display for organizational communications. Image 3414 depicts virtual auditory display filter technology providing augmentation of visual instrumentation with auditory signals in maritime operations. Image 3422 depicts virtual auditory display filter technology providing hyper-realistic virtual audio environments which facilitates virtual training for military and/or non-military personnel.

Image 3408 depicts virtual auditory display filter technology providing audio augmentation for orientation awareness for combat infantry situational awareness. Image 3416 depicts virtual auditory display filter technology providing audio augmentation for orientation awareness for air force orientation control. For example, pilots may use the localization of virtual beacons to assist in situational awareness. Image 3424 depicts virtual auditory display filter technology providing audio augmentation for hyper-situational awareness for unmanned aerial vehicle operations.

Another example use case of virtual auditory display filter technology involves phone calls or video conferences. For example, multiple people may talk at the same time in a phone call or video conference, making it difficult for listeners to focus on the speaker they want to hear, which may lead to confusion and misunderstandings. The present technology allows users to virtually select which talker they want to listen to through the simple movement of a head or other gesture. This attention selection mechanism may help avoid confusion and make meetings more productive.

As another example, air traffic controllers use radio messages to communicate with pilots. The air traffic controllers monitor the position, speed and altitude of aircraft in their assigned airspace visually and by radar and give directions to the pilots by radio. Often, air traffic controllers will need to communicate with multiple pilots simultaneously. Today, these situations requiring multiple pilot communications are addressed by physical switch boards that do not allow for user directed attention selection. The present technology may allow an air traffic controller to use gestures (for example, movement of a head or a hand) or other actions to localize radio communications so that there is seamless attention selection. In a simple example, multiple radio communication signals are statically arranged in unique virtual locations. The air traffic controller then looks at these predefined locations to hear the radio signal. In other examples, the radio communication signals are dynamically updated with the position, speed and altitude of the aircraft.

Other example use cases include virtual auditory display notifications to localize notifications such as voice, text-to-speech messages, email alerts, phone messages or other audio notifications, spatial navigation to use virtual auditory display cues to communicate direction and distance of virtual or real objects, which may also be used for wayfinding or orientation awareness, and spatial ambience to give a user a virtual sound environment that can be mixed with local or virtual sounds (for example, to experience music as if in a concert hall). Other example use cases of virtual auditory display filter technology are possible.

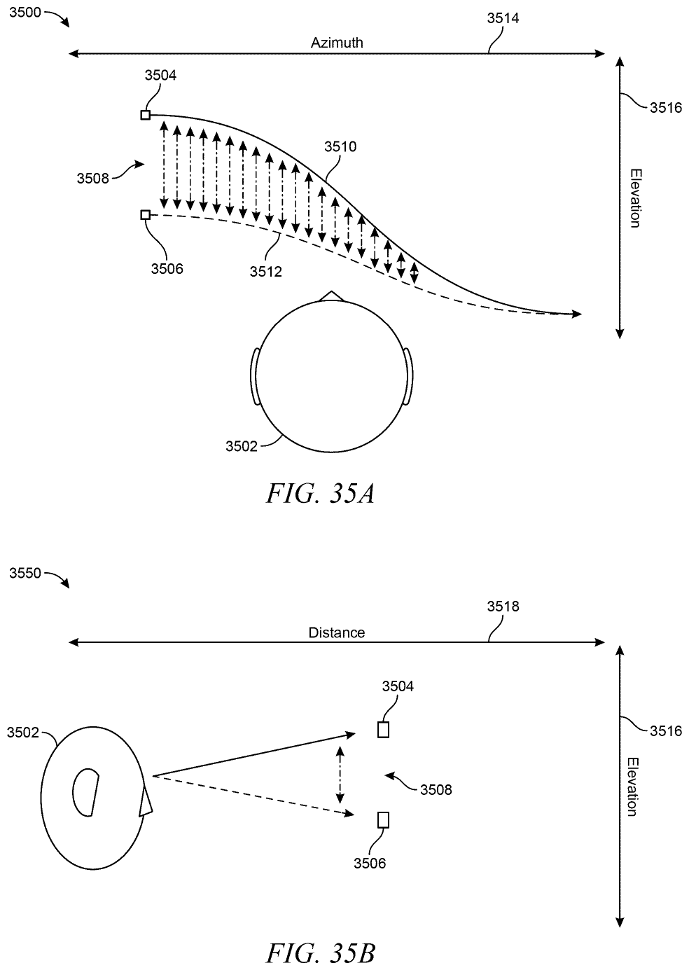

FIGS. 35A and 35B are diagrams of a method of personalizing digital filters in some embodiments that involves providing an action (for example, playing a sound) and detecting a user perception of the action. As described herein, the user may indicate perception of the action in various ways, such as by pointing his or her head, making one or more gestures, indicating where the sound is on a graphical user interface, and the like.

FIG. 35A depicts a view 3500 indicating how the location of a sound in virtual auditory space as indicated by azimuth 3514 and elevation 3516 may be perceived by a user. FIG. 35B depicts a view 3550 indicating how the location of a sound in virtual auditory space as indicated by distance 3518 and elevation 3516 may be perceived by a user. In both the view 3500 and the view 3550, the user 3502 is wearing the first ear-worn device 2302a and the second ear-worn device 2302b (not illustrated in FIGS. 35A and 35B). The virtual auditory display system 2302 may provide instructions to the user 3502 to follow a sound in virtual auditory space with the user's head as the user hears the sound. The virtual auditory display system 2302 may then generate audio signals that cause the first ear-worn device 2302a and the second ear-worn device 2302b to output one or more sounds that have a location 3504 in virtual auditory space. As the user 3502 hears the one or more sounds, the user 3502 may point his or her head towards a perceived location 3506 the user perceives the sound to be coming from, which may be different from the location 3504. In pointing his or her head towards the perceived location 3506, it may appear as if the user 3502 is looking in the direction of where the user 3502 perceives the sound to be. Other gestures the user may make with his or her head include nodding, shaking, tilting, and turning. Other head gestures will be apparent.

As the user 3502 moves his or her head to point towards the perceived location 3506 of the one or more sounds, one or both of the first ear-worn device 2302a and the second ear-worn device 2302b (for example, using the IMU sensor system 2452 and/or the magnetometer 2454) may detect a head orientation of the user 3502. The virtual auditory display system 2302 may utilize the detected head orientation to determine the perceived location 3506. The virtual auditory display system 2302 may then determine a delta 3508 between the location 3504 and the perceived location 3506. The virtual auditory display system 2302 may calculate the delta 3508 based on differences between the azimuth 3514 and/or elevation 3516 of the location 3504 and the azimuth 3514 and/or elevation 3516 of the perceived location 3506.

The user 3502 may user other gestures to indicate distance, such as extending an arm a specified amount, and the virtual auditory display system 2302 may use such gestures to determine the delta 3508 based on differences between the distance 3518 of the location 3504 and the distance 3518 of the perceived location 3506.

The virtual auditory display system 2302 may generate audio signals that cause the first ear-worn device 2302a and the second ear-worn device 2302b to output one or more subsequent sounds whose locations in virtual auditory space change, as indicated by solid line 3510. The user 3502 may move his or her head to follow the movement of the one or more subsequent sounds, and the perceived locations of the one or more sounds may change, as indicated by dashed line 3512.

One or both of the first ear-worn device 2302a and the second ear-worn device 2302b may detect subsequent head orientations of the user 3502 as he or she moves his or her head. The virtual auditory display system 2302 may utilize the detected subsequent head orientations to determine perceived locations of the one or more subsequent sounds. The virtual auditory display system 2302 may then determine one or more subsequent deltas between the location of the one or more subsequent sounds and the perceived locations of the one or more subsequent sounds.

The virtual auditory display system 2302 may store the deltas that the virtual auditory display system 2302 determines and utilize the deltas to modify the digital filters so as to cause the user 3502 to perceive the location of sounds in virtual auditory space to be closer to the actual locations in virtual auditory space. In some embodiments, the virtual auditory display system 2302 modifies the digital filters by selecting a different set of digital filters that the virtual auditory display system 2302 determines will reduce or minimize the deltas for the user 3502. The virtual auditory display system 2302 may then use the different set of digital filters for the user 3502.

In some embodiments, the virtual auditory display system 2302 modifies the parameters of the digital filters. For example, the virtual auditory display system 2302 may modify parameters such as center frequencies, gains, and/or q's. For example, the user 3502 may have an elevation delta of several degrees. The virtual auditory display system 2302 may modify the center frequency of a notch, a pair of notches, or a group of notches (see, for example, FIG. 28B) to modify the elevation of a virtual sound object and thereby reduce the elevation delta. The virtual auditory display system 2302 may then utilize the modified digital filters during real-time audio playback.

The virtual auditory display system 2302 may repeat the personalization procedure one or more times until the virtual auditory display system 2302 determines that the deltas are within certain ranges or thresholds.

In some embodiments, the virtual auditory display system 2302 and/or other devices may capture other actions that the user may make in response to the user hearing a sound in virtual auditory space to indicate where the user perceives the location of the sound to be. Example actions may include vocal responses by the user, gestures by the user using parts of the user's body other than the user's head (for example, pointing with a finger or an arm of the user, waving, clapping, tapping and hand signals). Such actions may be captured by a device connected to the virtual auditory display system 2302, such as a microphone, camera or a motion sensing device.

Other example actions include the user indicating the perceived location of the sound using a graphical user interface and/or user input devices of a digital device such as a phone, tablet or laptop or desktop computer. For example, the virtual auditory display system 2302 may provide a graphical user interface that graphically represents virtual auditory space for the user, and the user may utilize an input device (mouse, keyboard, touchscreen, and/or voice command) to indicate the perceived location of the sound on the graphical representation of the virtual auditory space. It will be appreciated that there are various methods to capture user actions in response to the user perception of the location of the sound, and that the virtual auditory display system 2302, optionally in cooperation with other devices, may utilize the various methods.

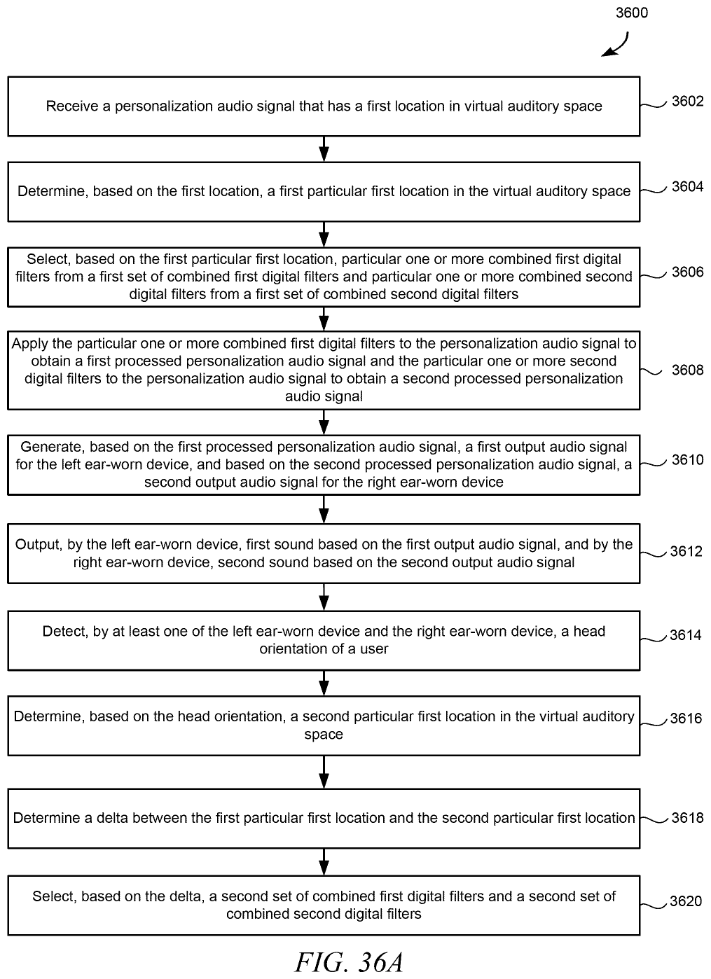

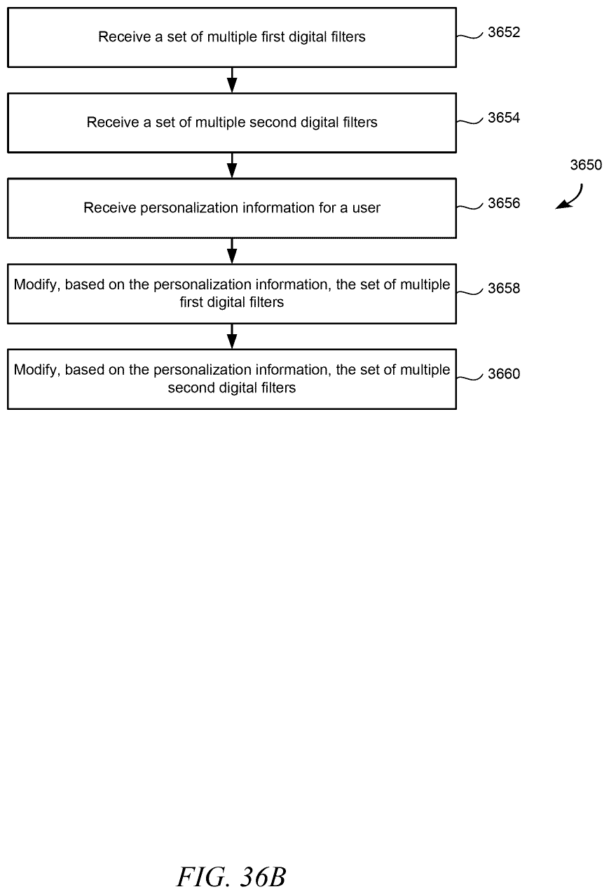

FIG. 36A depicts a method 3600 of personalizing digital filters in some embodiments. The virtual auditory display system 2302 may perform the method 3600. The method 3600 begins at a step 3602 where the virtual auditory display system 2302 (for example, the binauralizer 2338) receives a personalization audio signal that has a first location in virtual auditory space. At a step 3604 the virtual auditory display system 2302 (for example, the binauralizer 2338) determines, based on the first location, a first particular first location in the virtual auditory space.

At a step 3606 the virtual auditory display system 2302 selects, based on the first particular first location, particular one or more combined first digital filters from a first set of combined first digital filters and particular one or more combined second digital filters from a first set of combined second digital filters.

At a step 3608 the virtual auditory display system 2302 applies the particular one or more combined first digital filters to the personalization audio signal to obtain a first processed personalization audio signal and the particular one or more combined second digital filters to the personalization audio signal to obtain a second processed personalization audio signal.

At a step 3610 the virtual auditory display system 2302 generates, based on the first processed personalization audio signal, a first output audio signal for a left ear-worn device, and based on the second processed personalization audio signal, a second output audio signal for a right ear-worn device. At a step 3612 the left ear-worn device outputs first sound based on the first output audio signal and the right ear-worn device outputs second sound based on the second output audio signal.

At a step 3614 one or both of the left ear-worn device and the right ear-worn device detects a head orientation of a user wearing the left ear-worn device and the right ear-worn device. At a step 3616 the virtual auditory display system 2302 determines, based on the head orientation, a second particular first location in the virtual auditory space.

At a step 3618 the virtual auditory display system 2302 determines a delta between the first particular first location and the second particular first location. At a step 3620 the virtual auditory display system 2302 selects, based on the delta, a second set of combined first digital filters and a second set of combined second digital filters. The virtual auditory display system 2302 may use the second set of combined first digital filters and the second set of combined second digital filters while receiving a subsequent input audio signal.

FIG. 36B depicts a method 3650 of personalizing digital filters in some embodiments. The method 3650 includes certain steps that may be generally similar to certain steps of the method 3600. The virtual auditory display system 2302 (for example, various components of the virtual auditory display system 2302) may perform the method 3650.

At a step 3652 the virtual auditory display system 2302 receives a set of multiple first digital filters. At a step 3654 the virtual auditory display system 2302 receives a set of multiple second digital filters. There are one or more first digital filters and one or more second digital filters generated for each of multiple virtual auditory space locations.

At a step 3656 the virtual auditory display system 2302 receives personalization information for a user. Personalization information may include user-directed action or perception of acoustic cues, acoustic quality information, user anatomical measurements, user demographic information, and/or user audiometric measurements.

At a step 3658 the virtual auditory display system 2302 modifies, based on the personalization information for the user, the set of multiple first digital filters. At a step 3660 the virtual auditory display system 2302 modifies, based on the personalization information for the user, the set of multiple second digital filters.

In some embodiments, modifying, based on the personalization information, the set of multiple first digital filters includes modifying one or more first center frequencies of the multiple first digital filters. Moreover, modifying, based on the personalization information, the set of multiple second digital filters includes modifying one or more second center frequencies of the multiple second digital filters.

In some embodiments, modifying, based on the personalization information, the set of multiple first digital filters includes selecting a different set of multiple first digital filters. Further, modifying, based on the personalization information, the set of multiple second digital filters includes selecting a different set of multiple second digital filters.

The virtual auditory display system 2302 may provide a calibration and/or personalization process that allows a wearer of a virtual auditory display device to calibrate the virtual auditory display device and/or to personalize a virtual auditory display provided by the virtual auditory display device.

The calibration and/or personalization process may include a calibration part and a personalization part. The virtual auditory display device may include an inertial measurement unit (IMU). Calibrating the virtual auditory display device may refer to calibrating the IMU. Personalizing the virtual auditory display may refer to selecting a set of virtual auditory display filters for the wearer and/or modifying an existing set of virtual auditory display filters so that the virtual auditory display provided by the virtual auditory display device is customized to the wearer. The virtual auditory display system 2302 may allow the wearer to perform both the calibration part and the personalization part of the calibration and/or personalization process, just the calibration part, or just the personalization part.

FIGS. 37A through 37C depict an example user interface 3700 for calibrating a virtual auditory display device in some embodiments. The virtual auditory display device may be the virtual auditory display device 2300 which includes the first ear-worn device 2302a and the second ear-worn device 2302b. FIGS. 37A through 37F are described with reference to the virtual auditory display device 2300, but other virtual auditory display devices may be calibrated and/or personalized.

The virtual auditory display system 2302 (for example, the user interface module 2410) may provide the user interface 3700. The wearer may start a calibration and/or personalization process by selecting a button labeled “Start” (not shown in FIGS. 37A through 37C) displayed by the virtual auditory display system 2302. FIG. 37A depicts the user interface 3700 providing a user interface element 3702 indicating the point in the calibration part of the calibration and/or personalization process at which the wearer is, and instructions 3704 for the wearer.

FIG. 37B depicts the user interface 3700 providing a first circle 3706a and a second circle 3706b. The virtual auditory display system 2302 may cause the first circle 3706a and/or the second circle 3706b to move up and down on the user interface 3700 and instruct the wearer to nod their head up and down to follow the first circle 3706a and the second circle 3706b.

FIG. 37C depicts the user interface 3700 providing a circle 3708. The virtual auditory display system 2302 may cause the circle 3708 to move up and down on the user interface 3700 and instruct the wearer to nod their head up and down to follow the circle 3708. Additionally or alternatively, the virtual auditory display system 2302 may cause the circle 3708 to move from side to side on the user interface 3700 and instruct the wearer to move their head from side to side to follow the circle 3708.

While the virtual auditory display system 2302 performs the calibration part of the calibration and/or personalization process, the virtual auditory display system 2302 may receive detections of head orientations of the head of the wearer from the virtual auditory display device 2300 based on data obtained from the IMU-based sensor system and/or other sensors of the first ear-worn device 2302a and/or the second ear-worn device 2302b. The virtual auditory display system 2302 may use the detections of head orientations and other factors, such as a known or estimated distance from a display providing the user interface 3700, a width and height of the display, positions of the first circle 3706a, the second circle 3706b, and/or the circle 3708, and/or other data from the IMU-based sensor system to calibrate the IMU-based sensor system.

FIGS. 37D through 37F depict an example user interface 3750 for personalizing a virtual auditory display provided by a virtual auditory display device in some embodiments. The virtual auditory display system 2302 (for example, the user interface module 2410) may provide the user interface 3750.

The wearer of the virtual auditory display device 2300 may start the personalization part of the calibration and/or personalization process after completing the calibration part. The virtual auditory display system 2302 may cause the virtual auditory display device 2300 to play sounds at several locations (for example, five locations). The sounds may include, for example, sounds produced by objects that appear to the wearer as moving around his or her head, such as airplanes, helicopters, birds, and other flying creatures. FIG. 37D depicts the user interface 3750 providing instructions 3754 instructing the wearer to point their nose at the source of each sound as the virtual auditory display device 2300 plays the sound. The wearer may begin the personalization part of the calibration and/or personalization process by selecting the button 3756 labeled “Continue.”

FIG. 37E depicts the user interface 3750 providing a user interface element 3752 indicating the point in the personalization part of the calibration and/or personalization process at which the wearer is, and the instructions 3754. FIG. 37F depicts the user interface 3750 with the user interface element 3752 indicating that the wearer has located a sound that the virtual auditory display device 2300 played at a first location. The virtual auditory display system 2302 may cause the virtual auditory display device 2300 to play sounds at subsequent locations and update the user interface 3750 accordingly.

While the virtual auditory display system 2302 performs the personalization part of the calibration and/or personalization process, the virtual auditory display system 2302 may receive detections of head orientations of the head of the wearer from the virtual auditory display device 2300 based on data obtained from the IMU-based sensor system and/or other sensors of the first ear-worn device 2302a and/or the second ear-worn device 2302b. The virtual auditory display system 2302 may use the detections of head orientations and the locations of the sounds generated by the virtual auditory display system 2302 to calculate one or more deltas, as described with reference to, for example, FIGS. 35A and 35B. The virtual auditory display system 2302 may use the calculated one or more deltas to select a set of virtual auditory display filters and estimate a spatialization precision of the virtual auditory display for the wearer.

FIGS. 37G through 37J depict an example user interface 3770 for providing information on calibration of a virtual auditory display device and personalization of a virtual auditory display of the virtual auditory display device in some embodiments. The user interface 3770 includes a recommendation 3772 of a set of virtual auditory display filters. In some embodiments, as described herein with reference to, for example, FIGS. 35A and 35B, the virtual auditory display system 2302 may select a set of virtual auditory display filters from among multiple sets of virtual auditory display filters based on the results of the calibration and/or personalization process. The user interface 3770 also includes an estimate 3774 of a spatialization precision of the virtual auditory display for the wearer.

The virtual auditory display system 2302 may categorize the spatialization precision of the virtual auditory display for the wearer based on the estimate 3774, such as “Very Good” (FIG. 37G), “Medium” (FIG. 37H), and “Poor” (FIG. 37I). The virtual auditory display system 2302 may provide recommendations to redo the calibration part and/or the personalization part of the calibration and/or personalization process and/or to use custom filters. The user interface 3770 also includes a button 3776 labeled “Continue” that the wearer may select to return to the user interface 3300 depicted in FIGS. 33A and 33B.

Although the virtual auditory display system 2302 is described as using circles, the virtual auditory display system 2302 may utilize other visual user interface elements in the calibration and/or personalization process. Furthermore, although the virtual auditory display system 2302 is described as receiving detections of head orientations from the virtual auditory display device 2300 in the calibration and/or personalization process, the virtual auditory display system 2302 may receive detections of head orientations from other devices connected to the virtual auditory display system 2302, such as cameras, motion sensing devices, virtual reality headsets, and the like.

One advantage of the calibration and/or personalization process is that the virtual auditory display system 2302 may personalize a set of virtual auditory display filters for a wide range of individuals. The virtual auditory display system 2302 may personalize the set of virtual auditory display filters by modifying the set of virtual auditory display filters. The virtual auditory display system 2302 may have pre-configured multiple sets of virtual auditory display filters and may modify the set of virtual auditory display filters by selecting a different set of virtual auditory display filters based on the results of the calibration and/or personalization process for a user.

Additionally or alternatively, the virtual auditory display system 2302 may modify the set of virtual auditory display filters by modifying the digital filters or functions included in the set of virtual auditory display filters. For example, where the set of virtual auditory display filters includes digital filters, the virtual auditory display system 2302 may modify parameters of the digital filters, such as the center frequencies, gains, q's, algorithm type, or other parameters based on the results of the calibration and/or personalization process for a user.

Personalization of virtual auditory display filters allows a wide range of individuals to experience immersive, accurately rendered sound in a virtual auditory space. Moreover, such individuals would not have to have HRTFs generated for them using potentially difficult and/or unreliable physical measurement procedures. Such individuals could obtain a personalized set of virtual auditory display filters simply by having the virtual auditory display system 2302 perform the calibration and/or personalization process for them. The modification of virtual auditory display filters may be performed at an initial setup procedure for the person and at any subsequent point during the person's use of the virtual auditory display system 2302 and/or virtual auditory display device 2300.

One advantage of virtual auditory display filters is that sounds in far more locations in virtual auditory space may be rendered in comparison to existing technologies. For example, a 9.1.6 configuration has 16 virtual speakers and thus may be limited to accurately rendering sounds for only those 16 virtual speaker locations. Such configurations may render sounds from other locations by smearing sounds from virtual speaker locations to represent the other locations, but such artifacts may be noticeable to listeners.

In contrast, virtual auditory display filters may be able to render sound at far more locations. For example, using locations at one degree increments of azimuth and elevation results in 65,160 locations. However, the described technology may generate virtual auditory display filters at smaller increments, resulting in even more locations at which the virtual auditory display filters may render sound. Moreover, typical approaches render sound at a modeled distance of 1 m from a center point representing the listener. The described technology may generate virtual auditory display filters for any number of distances from the center point. Accordingly, the described technology may accurately render sounds at varying distances.

One advantage of the described technology is that the described technology accurately renders virtual auditory display sound in virtual auditory space, meaning that sound is perceived by a listener as coming from the location that the creator of the sound intended for the sound. Another advantage of the described technology is that the described technology may be utilized with any ear-worn device, such as headphones, headset, and earbuds. Another advantage is that the virtual auditory display sound is high-quality and clear. Another advantage is the described technology may emphasize or de-emphasize sounds in certain regions or locations of virtual auditory space so as to focus a listener's attention on those certain regions or locations. Such an approach may increase the listener's hearing abilities and allow the listener to hear sounds that the listener would not otherwise hear.

Another advantage of the described technology is that any digital device with suitable storage and processing power may store and apply the virtual auditory display filters. As described herein, a general purpose computing device such as a laptop or desktop computer may store and apply the virtual auditory display filters to audio signals to generate processed audio signals. The laptop or desktop computer may then send the processed audio signals to ear-worn devices to generate sound based on the processed audio signals. Similarly, a digital device such as a phone, tablet, or a virtual reality headset may store and apply the virtual auditory display filters to audio signals to generate processed audio signals and send the processed audio signals to ear-worn devices.

Additionally or alternatively, ear-worn devices, such as the virtual auditory display device 2300 described herein, may store and apply the virtual auditory display filters. The ear-worn devices may receive an input audio signal from, for example, a digital device with which the ear-worn devices are paired such as a phone or tablet, or from a cloud-based service. The ear-worn devices may apply the stored virtual auditory display filters to the input audio signal to generate processed audio signals and output virtual auditory display sound based on the processed audio signals. Another example is that a cloud-based service may store and apply the virtual auditory display filters to generate processed audio signals and send the processed audio signals to ear-worn devices. Other advantages will be apparent.

### Auditory User Interfaces

Described herein are auditory user interfaces that provide context-aware auditory experiences and facilitate audio interactions, such as audio interactions with artificial intelligence agents or other applications. An auditory operating system may implement the auditory user interface. The auditory operating system may have a multi-agent architecture in which multiple specialized agents perform tasks within their respective domains. The auditory operating system may include an auditory operating system shell that serves as the primary interface for user interactions with the multiple specialized agents. The auditory operating system shell may control and monitor the multiple specialized agents.

When the user of an auditory user interface speaks a command or query, the auditory operating system shell may receive the user input. The auditory operating system shell may utilize natural language processing (NLP) to identify the domain or agent type required to respond to the user command or query. Each agent may handle one domain (for example, music streaming, scheduling, home automation). The auditory operating system shell may select an agent based on the identified domain or agent type. The auditory operating system shell may provide relevant task details to the selected agent.

Agents may have controlled access to application programming interfaces (APIs) or hardware components of user devices. The auditory operating system shell may enforce boundaries on an agent's access to data and system privileges to maintain user privacy and device stability. The auditory operating system shell may provide global context management. If a user switches domains mid-conversation, the auditory operating system shell may preserve the relevant context. The auditory operating system shell may provide seamless handoffs from one agent to another agent. If a user request evolves from one domain to another (for example, from playing music to checking the artist's tour schedule), the auditory operating system shell may transition between specialized agents without losing continuity.

The auditory operating system shell may provide a unified user experience with a single entry point. Users may not be required to memorize separate wake words or skill names to invoke agents. In some cases, users may simply address the auditory operating system shell. Additionally or alternatively, the auditory operating system shell may determine, based on analysis of the content of the user's speech or from the context, that the user is addressing the auditory operating system shell. The auditory operating system shell may then orchestrate the best-suited agent to respond to the user's command or query. The auditory operating system shell may also standardize response formatting to ensure an integrated and cohesive style of replies, whether from a music agent, a weather agent, or another agent.

Certain user devices may implement spatial audio, which may also be referred to as spatial sound, three-dimensional (3D) audio or 3D sound. For such user devices, the auditory operating system shell may implement a spatial audio framework for agents. The auditory operating system shell may grant each agent a distinct virtual position relative to the user. Through advanced audio rendering, the auditory operating system shell may precisely simulate direction and distance cues for each agent's voice. The placement of each agent may be configurable and may be continuously updated based on factors such as interaction context, user movements, head orientation, environmental factors, and agent identity and role.

For example, if one agent is presenting essential guidance (for example, navigation instructions), the auditory operating system shell may move the agent closer or to a prominent location, while secondary agents remain in the periphery. As another example, as the user turns or changes position, the agents' virtual locations update accordingly, thereby reinforcing the sensation of their presence in a shared space. As another example, different voices or functionalities can be consistently associated with specific directions or distances to enhance recognition and reduce cognitive load.

The auditory operating system shell may integrate real-time user tracking, head position/orientation sensors, and audio rendering algorithms to dynamically adapt the agents' positions so that they appear to emanate from realistic, stable points in the auditory scene. This may not only improve realism but may also foster a sense of distinct entity presence, enabling users to localize and differentiate multiple agent voices in a seamless manner.

For devices that implement spatial audio, the auditory operating system shell may fuse real-world audio with digital content. The auditory operating system shell may utilize spatial audio rendering, environmental noise adaptation, and selective sound filtration to enable users to maintain or enhance their environmental awareness while also listening to digital audio. The auditory operating system shell may implement dynamic spatial audio rendering by positioning in virtual auditory space sounds in the user's perceived soundfield to avoid confusing overlap with real-world audio. The auditory operating system shell may also implement environmental noise adaptation through adaptive volume control and real-time equalization. The auditory operating system shell may continuously monitor the ambient sound profile and adjust digital audio parameters to harmonize or contrast with real-world acoustics.

The auditory operating system shell may implement selective sound filtration by a hear-through mode, in which the auditory operating system shell selectively filters or attenuates specific frequencies of external noises. The auditory operating system shell may let safety-critical sounds (for example, sirens, alarms) remain audible while reducing less relevant background chatter. The auditory operating system shell may allow users to define which real-world sounds are essential (for example, traffic signals, coworker's voice) and let the auditory operating system shell maintain those audio cues in the mix.

The auditory operating system shell may implement personalized control and interfaces through user preferences and gesture or voice commands. The auditory operating system shell may provide customizable settings that let individuals modify the degree of environmental blending or digital audio emphasis. The auditory operating system shell may also allow for quick on-the-fly adjustments through gestures or voice commands to allow users to switch modes (for example, silent, ambient emphasis, or fully immersive) without removing devices. By integrating and enhancing the natural soundscape, users can stay aware of their surroundings while enjoying digital audio experiences.

An agent may refer to a computational system, software module, or device—whether standalone or embedded—that is capable of autonomous perception, decision-making, learning, or interaction with digital or physical environments, including interaction with human users via text, speech, gesture, or other input modalities. An agent may utilize artificial intelligence techniques, such as machine learning, rule-based reasoning, or statistical inference, to generate outputs in response to inputs, prompts, or environmental stimuli. As used herein, an agent may also be referred to as an artificial intelligence agent, a synthetic intelligence agent, a digital assistant, a voice assistant, an artificial agent, or as an assistant.

The following description provides more details regarding auditory user interfaces, the auditory operating system, and the auditory operating system shell.

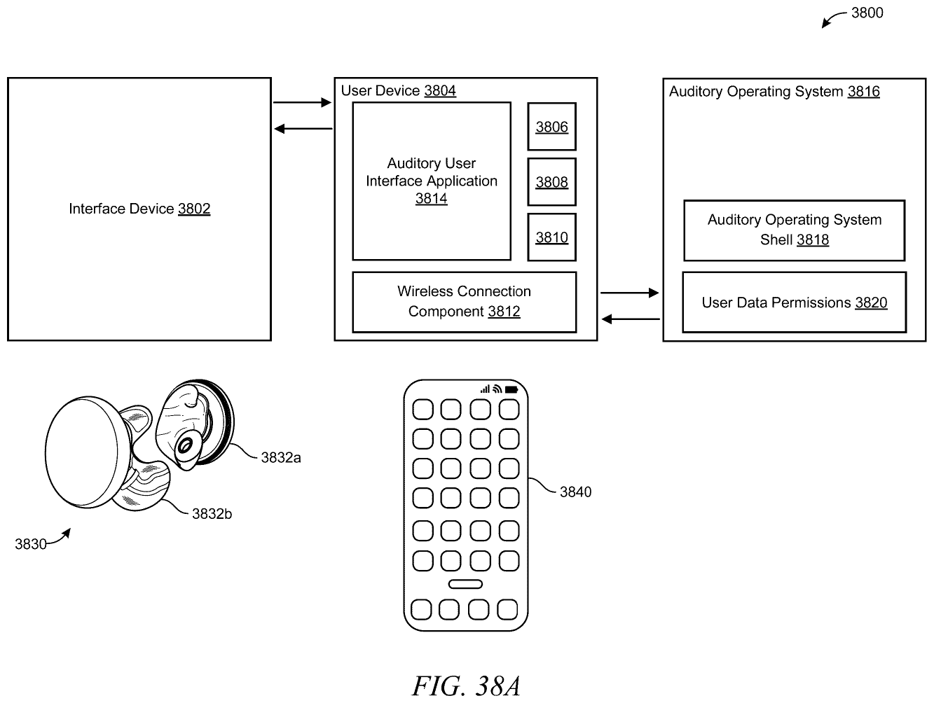

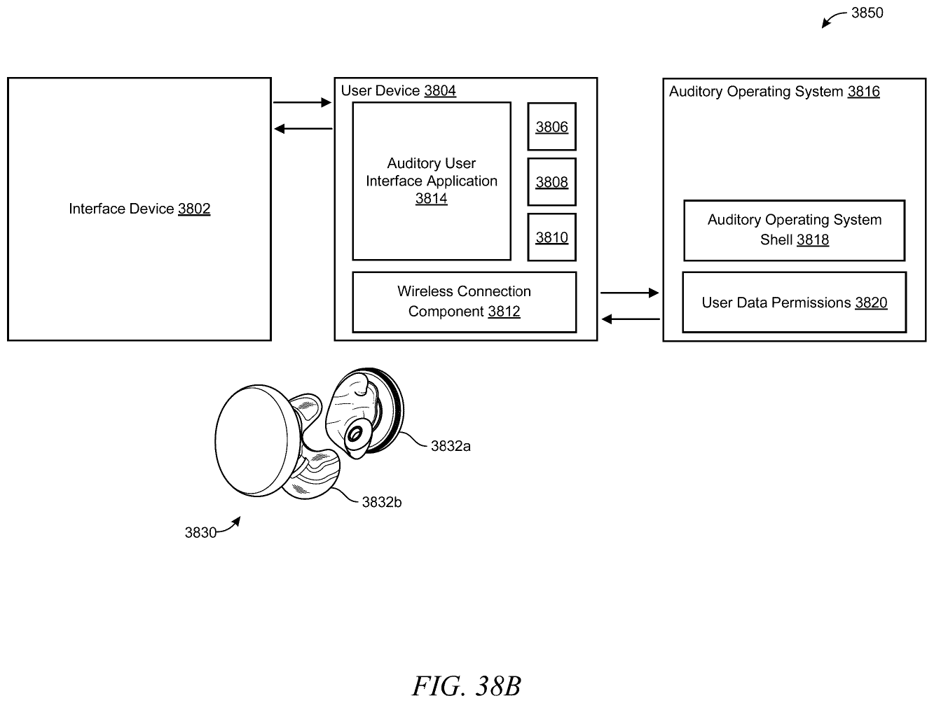

FIG. 38A depicts an example configuration 3800 for implementing an auditory user interface in some embodiments. The configuration 3800 includes an interface device 3802, a user device 3804, and an auditory operating system 3816. Each of the interface device 3802, the user device 3804, and the auditory operating system 3816 may be or include any number of digital devices. A digital device is any device with at least one processor and memory. Digital devices are discussed further herein, for example, with reference to FIG. 45.

The interface device 3802 may include one or more one or microphones or other devices configured to capture sounds or vibrations, such as speech of a user or environmental noise, and one or more sound output devices configured to output sounds or vibrations. The interface device 3802 may also include other components or modules configured to provide or enable other functionality, such as wireless connection components that allow the interface device 3802 to wirelessly connect to other systems or devices, such as the user device 3804 (for example, using a Bluetooth Low Energy (BLE) connection).

The user device 3804 may include memory 3806, such as flash memory, one or more GPS components 3808, one or more processors 3810 (for example, one or more digital signal processors (DSPs)), one or more wireless connection components 3812 that enable the user device 3804 to connect wirelessly to other devices or systems, an auditory user interface application 3814 that may enable interaction with the user device 3804, the interface device 3802, or the auditory operating system 3816, and other components or modules configured to provide or enable other functionality.

The auditory operating system 3816 may include an auditory operating system shell 3818, user data permissions 3820, and other components or modules configured to provide or enable other functionality, such as connection components that allow the interface device 3802 to connect to other systems or devices, such as the user device 3804. The auditory operating system shell 3818 may be considered as a device-level or system-level audio user interface through which a user interacts with the auditory operating system 3816. During usage of the interface device 3802 or the user device 3804, the auditory operating system shell 3818 may always be listening (unless deactivated by the user) for conversation cues to trigger actions, such as to bring up a particular application or agent or to access system settings.

As described in more detail herein, the auditory operating system shell 3818 may coordinate, control, monitor, or interact with one or more machine learning or artificial intelligence systems. A machine learning or artificial intelligence system may be or include one or more machine learning or artificial intelligence models, such as speech-to-text models such as acoustic models or language models, large language models, or other models that receive an input and provide an output based on the input or that are applied to data to process the data and provide a result. A machine learning or artificial intelligence system may also be or include one or more artificial intelligence agents that utilize machine learning or artificial intelligence models or reasoning techniques to provide output, such as output in response to an input or a prompt. An artificial intelligence agent may be referred to herein as a digital assistant, a voice assistant, as an artificial agent, or as an agent or an assistant. The auditory operating system shell 3818 may also coordinate, control, monitor, or interact with non-machine learning or artificial intelligence systems, such as music services.

The auditory operating system 3816 may be or include one or more devices or servers, such as one or more servers operated on-premises of an entity operating the auditory operating system 3816 or off-premises at a facility operated by another entity, or in other configurations, such as a mixture of on-premises and off-premises. Although the configuration 3800 depicts a single one of the auditory operating system 3816, it is to be understood that there may be multiple auditory operating systems 3816.

The interface device 3802 may interface with a user or wearer of the interface device 3802 and provide privacy, security, and portability. The interface device 3802 may detect voice input from the user or wearer, provide natural language output, and may provide or facilitate additional functionality. The user device 3804 may connect to the Internet or other networks, store data, and provide secondary processing functionality. In addition, the user device 3804 may provide location information, an additional user interface, such as a screen, and may provide or facilitate additional functionality. The auditory operating system 3816 may provide primary processing functionality, may utilize or interact with machine learning or artificial intelligence systems, such as artificial intelligence agents, and may utilize or interact with application programming interfaces (APIs), utilize or interact with tools, data or services, and may provide or facilitate additional functionality.

As described in more detail herein, the interface device 3802, the user device 3804, and the auditory operating system 3816 may cooperate to provide an auditory user interface for a user or wearer of the interface device 3802. The auditory user interface may provide for or facilitate functionality including device control by user voice input, augmented contextual audio such as hearing applications, services utilizing conversational agents such as conversation applications, audio applications such as music or podcast applications, and other location-based or augmented reality experiences.

FIG. 38A also depicts an audio computing device 3830 that may be or function as the interface device 3802 in some embodiments. The audio computing device 3830 includes a first ear-worn device 3832a and a second ear-worn device 3832b. The first ear-worn device 3832a is for a left ear of a wearer and the second ear-worn device 3832b is for a right ear of the wearer. Each of the first ear-worn device 3832a and the second ear-worn device 3832b has a three-part configuration: an electronics package that includes electronics components, such as an array of microphones, an acoustic package that includes analog components such as one or more sound output devices, and an ear interface configured to be inserted into an ear of the wearer. U.S. Patent Application Publication No. 2024/0334112, titled “VIRTUAL AUDITORY DISPLAY DEVICES AND ASSOCIATED SYSTEMS, METHODS, AND DEVICES” and filed Mar. 29, 2024, describes the audio computing device 3830 in more detail, and is incorporated in its entirety herein by reference.

The array of microphones in the electronics package may capture ambient sound from substantially all directions (for example, providing substantially 360° or spherical coverage) which enables context-sensitive input (for example, detecting a location of the wearer, environmental cues, or interactions with other speakers). The audio computing device 3830 may utilize algorithms to localize and interpret sound sources to facilitate responses to input and real-time adjustments. The array of microphones may also capture speech of the wearer. The audio computing device 3830 may perform beamforming with the array of microphones to isolate the speech from environmental noise.

The audio computing device 3830 also may include other components, such as one or more in-canal microphones in the acoustic package that may capture speech of the wearer in the ear canal. Other components may include electronics package components such as one or more global positioning system (GPS) components that may be utilized to determine a location of the audio computing device 3830, one or more inertial measurement unit (IMU)-based sensor systems (which may be referred to as an IMU) that may be utilized to determine user orientation, velocity, or acceleration, one or more magnetometers, one or more microcontrollers, one or more digital signal processors (DSPs), one or more memories, and one or more other sensors that may be utilized to determine if the audio computing device 3830 is being worn by the wearer.

The electronics package may be rotatable relative to the acoustic package. The audio computing device 3830 may thus provide a rotatable user interface for the wearer. The wearer may rotate the electronics package to cause the audio computing device 3830 to perform certain functions, such as to adjust a sound volume. In addition, the audio computing device 3830 may allow the wearer to interact with the audio computing device 3830 in other ways. For example, the audio computing device 3830 may allow the following interactions: a single tap on the electronics package may shut down any manipulations to the user's auditory stream to allow full passthrough of environmental noise (which may be referred to as presence); a double tap on the electronics package may enable or re-enable audio output manipulations (which may be referred to as immersion); and a tap and hold on the electronics package may activate or deactivate audio input through the one or more in-canal microphones and the array of microphones. Some embodiments of the audio computing device 3830 may include physical buttons or capacitive sensors and thus permit additional interactions.

The audio computing device 3830 may implement a virtual auditory display (VAD) that provides a virtual three-dimensional (3D) sound environment in which a person may perceive a sound as emanating from any location in the virtual 3D sound environment. The virtual 3D sound environment may be referred to as virtual auditory space. The VAD may allow the audio computing device 3830 to generate the perception that voices, such as agent voices, alerts, such as notifications, or other audio elements are coming from specific directions in the wearer's environment. Additionally or alternatively, the audio computing device 3830 may change the volume, timbre, or position of audio cues to match user context, personal preferences, or environmental changes, such as background noise. For example, the audio computing device 3830 may lower certain background sounds, convert certain unpleasant sounds into pleasant auditory experiences, and augment the audio scene with virtual sound objects. The audio computing device 3830 may allow the wearer to experience a seamless, screen-free interface, supporting hands-free, eyes-free operation in a wide array of scenarios.

Certain aspects of the technology described herein may be described as implemented by or in the audio computing device 3830. The input components (for example the spatial array of microphones, the one or more in-canal microphones, and the GPS), the output components (for example, the VAD), and the software of the audio computing device 3830 may enable or provide certain functionality or user experiences that other devices may not be capable of providing. For example, the audio computing device 3830 may superimpose sound objects in an auditory scene of a wearer to provide immersive sound experiences for the user. As another example, the audio computing device 3830 may, due to the acoustically sealed fit provided by the ear interface, allow for full or near-full ear occlusion, thereby assisting in reducing or eliminating environmental noises. The audio computing device 3830 may, for example, allow for full or partial contextual audio pass-through, such as in response to user input, so as to allow the user to hear their surroundings. Certain aspects of the technology described herein may be implemented by or in other types of devices, such as earbuds, headsets, and mobile phones. FIG. 38A also depicts a mobile phone 3840 as an example of the user device 3804 in some embodiments.

FIG. 38B depicts another example configuration 3850 for implementing an auditory user interface according to some embodiments. The example configuration 3850 may be generally similar to the example configuration 3800 of FIG. 38A. One difference is that in the example configuration 3850, the audio computing device 3830 may be or function as both the interface device 3802 and the user device 3804 in some embodiments.

Other examples of devices that may function as the interface device 3802, the user device 3804, or both the interface device 3802 and the user device 3804 include wearable devices such as headsets, headphones, earbuds, augmented reality or virtual reality headsets or augmented reality or mixed reality glasses, watches, pins, rings, clips, or necklaces, home devices such as appliances, home audio, or home automation devices, vehicle infotainment systems, mobile devices such as tablets or laptops, non-mobile devices such as desktop computers. Accordingly, the technology is not necessarily limited to being embodied in the audio computing device 3830 or in the mobile phone 3840.

### Auditory Operating System and Auditory Operating System Shell

As previously noted, the auditory operating system shell 3818 may be considered as a device-level or system-level audio user interface through which a user interacts with the auditory operating system 3816. The auditory operating system 3816 and the auditory operating system shell 3818 may be implemented in a wide range of computing devices, including wearable devices such as the interface device 3802, user computing devices such as the user device 3804, and other devices or systems, including smart speakers, Internet of Things (IoT) devices, automotive or other vehicle systems, laptops or desktops, AR or VR headsets. During usage of the interface device 3802 or the user device 3804, the auditory operating system shell 3818 may always be listening (unless deactivated by the user) for conversation cues to trigger actions, such as to bring up a particular application or agent or to access system settings. The auditory operating system shell 3818 may have system privileges, up to and including full root access where available and necessary, to perform various functions, such as adding or removing applications or agents, setting or modifying application or agent permissions in the user data permissions 3820, controlling access of applications or agents to user data, and generating, modifying, or otherwise controlling audio streams that are sent to the user device 3804 or the interface device 3802 for the user. In some embodiments, the auditory operating system shell 3818 responds to a keyword, (for example, “Shell”), but in other cases the auditory operating system shell 3818 may respond based on the content of the input provided by the user.

The auditory operating system 3816 and the auditory operating system shell 3818 follow a multi-agent model and allow users to interact with multiple agents. In some embodiments, each agent has a specific domain (for example, music, messaging, scheduling) and handles tasks within that domain. Each agent can be wrapped in its own conversational interface and intentionally invoked by the user (for example “Shell, load the music app.”). Allowing multiple agents evokes a familiar paradigm for users, who are used to conversational interactions with individual persons. Another advantage of a multi-agent system is that third party developers may develop agents for use with the auditory operating system 3816 and the auditory operating system shell 3818.

For devices that support spatial audio, such as the audio computing device 3830, the auditory operating system shell 3818 can precisely position where a sound object, notification, application or agent is relative to the center of the user's head. As human perception tends to exist on the horizon line, the auditory operating system shell 3818 may utilize spatial audio positions perceived as “inside a user's head” or directly above or below those positions for privileged information (for example, the auditory operating system shell 3818 or critical alerts). The auditory operating system shell 3818 may use distance as an analog to priority. For example, the auditory operating system shell 3818 may place higher priority audio streams closer to the user's head than lower priority audio streams. The auditory operating system shell 3818 may use other ways to indicate priority, such as by using narrower or broader spatial locations, different modes of audio (for example, earcons or agent conversation), or may process audio streams to indicate priority, such as by EQ filtering the audio stream.

The auditory operating system shell 3818 may offload tasks. Rather than have the user directly control every step of every process, the auditory operating system shell 3818 may require agents to gather as much information as needed to faithfully execute a task (remembering as much as possible to limit intent clarification in the future), and execute the task on behalf of the user. In addition, the auditory operating system shell 3818 may implement foregrounding and backgrounding of tasks. The auditory operating system shell 3818 may arrange agents in virtual auditory space to provide for user focus. For example, an agent executing a task that may take less than one second may stay in the foreground. However, for an agent performing a task that may take 30 seconds, the auditory operating system shell 3818 may cause the agent to recede into the background, thereby making space for active agents. The background agent may surface with a notification when it is ready again for user attention.

Conversational agents can be either present (in an active conversation), on deck (in the periphery of focus or passively listening in waiting for a cue to act), occupied elsewhere (running an operation), waiting on a response from an external operation, ready with a response for the user, or in another state. In some embodiments, the auditory operating system 3816 has agent-level states that pass state status to the auditory operating system shell 3818 to orchestrate for the user. As agent or application operations may require a time delay, the auditory operating system shell 3818 may utilize earcons (for example, legible audio notifications) for these states so that the states are clear to the user.

Different types of agents may have different levels of access to user personal information and have different roles (for example conversation only, conversation and generic tools like search, agent, cluster of services wrapped in a single agent, etc.). The auditory operating system shell 3818 may utilize the audio equivalent of a chip or tag so that it is clear to the user what type of agent the user is speaking to.

The auditory operating system shell 3818 may implement arrangements of agents. An arrangement may be a collection of agents arranged in a single shared conversational space that a user can configure, save, and call up as needed.

In some embodiments, the auditory operating system shell 3818 does not use wakewords. Instead, the auditory operating system shell 3818 may infer invocation intent using natural language processing techniques. Such actions by the auditory operating system shell 3818 may be referred to herein as natural language invocation or user intent inference. This has the advantage of allowing conversation to flow seamlessly between device interactions and interactions with other persons.

The auditory operating system shell 3818 may utilize contextual information. Contextual information may be ephemeral (for example, time of day, weather, location, etc.) or persistent (for example, username, biography, birthdate, close points of contact or social graph, user preference information, etc.). Persistent contextual information may accrete over time and be corrected or self-correct over time.

In some embodiments, the auditory operating system shell 3818 allows users to provide context actively, so as to make the auditory operating system shell 3818 behave as the user expects. For example, to add a label (and an expected behavior) to a place by saying “Shell, this is my apartment/bedroom—always turn off mic input when I'm in here” or “Shell, this is my desk at work—keep a record in a protected folder of my conversations so I can search back over them for relevant info when I'm here.” The auditory operating system shell 3818 may allow users to inspect the context the auditory operating system shell 3818 has for them and correct the record if there are errors present (which may be referred to as inspectability.) The auditory operating system shell 3818 may implement permissions to protect user privacy.

### Auditory Operating System Application or Agent Model

The auditory operating system 3816 may define a set of hardware features and user information that an application or an agent has access to. The auditory operating system shell 3818 may have privileged root-level permissions across the interface device 3802. The auditory operating system 3816 or the auditory operating system shell 3818 may scope permissions per application to allow users to maintain control over their information. In some embodiments, the auditory operating system shell 3818 allows users to share contextual information either once, for a limited period of time, or until revoked with applications or agents.

The arrangement and status of applications or agents in the auditory user interface may depend upon user preferences, context, and level of concurrent activity. Accordingly, the auditory user interface may be highly parametric, meaning that a set of rules may govern the properties of the auditory user interface as experienced by the user. The auditory operating system shell 3818 may serve as the orchestrator of events on behalf of the user by fielding states and requests from applications or agents.

The auditory operating system shell 3818 may manage requests from applications or agents for locations in a user's virtual auditory display, in line with user preferences. A user could set the interface device 3802 to maximum information density, in which case many applications or agents of many different kinds and sizes would occupy space in their auditory perception in parallel. Or a user could set the interface device 3802 to maximum focus or attention on fewer items at a time, in which case the auditory operating system shell 3818 would constrain access to the user's attention with foregrounding and backgrounding, and for example attenuate individual conversational application or agent settings to be terser. The auditory operating system shell 3818 may also manage requests from applications or agents for notifications. For example, applications or agents may set state, which may trigger state notification requests managed by the auditory operating system shell 3818. This allows for consistency of user experience and legibility of application or agent-level states and actions.

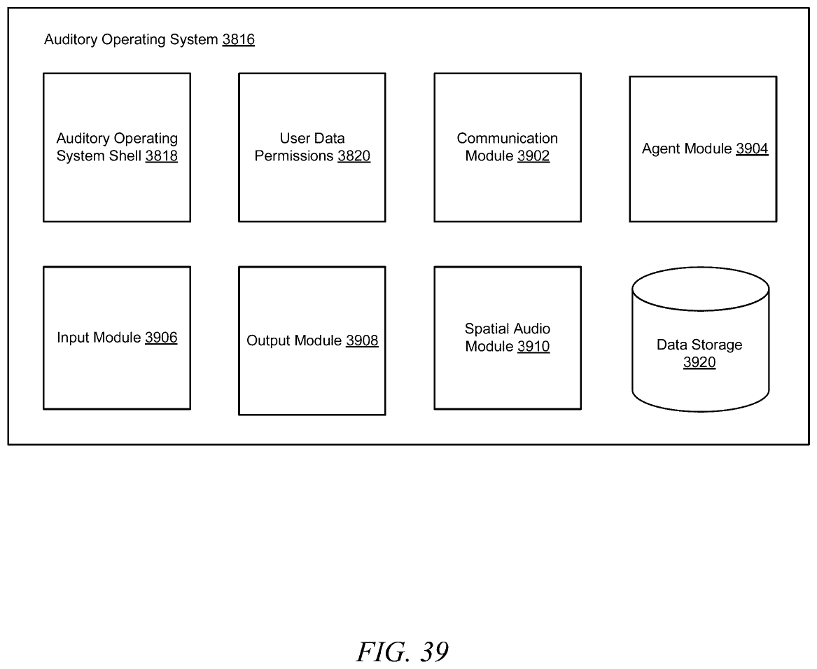

FIG. 39 is a block diagram depicting the auditory operating system 3816 according to some embodiments. The auditory operating system 3816 includes the auditory operating system shell 3818, the user data permissions 3820, a communication module 3902, an agent module 3904, an input module 3906, an output module 3908, a spatial audio module 3910, and a data storage 3920. Although modules may be illustrated as part of the auditory operating system 3816, the modules may be part of the auditory operating system shell 3818 or otherwise accessible to or used by the auditory operating system shell 3818 to perform various functions.

The communication module 3902 may send or receive requests or data between the auditory operating system 3816 and any other system or device. For example, the communication module 3902 may receive requests or data from the user device 3804 or from agents. The communication module 3902 may also send requests or data to the user device 3804 or to agents.

The agent module 3904 may, for example, provide instructions to agents, receive responses from agents, monitor tasks being performed by agents, such as foreground tasks and background tasks, and control whether or not agents receive audio streams or user data.

The input module 3906 may receive input, such as input obtained from speech of a user, and analyze the input to identify the content, such as to identify whether the input contains commands or queries.

The output module 3908 may generate output to be provided to users or coordinate output from agents that is to be provided to users. The spatial audio module 3910 may determine spatial audio locations for audio streams. For example, the spatial audio module 3910 may determine spatial audio locations based on the source of the audio stream (for example, the domain of the agent that generated the audio stream), based on user-defined rules, or based on environmental noises.

The data storage 3920 may include data stored, accessed, or modified by any of the modules of the auditory operating system 3816, such as the auditory operating system shell 3818. The data storage 3920 may include any number of data storage structures such as tables, databases, lists, or the like.

A module of the auditory operating system 3816 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, or any combination. Software may be executed by one or more processors. Although a limited number of modules are depicted in FIG. 39, there may be any number of modules. Furthermore, individual modules may perform any number of functions, including functions of multiple modules as shown herein.

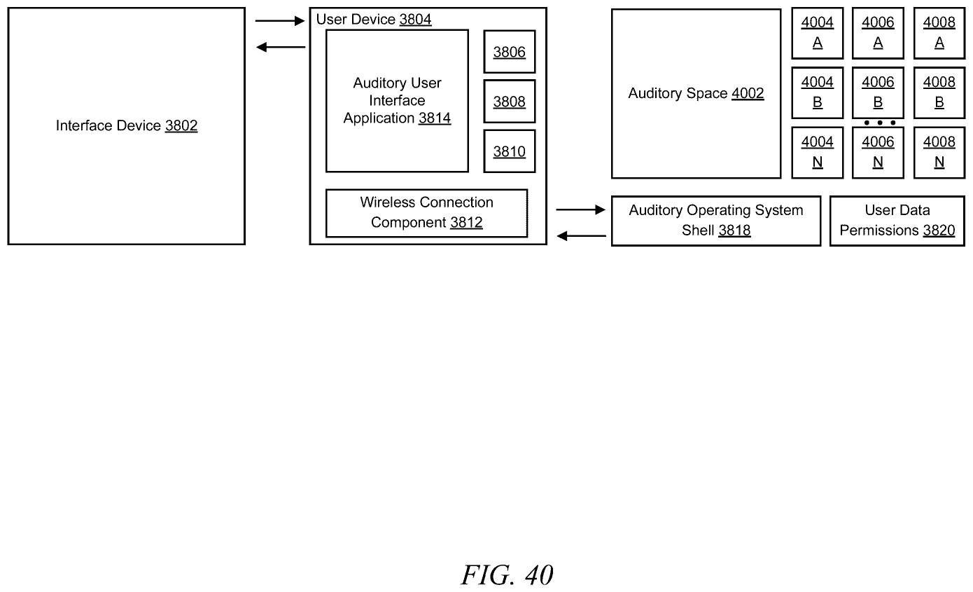

FIG. 40 depicts functionality of the auditory operating system 3816 and the auditory operating system shell 3818 in some embodiments. The auditory operating system 3816 may generate an auditory space 4002 where a user of the interface device 3802 may interact with one or more agents 4004 (shown individually as agent 4004A and agent 4004B through agent 4004N). The interface device 3802 may receive input, such as speech input, from the user, and provide the input to the user device 3804 to be provided to the auditory operating system 3816. The auditory operating system shell 3818 may receive the input, analyze the input, and perform various actions based on the analysis, such as sharing the input or portions of the input with the agents 4004. The auditory operating system shell 3818 controls which agents 4004 may join the auditory space 4002. The auditory operating system shell 3818 may perform various actions with respect to agents 4004 that have joined the auditory space 4002, such as muting or unmuting agents 4004, deafening or undeafening agents 4004, and positioning agents in 3D space for interface devices 3802 that implement spatial audio. The auditory operating system shell 3818 may take the focus of the auditory space 4002, meaning that audio streams from the auditory operating system shell 3818 may be prioritized over audio streams from agents 4004. The auditory operating system shell 3818 may also perform other tasks for the auditory space 4002, such as controlling the auditory complexity of the auditory space 4002.

The agents 4004 may utilize tools and APIs 4006 (shown individually as tools and APIs 4006A and tools and APIs 4006B through tools and APIs 4006N). The agents 4004 may also store application data 4008 (shown individually as application data 4008A and application data 4008B through application data 4008N), such as for use by the agents 4004. As described in more detail herein, the auditory operating system shell 3818 may allow agents to selectively access the user data permissions 3820 to perform tasks or respond to user commands or queries. Also as described in more detail herein, multiple users and their associated agents 4004 may join the auditory space 4002.

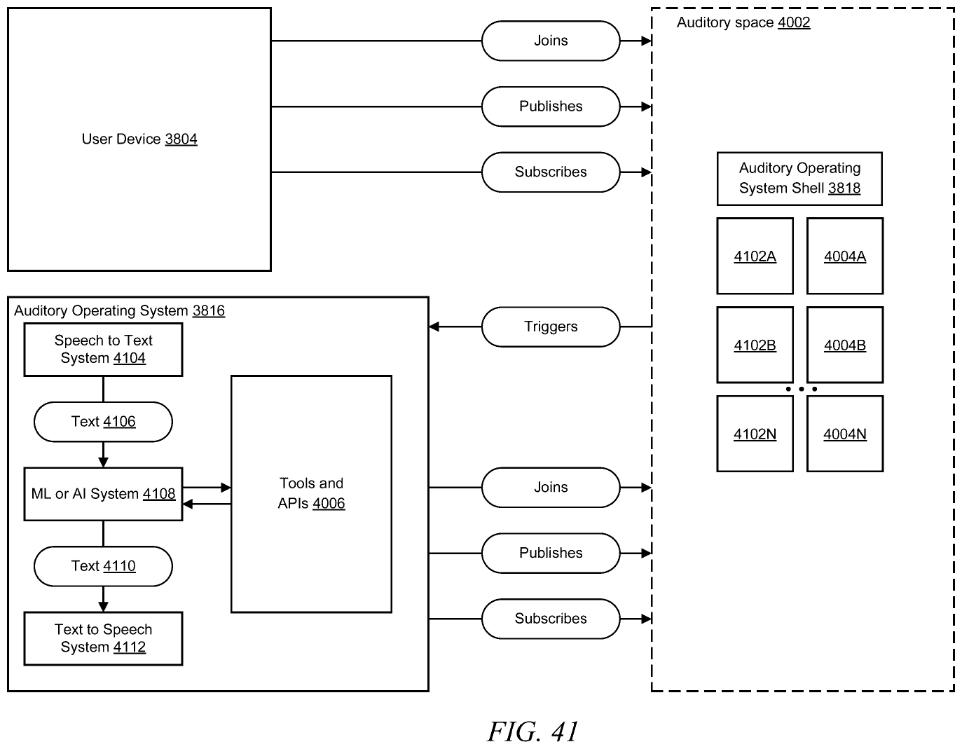

FIG. 41 depicts interactions between the user device 3804, the auditory space 4002, and the auditory operating system 3816 according to some embodiments. The auditory space 4002 may include the auditory operating system shell 3818, users 4102 (shown individually as user 4102A and user 4102B through user 4102N), and agents 4004 (shown individually as agent 4004A and agent 4004B through agent 4004N). Both the user device 3804 and the auditory operating system 3816 may join the auditory space 4002 and may publish audio streams to the auditory space 4002 or subscribe to audio streams in the auditory space 4002. The auditory operating system 3816 or the auditory operating system shell 3818 may determine which entities (users, agents, etc.) may receive audio streams and send audio streams. Events or actions that occur in the auditory space 4002 may trigger events or actions by the auditory operating system 3816.

The auditory operating system 3816 may include or interface with a speech to text system 4104, a machine learning (ML) or artificial intelligence (AI) system 4108, such as a large language model, and a text to speech system 4112. The auditory operating system 3816 may receive speech or other vocal input, and utilize the speech to text system 4104 to convert the speech into text 4106. The auditory operating system 3816 may provide the text 4106 to the ML or AI system 4108 along with any prompts or other input. The ML or AI system 4108 may provide text 4110 to the auditory operating system 3816. The auditory operating system 3816 may utilize the text to speech system 4112 to convert the text into speech. The auditory operating system 3816 may then provide the speech audio stream to various entities, such as the user via the user device 3804 or the interface device 3802 or the auditory operating system shell 3818.

### Audio Mixed Reality

Described herein are audio mixed reality devices and systems that may enhance, diminish, or modify real-world sounds, such as by overlaying audio streams onto real-world sounds or by combining audio streams with real-world sounds. In doing so, the audio mixed reality devices and systems may enable presence in the real world, immersion in audio streams, or focus on real-world sounds. The audio mixed reality devices and systems described herein may render immersive spatial audio scenes that can be layered over, selectively mixed with, or used to modify real-world acoustic inputs.

An audio mixed reality device according to some embodiments may capture and reproduce real-world sounds such that they appear spatially situated in the user's environment. The resulting auditory experience may ensure that physical sounds maintain their natural origin points. This may have the effect on the user of feeling as if the audio mixed reality device effectively disappears perceptually. This provides a clean and believable acoustic foundation upon which sounds from audio streams can be overlaid or modulated without disorienting the user.

By dynamically reconstructing a spatial representation of the external environment, the audio mixed reality device may facilitate the contextual and spatial interaction of audio streams with real-world sounds. The audio mixed reality device may modify characteristics of audio streams (for example, locations, reverberances, or other qualities) so as to render them near or virtually indistinguishable from environmental sounds. This may have the effect on the user of collapsing audio steams into physical perception as an extension of the user's real-time experience of the world. This hybridization may unlock unique affordances or experiences. For example, a user may be able to hear an artificial intelligence agent walking “through” their physical space, experience real-world speech with spatial augmentation, or have environmental sounds selectively replaced or redirected in a perceptually coherent manner.

As described in more detail herein, the audio mixed reality device may provide or implement various features or functions. One feature may be referred to as spatial pass-through, which may refer to the audio mixed reality device capturing and reproducing environmental noises. The audio mixed reality device may use the array of external microphones to perform beamforming to locate sources of the environmental noises. The audio mixed reality device may utilize the locations of the sources to determine spatial audio locations for the environmental noises to be reproduced, and reproduce the environmental noises at the determined spatial audio locations. The audio mixed reality device may perform this with zero or near-zero latency. That, and the combination of the accurate spatial locations, may result, in some cases, in the user of the audio mixed reality device feeling as if the audio mixed reality device is effectively not present.

Another feature relates to augmentation of the reproduced environment with audio streams. The audio mixed reality device may receive signals for audio streams, such as music streams, artificial intelligence agent communications, notifications such as earcons, or other sounds. The audio mixed reality device may determine or modify spatial locations for the audio streams. The audio mixed reality device may then output sounds at the spatial locations for the audio streams, thereby superimposing or layering the audio streams on the reproduced environment.

Yet another feature pertains to modifying environmental noises. The audio mixed reality device may identify and characterize acoustic features of environmental noises (for example, pitch, timbre, reverberation, location, or periodicity). The audio mixed reality device may remove, attenuate, enhance, or replace certain elements in environmental noises in real time (or provide facilities for the user to do so). This allows for control over how the user perceives real-world sounds. For example, the audio mixed reality device may permit the user to eliminate certain background noises, to modify a tone of a speaker, or to superimpose synthetic qualities onto environmental noises. As an example of eliminating certain background noises, the audio mixed reality device may generate noise cancellation signals to reduce or eliminate the sound of traffic or busy streetscapes. In some cases, the audio mixed reality device constrains modifications so as to ensure a coherent sound environment for the user.

Another feature relates to using context data as inputs to generating and modifying the sound environment. The audio mixed reality device may receive context data, such as detected user activities, device data, ephemeral or persistent user data, and location data, and utilize such context data to modify environmental noises or audio streams. For example, the audio mixed reality device may utilize an IMU sensor system to infer the user's activity, such as walking, running, or being stationary, and utilize the user's activity to modify environmental noises or audio streams. As another example, the audio mixed reality device may obtain user physiological signals such as heart rate or respiration (which the audio mixed reality device may obtain from another device such as a watch or a heart rate monitor) and use the user physiological signals to modify environmental noises or audio streams. Other context data that the audio mixed reality device may utilize may include device data (for example, battery level or connectivity status) and location data.

The audio mixed reality device may also provide for seamless interactions with artificial intelligence agents (which may be referred to as agents) or applications. Agents can communicate with users through spatialized voice overlays, ambient earcons, or reactive environmental cues. The audio mixed reality device suitably overlays such communications in the auditory scene for the user. In doing so, the audio mixed reality device preserves privacy, supports subtle background interactions in public or social spaces, and enables hands-free, screenless operation.

The audio mixed reality device also supports a targeted mode of auditory enhancement designed to improve the intelligibility or salience of specific environmental sound sources. This feature enables narrow-band or source-specific amplification or filtering, for example, enhancing human speech while attenuating background noise, or boosting high-frequency sounds, which may be desirable for certain users, such as users with age-related hearing loss. The audio mixed reality device may use context data in determining what environmental noises to enhance. For example, the audio mixed reality device may detect that the user is engaged in a group conversation in a noisy environment. The audio mixed reality device may intelligently prioritize and spatialize voices of persons in the group while suppressing the hum of an HVAC system or other environmental noise. This approach provides practical benefits for accessibility, communication, and safety, particularly in shared spaces or dynamic real-world scenarios.

In some embodiments, the audio mixed reality device may use machine learning or artificial intelligence techniques to identify environmental noises. For example, features may be extracted from environmental noises captured by the audio mixed reality device. One or more machine learning models may be applied to the extracted features to obtain predictions of what the environmental noises are, as well as optional confidence scores. The audio mixed reality device may then use such predictions (which may also be referred to as identifications in the case where confidence scores exceed thresholds) to respond to user commands as to what actions to take with respect to the environmental noises. For example, in the case of a loud HVAC system, the HVAC system may be identified as the source of the environmental noise. The user may command the audio mixed reality device to “turn off the air conditioner” or “cancel the air conditioner.” The audio mixed reality device may receive the user's speech and utilize speech recognition or natural language processing techniques may be used to recognize the command in the speech. The audio mixed reality device may then generate one or more noise cancellation signals to cancel or reduce the HVAC noise.

The audio mixed reality device may also provide other features, such as real-time translation of a speaker and fixing of corresponding spatial audio to the speaker's location, playing spatial audio streams, and other features.

The audio mixed reality device may provide several approaches for spatializing audio with respect to the user. One approach may be referred to as scene-anchored, in which spatial audio locations of sounds are generally fixed in the sound environment and remain generally stable even as the user moves. For example, if a user hears a sound at a spatial audio location directly in front of the user at a distance of one (1) meter, if the user backs away one meter and rotates 180°, the user will hear the sound behind him or her and at a distance of two (2) meters behind him or her.

Another approach may be referred to as location-anchored, in which spatial audio locations of sounds are generally fixed relative to the user in the sound environment as the user moves, but not rotates. For example, if the user hears a sound at a spatial audio location directly in front of the user at a distance of one (1) meter, if the user backs away one (1) meter and rotates 180°, the user will hear the sound behind him or her and at a distance of one (1) meter behind him or her.

A third approach may be referred to as user-anchored, in which spatial audio locations of sounds are generally fixed relative to the user in the sound environment as the user moves and rotates. For example, if the user hears a sound at a spatial audio location directly in front of the user at a distance of one (1) meter, if the user backs away one (1) meter and rotates 180°, the user will hear the sound in front of him or her and at a distance of one (1) meter in front of him or her. Another approach may be referred to as disconnected, in which sounds may be free floating and untethered to the user or the sound environment. The audio mixed reality device may use such an approach to provide surreal or abstract auditory effects. The audio mixed reality device may use a combination of these approaches, such as one approach for one sound source and another approach for another sound source. Additionally or alternatively, the audio mixed reality device may change the approach for a sound source depending on user preference or context.

Some example use cases of the audio mixed reality device are as follows. One use case is to integrate an agent into the user's environmental auditory scene in a seamless manner, so as to avoid interference with other agents or with other speakers or important environmental noises. Another relates to navigation. For example, vocal navigation instructions could be supplemented by spatial placement (for example “turn left at the next street” being located at the corner of that street relative to the user) and/or non-verbal auditory cues (for example gentle pinging from a location where the user is meant to turn increasing in intensity as the user approaches, or to guide the user along a path).

Another use case relates to geofenced points of interest or audio tours. A user may be walking through a city or neighborhood. The audio mixed reality device may provide audio cues or notifications to indicate to the user points of interest or items the user may be interested in. For example, the audio mixed reality device may highlight to the user points of interest that are aligned with the user's purchase history or the user's topics of interest as indicated by consumption of certain podcasts in a podcast application.

Another use of the audio mixed reality device may involve the user searching for an item, such as a location or an establishment, in the user's vicinity (either by using another device such as a mobile phone or by a voice input to the audio mixed reality device). The audio mixed reality device may provide audio notifications in spatial locations corresponding to their real-world locations relative to the user. The audio mixed reality device may vary the tone, timbre, pitch, or style of the notification based on various factors, such as the direction, distance, or rating of the item searched for. Another use relates to a running app where the user has to keep up with a virtual “ghost” training target designed to improve the user's running pace dynamically creating a running path tailored to the user's training goals. Other uses of the audio mixed reality device may be described herein.

Some examples of audio mixed reality devices are the virtual auditory display devices described herein, such as the virtual auditory display device 100 of FIG. 1A or the virtual auditory display device described with reference to, for example, FIG. 11. In some embodiments, an audio mixed reality device includes a first ear-worn device and a second ear-worn device. Each of the first ear-worn device and a second ear-worn device may include an ear interface configured to be at least partially positioned in an ear canal of a wearer and form at least a partial acoustic seal with an ear of the wearer. The at least partial acoustic may provide or facilitate passive cancellation or isolation of environmental noises.

Each of the first ear-worn device and a second ear-worn device may also include one or more of the following: an array of external microphones that may be utilized to perform beamforming, such as on environmental noises or on speech of the wearer; one or more in-canal microphones that may be utilized to capture speech of other acoustic cues of the wearer, one or more sound output devices configured to output sounds, and one or more inertial measurement unit (IMU) sensor systems that may be utilized to detect a head orientation of the wearer and other interactions of the wearer with the first ear-worn device or the second ear-worn device, such as taps or presses. The audio mixed reality device may implement spatial audio. For example, the audio mixed reality device may implement a virtual auditory display using virtual auditory display filters as described herein.

Audio mixed reality may also be implemented in or provided by other devices, such as other wearable devices (augmented reality glasses or headsets, virtual reality headsets) or in other systems comprising microphones and speakers capable of outputting spatialized audio (for example, entertainment systems). Mixed reality as described herein may refer to or include aspects of virtual reality (VR), augmented reality (AR), audio mixed reality (AMR), visual mixed reality (VMR), or any combination thereof.

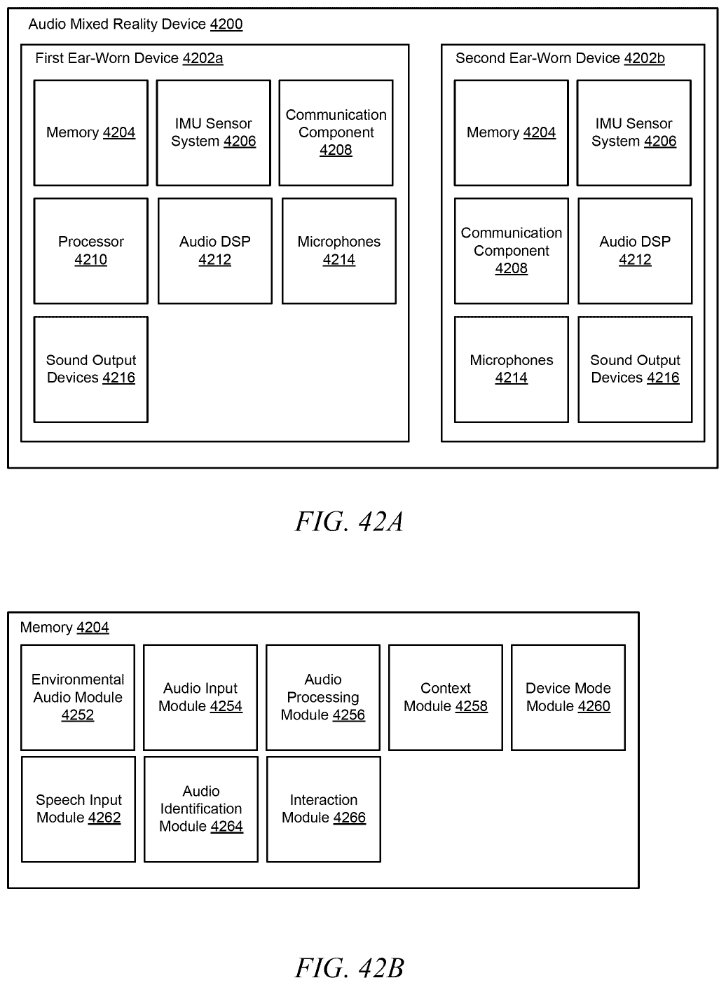

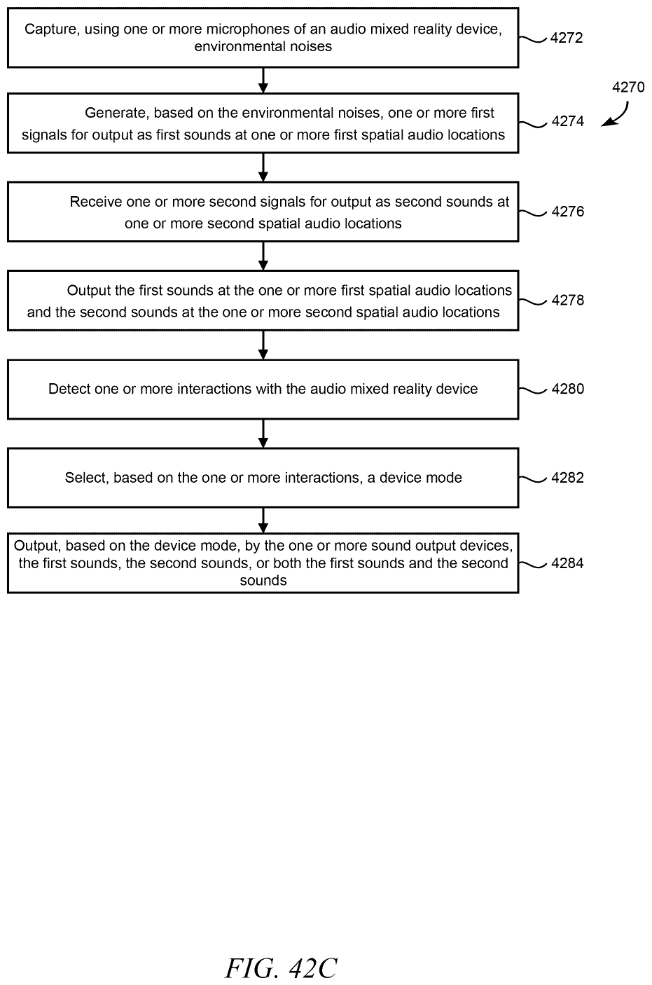

FIG. 42A is a block diagram depicting an audio mixed reality device 4200 according to some embodiments. The audio mixed reality device 4200 includes a first ear-worn device 4202a and a second ear-worn device 4202b in some embodiments. The first ear-worn device 4202a may include a memory 4204, an IMU sensor system 4206 (inertial measurement unit sensor system), a communication component 4208, a processor 4210 (which may be or include a microcontroller, a system-on-a-chip (SoC), or other processor), an audio digital signal processor 4212 (audio DSP), microphones 4214, and sound output devices 4216. The second ear-worn device 4202b may include a memory 4204, an IMU sensor system 4206 (inertial measurement unit sensor system), a communication component 4208, an audio digital signal processor 4212, microphones 4214, and sound output devices 4216.

The memory 4204 may store software or firmware. The IMU sensor system 4206 may include one or more magnetometers, accelerometers, or gyroscopes. The IMU sensor system 4206 may be used to detect a head orientation of a wearer of the audio mixed reality device 4200 and/or user interactions with the audio mixed reality device 4200. The communication component 4208 may be or include wireless communication components that facilitate wireless communications (for example, Bluetooth, Wi-Fi, or cellular communication) or wired communication. The processor 4210 may execute software and/or firmware stored in the memory 4204 or in the storage of the processor 4210. The audio digital signal processor 4212 may process audio signals to perform functions such as noise cancellation. The microphones 4214 may capture audio, such as environmental audio and/or speech of a wearer of the first ear-worn device 4202a or the second ear-worn device 4202b. The microphones 4214 may include an array of external microphones and one or more in-canal microphones. The sound output devices 4216 may output sound based on output audio signals.

Either or both of the first ear-worn device 4202a and the second ear-worn device 4202b may include components not depicted in FIG. 42A (for example, a global positioning service (GPS) component, power management components, batteries, connectors, or ear interfaces). The first ear-worn device 4202a may be the primary device and the second ear-worn device 4202b may be the secondary device. As such, the second ear-worn device 4202b may not include a processor 4210. In some embodiments, the second ear-worn device 4202b includes a processor 4210.

FIG. 42B is a block diagram depicting the memory 4204 of the audio mixed reality device 4200 of FIG. 42A in some embodiments. The memory 4204 may store software or firmware instructions or modules for execution by the processor 4210 or the audio digital signal processor 4212. The memory 4204 includes an environmental audio module 4242, an audio input module 4254, an audio processing module 4256, a context module 4258, and a device mode module 4260. The memory 4204 also includes a speech input module 4262, an audio identification module 4264, and an interaction module 4266.

The environmental audio module 4242 may receive signals for environmental noises captured by the microphones 4214. The audio input module 4254 may receive signals for audio streams using the communication component 4208. The audio processing module 4256 may process signals for the environmental noises and audio streams as described herein. For example, the audio processing module 4256 may process signals for environmental noises to remove or attenuate the environmental noises, or to enhance, modify, or replace the environmental noises.

The context module 4258 may receive and process context data, such as detected user activities, device data, ephemeral or persistent user data, and location data, so that such context data may be utilized to process signals.

The device mode module 4260 may select, based on physical interactions of a user with the device, one of several different device modes. The device modes may include a transparency mode in which the sound output devices 4216 output sounds for environmental noises and may attenuate output of audio streams, an immersion mode in which the sound output devices 4216 output sounds for audio streams and may attenuate output of environmental noises, and a focus mode in which the audio mixed reality device 4200 performs beamforming using the microphones 4214, amplifies signals for environmental noises captured using the microphones 4214, and may attenuate output of sounds for audio streams. In some embodiments, the signals for environmental noises are amplified by approximately 2.0 to 6.0 dB, such as approximately 3.0 dB, although other ranges or values are possible.

In some embodiments, a user may use physical interactions with the audio mixed reality device 4200 to control how the audio mixed reality device 4200 outputs sounds for environmental noises and sounds for audio streams. For example, if the audio mixed reality device 4200 is embodied as one of the virtual auditory display devices described herein, the user may be able to control volume of sounds for environmental noises with the rotatable electronics package of one ear-worn device and to control volume of sounds for audio streams with the rotatable electronics package of the other ear-worn device. Thus the user may be able to turn up or down the volume of sounds for environmental noises as well as able to turn up or down the volume of sounds for audio streams.

The speech input module 4262 may receive and process speech or other acoustic cues (claps, clicks, hums, etc.) of a user of the audio mixed reality device 4200. The audio identification module 4264 may segment environmental noises by which microphone of the 4214 captured the environmental noises. The audio identification module 4264 may classify or identify environmental noises, such as by using one or more machine learning or artificial intelligence models.

The interaction module 4266 may process detected interactions of the user with the audio mixed reality device 4200, such as taps, presses, or rotations, so that such detected interactions may be utilized to change modes or behaviors of the audio mixed reality device 4200.

An engine, component, module, or the like of the audio mixed reality device 4200 may be hardware, software, firmware, or any combination, depending on the context. For example, each engine, component, module or the like may include functions performed by dedicated hardware (for example, an Application-Specific Integrated Circuit (ASIC), a Field Programmable Gate Array (FPGA), or the like), software, instructions maintained in memory, and/or any combination. Software and/or firmware may be executed by one or more processors. Although a limited number of engines, components, or modules may be depicted in FIGS. 42A and 42B, there may be any number of engines, components, modules or the like. Further, individual engines, components, or modules may perform any number of functions, including functions of multiple modules as described herein. Moreover, there may be multiple of engines, components, or modules indicated as singly (for example, the first ear-worn device 4202a or the second ear-worn device 4202b may each include multiple audio digital signal processors 4212) or a single one of engines, components, or modules indicated as plural (for example, the first ear-worn device 4202a or the second ear-worn device 4202b may include a single sound output device 4216).

FIG. 42C is a flow diagram illustrating an example method 4270 that the audio mixed reality device 4200 may perform according to some embodiments. The audio mixed reality device 4200 may begin at step 4272 where the audio mixed reality device 4200 captures, using the one or more microphones 4214, environmental noises. At step 4274 the audio mixed reality device 4200 generates, based on the environmental noises, one or more first signals for output as first sounds at one or more first spatial audio locations by the sound output devices 4216. At step 4276 the audio mixed reality device 4200 receives one or more second signals for output as second sounds at one or more second spatial audio locations by the sound output devices 4216. For example, the signals may be, include, or correspond to audio streams from agents or applications. At step 4278 the audio mixed reality device 4200 outputs, by the sound output devices 4216, the first sounds at the one or more first spatial audio locations and the second sounds at the one or more second spatial audio locations.

At step 4280 the audio mixed reality device 4200 detects one or more interactions with the audio mixed reality device 4200. For example, the audio mixed reality device 4200 may detect that the wearer has tapped, double tapped, or pressed on the audio mixed reality device 4200. At step 4282 the audio mixed reality device 4200 selects, based on the one or more interactions, a device mode. The device mode may be a transparency mode in which the sound output devices 4216 output the first sounds and may attenuate output of the second sounds, an immersion mode in which the sound output devices 4216 output the second sounds and may attenuate output of the first sounds, or a focus mode. In the focus mode, the audio mixed reality device 4200 performs beamforming using the microphones 4214. The audio mixed reality device 4200 amplifies the one or more first signals corresponding to the environmental noises captured using the beamformed microphones 214. At step 4284 the audio mixed reality device 4200 outputs, based on the device mode, by the sound output devices 4216, the first sounds, the second sounds, or both the first sounds and the second sounds.

In some aspects, the techniques described herein relate to an audio mixed reality device including: a first ear interface configured to be at least proximate to a first ear of a wearer of the audio mixed reality device, the first ear interface including one or more first sound output devices configured to direct sound into a first ear canal of the first ear; a second ear interface configured to be to be at least proximate to a second ear of the wearer, the second ear interface including one or more second sound output devices configured to direct sound into a second ear canal of the second ear; one or more microphones; one or more communication components; one or more processors; and one or more memories storing instructions that, when executed by the one or more processors, cause the audio mixed reality device to: capture, using the one or more microphones, environmental noises; generate, based on the environmental noises, one or more first signals for output as first sounds at one or more first spatial audio locations by the one or more first sound output devices or the one or more second sound output devices; receive, using the one or more communication components, one or more second signals for output as second sounds at one or more second spatial audio locations by the one or more first sound output devices or the one or more second sound output devices; and output, by the one or more first sound output devices or the one or more second sound output devices, the first sounds at the one or more first spatial audio locations and the second sounds at the one or more second spatial audio locations.

In some aspects, the techniques described herein relate to an audio mixed reality device, further including one or more components configured to detect physical interactions of the wearer with the audio mixed reality device, and wherein the audio mixed reality device may perform beamforming using the one or more microphones, and the instructions further cause the audio mixed reality device to: detect, using the one or more components, one or more physical interactions of the wearer with the audio mixed reality device; select, based on the one or more physical interactions, a device mode, the device mode selected from: a transparency mode in which the one or more first sound output devices or the one or more second sound output devices output the first sounds and may reduce or attenuate output of the second sounds; an immersion mode in which the one or more first sound output devices or the one or more second sound output devices output the second sounds and may reduce or attenuate output of the first sounds; and a focus mode in which the audio mixed reality device performs beamforming using the one or more microphones, the one or more first signals are amplified prior to output as the first sounds, and the one or more first sound output devices or the one or more second sound output devices output the first sounds and may reduce or attenuate output of the second sounds; and output, based on the device mode, by the one or more first sound output devices or the one or more second sound output devices, the first sounds, the second sounds, or both the first sounds and the second sounds.

In some aspects, the techniques described herein relate to an audio mixed reality device wherein the audio mixed reality device performs beamforming using the one or more microphones on a target region relative to the wearer, and the one or more first spatial audio locations are based at least in part on the target region.

In some aspects, the techniques described herein relate to an audio mixed reality device wherein the one or more first signals for output as first sounds are generated to remove or attenuate the environmental noises.

In some aspects, the techniques described herein relate to an audio mixed reality device wherein the one or more first signals for output as first sounds are generated to modify or replace the environmental noises.

In some aspects, the techniques described herein relate to an audio mixed reality device wherein the instructions further cause the audio mixed reality device to determine one or more locations of the environmental noises using the one or more microphones, and the one or more first spatial audio locations correspond to the one or more locations.

In some aspects, the techniques described herein relate to an audio mixed reality device, further including one or more components configured to detect a head orientation of the wearer, and the instructions further cause the audio mixed reality device to: detect, using the one or more components, the head orientation of the wearer; and modify, based on the head orientation of the wearer, the one or more first spatial audio locations or the one or more second spatial audio locations.

In some aspects, the techniques described herein relate to an audio mixed reality device, further including: a first ear-worn device that includes: the first ear interface, wherein the first ear interface is configured to be at least partially positioned in the first ear canal and form at least a first partial acoustic seal with the first ear; one or more first microphones of the one or more microphones; and the one or more first sound output devices; and a second ear-worn device that includes: the second ear interface, wherein the second ear interface is configured to be at least partially positioned in the second ear canal and form at least a second partial acoustic seal with the second ear; one or more second microphones of the one or more microphones; and the one or more second sound output devices.

In some aspects, the techniques described herein relate to a method including: capturing, using one or more microphones of an audio mixed reality device, environmental noises, the audio mixed reality device further including one or more sound output devices; generating, based on the environmental noises, one or more first signals for output as first sounds at one or more first spatial audio locations by the one or more sound output devices; receiving one or more second signals for output as second sounds at one or more second spatial audio locations by the one or more sound output devices; and outputting, by the one or more sound output devices, the first sounds at the one or more first spatial audio locations and the second sounds at the one or more second spatial audio locations.

In some aspects, the techniques described herein relate to a method, further including: detecting one or more interactions with the audio mixed reality device; selecting, based on the one or more interactions, a device mode, the device mode selected from: a transparency mode in which the one or more sound output devices output the first sounds and may attenuate output of the second sounds; an immersion mode in which the one or more sound output devices output the second sounds and may attenuate output of the first sounds; and a focus mode in which the audio mixed reality device performs beamforming using the one or more microphones, the one or more first signals are amplified prior to output as the first sounds, and the one or more sound output devices output the first sounds may attenuate output of the second sounds; and outputting, based on the device mode, by the one or more sound output devices, the first sounds, the second sounds, or both the first sounds and the second sounds.

In some aspects, the techniques described herein relate to a method wherein the audio mixed reality device performs beamforming using the one or more microphones on a region generally in front of a wearer of the audio mixed reality device, and the one or more first spatial audio locations correspond to the region.

In some aspects, the techniques described herein relate to a method, further including processing the one or more first signals to remove or attenuate the environmental noises.

In some aspects, the techniques described herein relate to a method, further including processing the one or more first signals to modify or replace the environmental noises.

In some aspects, the techniques described herein relate to a method, further including determining one or more locations of the environmental noises using the one or more microphones, wherein the one or more first spatial audio locations correspond to the one or more locations.

In some aspects, the techniques described herein relate to a method, further including: detecting a head orientation of a wearer of the audio mixed reality device; and modifying, based on the head orientation of the wearer, the one or more first spatial audio locations or the one or more second spatial audio locations.

In some aspects, the techniques described herein relate to an ear-worn device including: an ear interface configured to be at least partially positioned in an ear canal of a wearer of the ear-worn device and form at least a partial acoustic seal with an ear of the wearer; one or more microphones; one or more sound output devices; one or more communication components; one or more processors; and one or more memories storing instructions that, when executed by the one or more processors, cause the ear-worn device to: capture, using the one or more microphones, environmental noises; generate, based on the environmental noises, one or more first signals for output as first sounds at one or more first spatial audio locations by the one or more sound output devices; receive, using the one or more communication components, one or more second signals for output as second sounds at one or more second spatial audio locations by the one or more sound output devices; and output, by the one or more sound output devices, the first sounds at the one or more first spatial audio locations and the second sounds at the one or more second spatial audio locations.

### Audio

### 1. Auditory Scene Management for Mixed Reality

Mixed reality (MR) experiences often merge virtual content (for example, audio cues, digital announcements) with the real-world soundscape (for example, people talking, ambient noises). Achieving an effective audio blend can be challenging: if virtual audio overwhelms the user, they may lose awareness of their surroundings; conversely, if real-world noise is too dominant, virtual cues may become inaudible. Striking the right balance and coherence between these sources is important for immersive yet safe and context-aware interactions.

The described technology provides technical solutions to these technical problems. An auditory scene management system according to the described technology dynamically monitors and balances real-world and virtual sounds in real time. The system is guided by environmental sound analysis, user preference profiles, and contextual factors. Features or components of the system include real-time environmental sound analysis, virtual audio source management, utilization of user preferences and contextual information, and an adaptive balancing algorithm.

The system may implement real-time environmental sound analysis through the use of microphones that capture ambient noise levels, voices, and other real-world signals. The system may identify certain audio events, such as alarms or honking, and suitably prioritize these audio events so as to ensure user safety and awareness.

The system may implement virtual audio source management by dynamically assigning different priority levels to application notifications, agents, or application sounds, such as game sounds. Such dynamic prioritization may allow the system to ensure that critical information remains audible even in noisy environments. The system may also place virtual audio objects in 3D space and control their controlling volume and positioning to avoid clutter and maintain realism.

The system may utilize user preferences and contextual information to balance real-world and virtual sounds. For example, the system may learn from user behavior (for example, repeated volume adjustments) and declared preferences (for example, always give top priority to navigation instructions). As another example, the system may adjust the mix of real-world and virtual sounds based on the user activity that the system detects (for example, walking compared to sitting) or based on the environment of the user (for example, quiet library compared to busy street).

The system may implement an adaptive balancing algorithm that continuously tracks ambient decibel levels and raises or lowers virtual audio as needed to maintain clarity. The system may automatically reduce virtual elements if critical external cues (for example, a siren) are detected, so as to, for example, prevent user isolation from their surroundings.

By combining environmental sensing, contextual user data, and real-time balancing of real-world and virtual sounds, the system may ensure a balanced and coherent auditory scene, one that immerses the user in virtual experiences without compromising situational awareness or personal safety.

One potential application of the system is in wearable augmented reality (AR) devices such as headsets or glasses that merge navigation alerts, multimedia content, or social notifications with the user's real-world soundscape. Another potential application of the system is in immersive entertainment and media such as theme park rides or interactive storytelling experiences that seamlessly integrate real environmental sounds with virtual reality (VR) sound effects. The system may be used in educational settings. For example, museum exhibits or classroom tools may utilize the system to layering explanatory commentary and interactive audio cues over ambient noise without overwhelming visitors. Another potential application of the system is in navigation aids for visually impaired users. The system may offer detailed directional cues and hazard alerts while preserving essential real-world auditory cues (for example, traffic).

The system provides multiple advantages. One advantage is that the system, by providing balanced and coherent audio, reduces or prevents audio overload that users may experience. The system may enhance safety and comfort by allowing users to remain aware of critical real-world audio cues. This may reduce risks or user anxiety in public or unfamiliar spaces. By providing adaptive controls allow each user to define which sounds matter most, the system may enable personalized interaction that ensures a unique, user-friendly experience. Another advantage of the system relates to improved immersion, as managed volumes and positions of virtual sources may elevate realism and match the visual fidelity of modern MR technology. The system may also be integrated into consumer wearables, specialized professional gear, entertainment installations, and accessibility-focused tools.

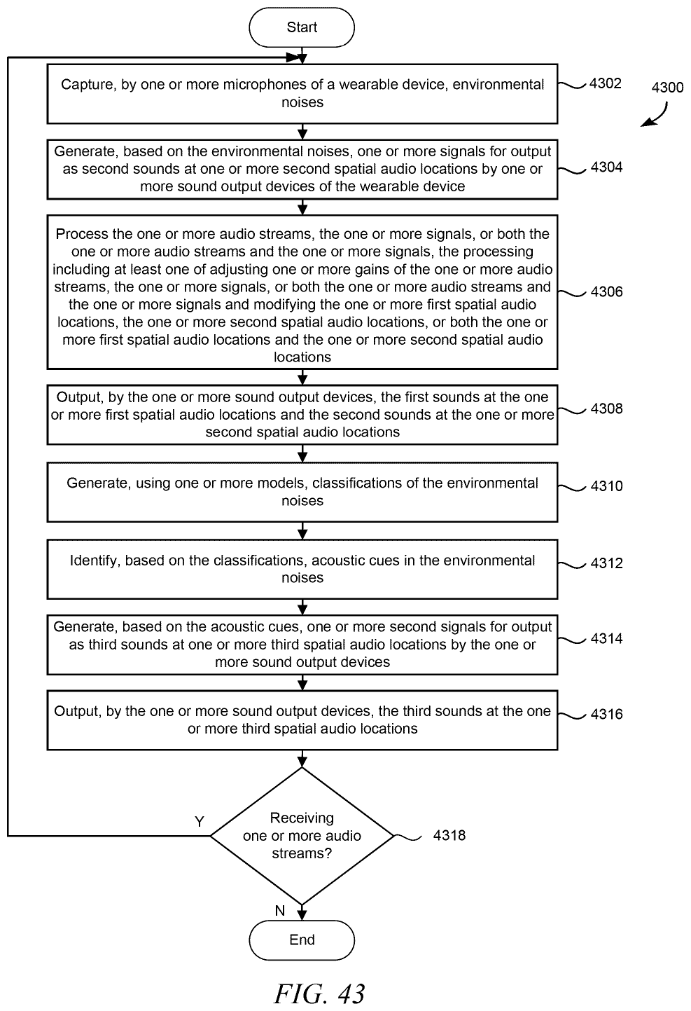

FIG. 43 is a flow diagram illustrating an example method 4300 that some embodiments of aspects of the described technology may perform. Some steps of the method 4300 may be performed by a wearable device that includes one or more sound output devices and one or more microphones. However, other systems or devices may perform some or all of the steps of the method 4300.

The method 4300 may be performed while the wearable device receives one or more audio streams for output as first sounds at one or more first spatial audio locations by the one or more sound output devices. At step 4302 the wearable device captures, by the one or more microphones, environmental noises. At step 4304 the wearable device generates, based on the environmental noises, one or more signals for output as second sounds at one or more second spatial audio locations by the one or more sound output devices.

At step 4306 the one or more audio streams, the one or more signals, or both the one or more audio streams and the one or more signals are processed. Processing includes at least one of adjusting one or more gains of the one or more audio streams, the one or more signals, or both the one or more audio streams and the one or more signals and modifying the one or more first spatial audio locations, the one or more second spatial audio locations, or both the one or more first spatial audio locations and the one or more second spatial audio locations. At step 4308 the wearable device outputs, by the one or more sound output devices, the first sounds at the one or more first spatial audio locations and the second sounds at the one or more second spatial audio locations.

At step 4310 classifications of the environmental noises are generated using one or more models, such as one or more machine learning or artificial intelligence models. At step 4312, acoustic cues in the environmental noises are identified based on the classifications. At step 4314 one or more second signals for output as third sounds at one or more third spatial audio locations by the one or more sound output devices are generated based on the acoustic cues. At step 4316 the wearable device outputs, by the one or more sound output devices, the third sounds at the one or more third spatial audio locations. At step 4318 it is determined if the wearable device is receiving one or more audio streams. If so, the method 4300 returns to step 4302. If not, the method 4300 ends. Additional or alternative steps may be performed.

In some aspects, the techniques described herein relate to a method including: while receiving one or more audio streams for output as first sounds at one or more first spatial audio locations by one or more sound output devices of a wearable device, the wearable device further including one or more microphones: capturing, by the one or more microphones, environmental noises; generating, based on the environmental noises, one or more signals for output as second sounds at one or more second spatial audio locations by the one or more sound output devices; processing the one or more audio streams, the one or more signals, or both the one or more audio streams and the one or more signals, the processing including at least one of: adjusting one or more gains of the one or more audio streams, the one or more signals, or both the one or more audio streams and the one or more signals; and modifying the one or more first spatial audio locations, the one or more second spatial audio locations, or both the one or more first spatial audio locations and the one or more second spatial audio locations; and outputting, by the one or more sound output devices, the first sounds at the one or more first spatial audio locations and the second sounds at the one or more second spatial audio locations.

In some aspects, the techniques described herein relate to a method, further including receiving user preference data associated with a wearer of the wearable device, wherein the processing further includes at least one of: adjusting, based on the user preference data, the one or more gains of the one or more audio streams, the one or more signals, or both the one or more audio streams and the one or more signals; and modifying, based on the user preference data, the one or more first spatial audio locations, the one or more second spatial audio locations, or both the one or more first spatial audio locations and the one or more second spatial audio locations.

In some aspects, the techniques described herein relate to a method, further including receiving context data associated with a wearer of the wearable device or with an environment of the wearer, wherein the processing further includes at least one of: adjusting, based on the context data, the one or more gains of the one or more audio streams, the one or more signals, or both the one or more audio streams and the one or more signals; and modifying, based on the context data, the one or more first spatial audio locations, the one or more second spatial audio locations, or both the one or more first spatial audio locations and the one or more second spatial audio locations.

In some aspects, the techniques described herein relate to a method wherein the one or more signals are one or more first signals and further including, while receiving the one or more audio streams: generating, using one or more models, classifications of the environmental noises; identifying, based on the classifications, acoustic cues in the environmental noises; generating, based on the acoustic cues, one or more second signals for output as third sounds at one or more third spatial audio locations by the one or more sound output devices; and outputting, by the one or more sound output devices, the third sounds at the one or more third spatial audio locations.

In some aspects, the techniques described herein relate to a method wherein the one or more audio streams include a first audio stream and a second audio stream, and further including: generating or accessing a first unique audio signature for the first audio stream, the first unique audio signature associated with a first source of the first audio stream; generating or accessing a second unique audio signature for the second audio stream, the second unique audio signature associated with a second source of the second audio stream; and outputting, by the one or more sound output devices, third sounds for the first unique audio signature and fourth sounds for the second unique audio signature.

In some aspects, the techniques described herein relate to one or more non-transitory computer-readable media including executable instructions that when executed by one or more processors of a system cause the system to perform a method including: while receiving one or more audio streams for output as first sounds at one or more first spatial audio locations by one or more sound output devices of a wearable device, the wearable device further including one or more microphones: capturing, by the one or more microphones, environmental noises; generating, based on the environmental noises, one or more signals for output as second sounds at one or more second spatial audio locations by the one or more sound output devices; processing the one or more audio streams, the one or more signals, or both the one or more audio streams and the one or more signals, the processing including at least one of: adjusting one or more gains of the one or more audio streams, the one or more signals, or both the one or more audio streams and the one or more signals; and modifying the one or more first spatial audio locations, the one or more second spatial audio locations, or both the one or more first spatial audio locations and the one or more second spatial audio locations; and outputting, by the one or more sound output devices, the first sounds at the one or more first spatial audio locations and the second sounds at the one or more second spatial audio locations.

In some aspects, the techniques described herein relate to one or more non-transitory computer-readable media wherein the method further includes receiving user preference data associated with a wearer of the wearable device, wherein the processing further includes at least one of: adjusting, based on the user preference data, the one or more gains of the one or more audio streams, the one or more signals, or both the one or more audio streams and the one or more signals; and modifying, based on the user preference data, the one or more first spatial audio locations, the one or more second spatial audio locations, or both the one or more first spatial audio locations and the one or more second spatial audio locations.

In some aspects, the techniques described herein relate to one or more non-transitory computer-readable media wherein the method further includes receiving context data associated with a wearer of the wearable device or with an environment of the wearer, wherein the processing further includes at least one of: adjusting, based on the context data, the one or more gains of the one or more audio streams, the one or more signals, or both the one or more audio streams and the one or more signals; and modifying, based on the context data, the one or more first spatial audio locations, the one or more second spatial audio locations, or both the one or more first spatial audio locations and the one or more second spatial audio locations.

In some aspects, the techniques described herein relate to one or more non-transitory computer-readable media wherein the one or more signals are one or more first signals and the method further includes, while receiving the one or more audio streams: generating, by using one or more models, classifications of the environmental noises; identifying, based on the classifications, acoustic cues in the environmental noises; generating, based on the acoustic cues, one or more second signals for output as third sounds at one or more third spatial audio locations by the one or more sound output devices; and outputting, by the one or more sound output devices, the third sounds at the one or more third spatial audio locations.

In some aspects, the techniques described herein relate to one or more non-transitory computer-readable media wherein the one or more audio streams include a first audio stream and a second audio stream and the method further includes: generating or accessing a first unique audio signature for the first audio stream, the first unique audio signature associated with a first source of the first audio stream; generating or accessing a second unique audio signature for the second audio stream, the second unique audio signature associated with a second source of the second audio stream; and outputting, by the one or more sound output devices, third sounds for the first unique audio signature and fourth sounds for the second unique audio signature.

In some aspects, the techniques described herein relate to a device including: one or more sound output devices; one or more microphones; at least one processor; and at least one memory including executable instructions that when executed by the at least one processor cause the device to: receive one or more audio streams for output as first sounds at one or more first spatial audio locations by the one or more sound output devices, and while receiving the one or more audio streams: capture, by the one or more microphones, environmental noises; generate, based on the environmental noises, one or more signals for output as second sounds at one or more second spatial audio locations by the one or more sound output devices; process the one or more audio streams, the one or more signals, or both the one or more audio streams and the one or more signals, to process including at least one of: adjusting one or more gains of the one or more audio streams, the one or more signals, or both the one or more audio streams and the one or more signals; and modifying the one or more first spatial audio locations, the one or more second spatial audio locations, or both the one or more first spatial audio locations and the one or more second spatial audio locations; and output, by the one or more sound output devices, the first sounds at the one or more first spatial audio locations and the second sounds at the one or more second spatial audio locations.

In some aspects, the techniques described herein relate to a device wherein the executable instructions that when executed by the at least one processor further cause the device to receive user preference data associated with a user of the device, and wherein to process further includes at least one of: adjusting, based on the user preference data, the one or more gains of the one or more audio streams, the one or more signals, or both the one or more audio streams and the one or more signals; and modifying, based on the user preference data, the one or more first spatial audio locations, the one or more second spatial audio locations, or both the one or more first spatial audio locations and the one or more second spatial audio locations.

In some aspects, the techniques described herein relate to a device wherein the executable instructions that when executed by the at least one processor further cause the device to receive context data associated with a user of the device, and wherein to process further includes at least one of: adjusting, based on the context data, the one or more gains of the one or more audio streams, the one or more signals, or both the one or more audio streams and the one or more signals; and modifying, based on the context data, the one or more first spatial audio locations, the one or more second spatial audio locations, or both the one or more first spatial audio locations and the one or more second spatial audio locations.

In some aspects, the techniques described herein relate to a device wherein the one or more signals are one or more first signals and the executable instructions that when executed by the at least one processor further cause the device to while receiving the one or more audio streams: generate, by using one or more models, classifications of the environmental noises; identify, based on the classifications, acoustic cues in the environmental noises; generate, based on the acoustic cues, one or more second signals for output as third sounds at one or more third spatial audio locations by the one or more sound output devices; and output, by the one or more sound output devices, the third sounds at the one or more third spatial audio locations.

In some aspects, the techniques described herein relate to a device wherein the one or more audio streams include a first audio stream and a second audio stream and the executable instructions that when executed by the at least one processor further cause the device to: generate or access a first unique audio signature for the first audio stream, the first unique audio signature associated with a first source of the first audio stream; generate or access a second unique audio signature for the second audio stream, the second unique audio signature associated with a second source of the second audio stream; and output, by the one or more sound output devices, third sounds for the first unique audio signature and fourth sounds for the second unique audio signature.

### 2. Spatial Audio Rendering for Mixed Reality

Mixed reality (MR) combines virtual elements with the real world, offering immersive experiences that challenge the boundaries of conventional audio design. Achieving realistic, spatially accurate sound is important in MR environments, as incongruities between visual and auditory cues can break immersion. Traditional approaches to 3D audio overlook environmental acoustic factors-like reflection, absorption, and diffusion-leading to unrealistic or flat sound experiences.

The described technology provides technical solutions to these technical problems. A spatial audio rendering system for mixed reality applications according to the described technology integrates real-time acoustic modeling with position tracking and environmental data to deliver highly immersive and dynamic audio. Features or components of the system include acoustic property simulation, real-time positional audio, integration with visual components, and multi-source management.

The system may implement acoustic property simulation by accounting for acoustic properties of the virtual and real environment, including reflection, diffusion, and absorption, to create realistic soundscapes. For example, to account for reflection and diffusion, the system may determine how sound waves bounce off or diffuse across different virtual and physical surfaces. As another example, to model absorption, the system may dynamically adjust audio signals based on material properties (for example, soft fabrics, rigid walls) for natural attenuation.

The system may implement real-time positional audio by synchronizing sound sources with movements of the head of the user or with orientation of a device of the user. The system may thus ensure that virtual objects emit sound from correct angles and distances. The system may also update audio parameters whenever objects or the user move in the virtual or real space, thereby preserving consistent spatial cues.

The system may integrate with visual components by merging audio rendering with graphical rendering to ensure a cohesive, time-locked multimedia experience. The system may implement multi-source management through the use of layered soundscapes and context-aware mixing. The system may manage multiple simultaneous sound sources-whether they originate from the real environment or from virtual objects-applying appropriate acoustic transformations. The system may also automatically reduce or mute non-critical audio streams when important events (for example, alarms, user prompts) occur.

One potential application of the system is in virtual reality (VR) or augmented reality (AR) gaming, where the system may create deeply engaging scenarios where enemies, obstacles, or virtual characters can be located precisely by sound, thereby enhancing player awareness. Another potential application is for educational and training simulations: the system may offer realistic feedback in environments like flight simulators, medical training labs, or engineering prototyping. The system may be used in architectural systems for visualization, as the system may demonstrate acoustic design choices when exploring virtual renderings of future structures or interior layouts. Another potential application is for entertainment and live events: the system may be utilized to produce immersive concerts, theater shows, or interactive museum exhibits that blend physical and virtual sound elements.

One advantage of the system is the enhanced realism and immersion that the system provides. The system may align visual and auditory cues, which may reinforce suspension of disbelief in mixed reality. Another advantage is that the system may provide improved spatial awareness: through the accurate location of sound sources in 3D space, the system may aid users in navigation, gameplay, or training tasks. The system is also adaptive and dynamic, in that the system may respond fluidly to user movements or changes in environment, thereby maintaining coherent, lifelike auditory scenes. The system may also be utilized in various MR or AR devices and software frameworks to support a wide range of applications. Another advantage is that the system may provide engaging user experiences as high-fidelity 3D audio may foster deeper emotional connections and heightened user satisfaction.

### 3. Interactive Audio Objects in Mixed Reality

Mixed reality (MR) systems often focus on visual augmentation, such as by overlaying digital graphics on the real environment or constructing fully virtual worlds. While spatial audio has enhanced immersion, user interaction with sound itself typically remains passive. The user may hear virtual audio sources but cannot manipulate them as tangible entities.

The described technology provides technical solutions to these technical problems. A system according to the described technology allows users to create and interact with virtual audio objects in mixed reality environments. In such mixed reality environments, users may engage with virtual audio objects as if they were physical objects, offering a new dimension of interaction. For example, the system may allow users to perform actions on virtual audio objects that are the equivalents of grabbing, moving, resizing, or shaping physical objects. The system may allow users to manipulate virtual audio objects through gestures, movements, or voice commands, affecting properties such as volume, pitch, and spatial position. The system may detect user actions in real-time and adjust the auditory feedback based on the user actions, thereby simulating physical interaction with sound. Features or components of the system include virtual audio object representation, interaction detection and gesture recognition, spatial auditory feedback, and physical interaction simulation.

The system may implement virtual audio object representation through parametric modeling for virtual audio objects. Each virtual audio object may be defined by parameters such as pitch, volume, spatial position, and timbre. The system may enable updates to these parameters in real-time, thereby ensuring changes in user interaction are reflected in the generated sound in real-time.

The system may implement interaction detection and gesture recognition through the use of sensors that may track motion of the user. For example, the system may use hand tracking sensors or augmented reality headsets with depth cameras to detect user gestures or movements aimed at the audio object's virtual location. The system may also recognize user voice commands. For example, the system may allow users to modify properties of virtual audio objects by speaking commands such as “increase volume” or “shift to the left.” Other commands are possible.

The system may implement spatial auditory feedback through the use of 3D audio rendering of virtual audio objects. The system may position a sound in a virtual or hybrid environment, letting users perceive it as emanating from a specific location or path. The system may also render changes in object position or state in real-time. Such dynamic updates may give an impression of physical sound movement or transformation.

In devices with displays or haptic feedback components, the system may implement physical interaction simulation through visual or haptic cues. For example, a device with a display and haptic feedback components, such as augmented reality (AR) glasses, may provide haptic feedback such as vibration or overlays to reinforce the illusion of physically moving or reshaping the sound. The system may also implement physics-inspired behaviors by utilizing inertia or boundary constraints. This may give the effect of virtual audio objects interacting with physical objects. For example, a virtual audio object may “bounce” off a virtual surface or gradually fade if “pushed” away.

By treating sound as a manipulable object, the system allows users to explore creative, educational, or therapeutic applications where sound is not only heard but actively engaged with in a tactile manner.

One potential application of the system is in interactive installations and exhibitions. For example, museums or galleries may allow visitors to “play” with sound sculptures, forming unique auditory compositions. The system may also be utilized in educational tools such as music theory apps that let students visualize and move pitches or chords in space, which may reinforce students' understanding of certain concepts. The system may also be used in the creation or exploration of music. For example, composers or performers may arrange, reshape, or circulate audio tracks in real time to create or explore innovative soundscapes. Another potential application is for therapeutic uses. For example, the system may be used in rehabilitation exercises to allow patients to practice motor skills by manipulating audio objects. As another example, relaxation applications may use the system to provide ambient audio that can be spatially arranged and rearranged.

The system offers numerous advantages. One advantage is that the interaction paradigm merges auditory and physical engagement, thereby offering an immersive approach to MR experiences. The system also enhances creativity: users can treat sound as a “material,” discovering new ways to shape or combine audio elements. The system promotes accessibility and inclusivity by providing non-visual interaction methods for users with visual impairments or individuals seeking multisensory experiences. The system also allows for tactile-like feedback. Through haptic or visual overlays, users may develop a greater sense of realism when handling audio objects. The system may also be applicable to a range of domains, from entertainment and art to educational curricula and therapeutic interventions.

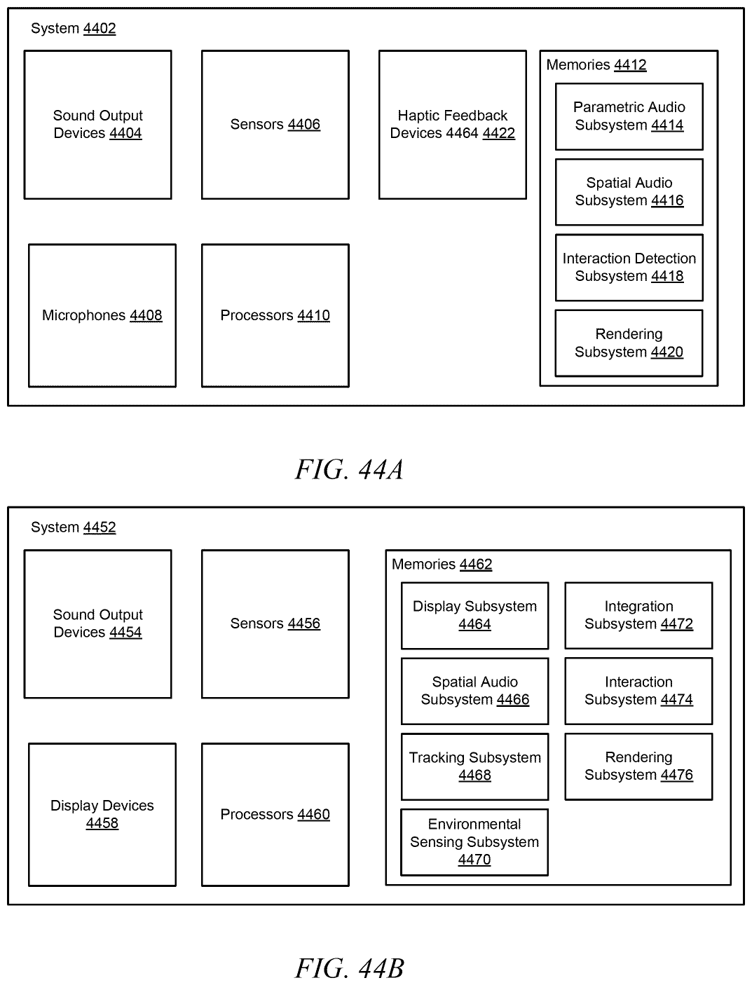

FIG. 44A depicts a system 4402 according to embodiments of aspects of the described technology. The system 4402 includes one or more sound output devices 4404 configured to process audio signals and output sounds based on the audio signals, one or more sensors 4406 configured to detect gestures or movements of a person, one or more microphones configured to capture speech of the person 4408, one or more processors 4410, and one or more haptic feedback devices 4422 configured to provide haptic feedback. The system 4402 also includes one or more memories 4412 that include instructions that are executable by the one or more processors 4410.

The instructions include a parametric audio subsystem 4414 configured to generate audio objects, an audio object having parameters including a volume, a pitch, a timbre, and a spatial audio location, the spatial audio location defined with respect to a person and a spatial audio subsystem 4416 configured to generate audio signals for the audio objects based on the parameters of the audio objects. When the audio signals are by the one or more sound output devices the audio signals cause the one or more sound output devices to output sounds at spatial audio locations of the audio objects.

The instructions also include an interaction detection subsystem 4418 configured to utilize the one or more sensors to detect the gestures or movements of the person and to identify first interactions with the audio objects or the one or more microphones to capture the speech of the person and to identify second interactions with the audio objects. The instructions also include a rendering subsystem 4420 configured to modify the parameters of the audio objects based on the first interactions or the second interactions. Additional or alternative components are possible.

In some aspects, the techniques described herein relate to a system including: one or more sound output devices configured to process audio signals and output sounds based on the audio signals; one or more sensors configured to detect gestures or movements of a person; one or more microphones configured to capture speech of the person; one or more processors; and one or more memories including instructions executable by the one or more processors, the instructions including: a parametric audio subsystem configured to generate audio objects, an audio object having parameters including a volume, a pitch, a timbre, and a spatial audio location, the spatial audio location defined with respect to a person; a spatial audio subsystem configured to generate audio signals for the audio objects based on the parameters of the audio objects, the audio signals when processed by the one or more sound output devices cause the one or more sound output devices to output sounds at spatial audio locations of the audio objects; an interaction detection subsystem configured to utilize the one or more sensors to detect the gestures or movements of the person and to identify first interactions with the audio objects or the one or more microphones to capture the speech of the person and to identify second interactions with the audio objects; and a rendering subsystem configured to modify the parameters of the audio objects based on the first interactions or the second interactions.

In some aspects, the techniques described herein relate to a system, further including one or more haptic feedback devices configured to provide haptic feedback to the person based on the first interactions or the second interactions.

In some aspects, the techniques described herein relate to a system wherein the one or more haptic feedback devices change the haptic feedback in intensity based on the parameters of the audio objects.

In some aspects, the techniques described herein relate to a system wherein the spatial audio subsystem generates the audio signals for the audio objects further based on the first interactions or the second interactions.

### 4. Auditory Signatures for Virtual Entities in Mixed Reality

In mixed reality (MR) environments, users frequently interact with multiple virtual entities, such as objects, characters, or interface elements. With visual cues often crowded or partially obscured, identifying and distinguishing these entities can be difficult, particularly when numerous entities occur at the same time or when their states change rapidly. Relying solely on visual representations may not provide quick or accessible identification for all users, Such deficiencies in current systems create a need for additional sensory channels.

The described technology provides technical solutions to these technical problems. A system according to the described technology assigns unique auditory signatures to virtual entities in MR environments. By designing and applying distinct sound motifs or cues to each entity, the user can identify, track, and understand changing states of these entities through sound alone. Features or components of the system include unique sound motifs and identity cues, adaptive state indicators, spatial and interactive integration, and personalization.

The system may implement unique sound motifs and identity cues through predefined or generated signatures. The system may assign each virtual entity an audio motif—either selected from a curated library or procedurally generated—to reflect the role, function, or personality of the virtual entity. The system may require or enforce that entities maintain consistent motifs across different interactions or sessions, fostering user familiarity and consistent audio branding.

The system may implement adaptive state indicators by making sounds vary according to the state of the virtual entity and contextual cues. For example, the system may shift a virtual entity's auditory signature in timbre, pitch, tempo, or intensity based on the virtual entity's actions, conditions, or relationship to the user. For example, the system may make the auditory signature louder or more urgent when the virtual entity is attempting to interact with the user. The system may also vary the motif to signify changes such as low health, alert mode, or relevant status updates.

The system may implement spatial and interactive integration by rendering an entity's auditory signature with appropriate spatial audio techniques, so the user may perceive sound from the entity's precise location, aiding in orientation and discovery. The system may also dynamically emphasize an entity's auditory signature while attenuating others when the user focuses on or interacts with an entity.

The system may implement personalization using user-defined preferences and enhance accessibility. For example, users can personalize their auditory landscapes by adjusting volume levels, choosing alternative motifs, or muting certain classes of entities.

By mapping auditory identities to virtual entities and adapting sound profiles as these entities evolve, the system may streamline identification, increase immersion, and broaden accessibility in MR experiences.

A potential application of the system is in games, such as in multiplayer or single-player games where numerous characters or objects require quick differentiation. The system may be used in virtual collaboration and social platforms to provide avatars or tools in shared workspaces that are easily distinguished by unique audio cues, thereby improving communication flow. Another potential application is in educational virtual reality (VR) or augmented reality (AR) content. In complex simulations or interactive lessons, the use of auditory identifiers may help learners track multiple concepts or points of interest. The system may also be used to provide narrative-driven experiences, such as interactive stories where characters' evolving sound motifs contribute to storytelling depth and emotional resonance.

One advantage of the system is that the system facilitates entity tracking that is intuitive to users. Users can quickly locate and discern entities that use distinct sound motifs. This may reduce or eliminate visual overload for users. Another advantage is that the system enhances immersion by layering auditory cues onto visual displays. This may heighten users' senses of presence and world coherence. The system allows entities to convey dynamic information (for example, health, status, or emotion) via changing sound profiles without relying on visual overlays. The system is also accessible and inclusive. Auditory identities aid those with visual impairments or users in cognitively demanding scenarios, ensuring key information remains perceptible. The system may also scale from small AR applications to large-scale VR worlds, enabling broad usage across industries.

### 5. Environmental Noise Cancellation and Enhancement in Mixed Reality

In mixed reality (MR) experiences, users often juggle multiple audio sources, such as virtual cues intertwined with real-world sounds. To avoid overload or loss of critical information, an effective method for managing environmental noise is important. Typical noise-canceling solutions aim to remove all background sounds, but in MR settings, certain real-world audio cues might be necessary (for example, traffic alerts, someone calling the user's name). This creates a need for selective noise cancellation and enhancement in order to achieve the suppression unneeded background din while allowing priority signals (virtual or real) to come through clearly.

The described technology provides technical solutions to these technical problems. A system according to the described technology provides environmental noise cancellation and selective auditory enhancement tailored for audio mixed reality scenarios. The system enables user-driven or context-driven focusing on specific sounds—whether from the virtual domain or real world—while attenuating competing noise sources. For example, the system may allow users to selectively amplify virtual audio cues or real-world sounds while suppressing background noise, facilitating focused interaction with virtual content or important real-world auditory signals. Features or components of the system include advanced noise cancellation algorithms, selective audio enhancement, adaptive mixing, user preferences, and integration with MR interfaces.

The system may implement advanced noise cancellation algorithms through adaptive beamforming and contextual sound profiles. The system may use microphone arrays to isolate user-desired signals (voice commands, important real-world sounds) and minimize peripheral noise. The system may also employ machine learning-based classification to recognize categories of sounds (for example, engine noise, ambient chatter) and selectively reduce or enhance them based on user settings.

The system may implement selective audio enhancement by increasing the clarity of spatial audio elements (for example, instructions from a virtual tour guide) even in noisy settings. The system may also prioritize real-world signals to heighten the user's ability to detect essential real-world cues (for example, alerts, direct speech) amidst bustling background sounds.

The system may implement adaptive mixing by monitoring environmental noise levels and user interactions in real time and automatically modulate volumes or filtering thresholds. The system may implement user preferences by letting users configure “focus profiles”—like quiet study mode, city exploration mode, or work collaboration mode—to define which sounds remain audible or suppressed.

The system may integrate with MR interfaces by aligning cancellation and enhancement with the 3D positions of both virtual content and real-world sound sources and by providing an intuitive interface (for example, quick voice commands or gestures) for on-the-fly adjustments to noise suppression levels or audio source emphasis.

By selectively managing what the user hears, the system may offer clarity and flexibility, ensuring that important real or virtual sound sources remain prominent while unimportant background noise is mitigated or reduced.

One potential application of the system is urban exploration applications. In such applications, the system may allow travelers to filter out city din while still hearing key sounds like traffic signals or tour guide prompts. The system may also be used to provide immersive educational content that ensures students remain focused on lesson audio in a crowded classroom or noisy lab environment. Professional concentration tools may also utilize the system to facilitate office workers or remote professionals prioritizing communication from teammates while silencing disruptive background chatter. The system may also be used in hearing support devices to improve intelligibility for hearing-impaired users. In such devices, the system may emphasize significant auditory stimuli (like speech) and downplay irrelevant noise.

One advantage of the system is that it provides enhanced auditory clarity by balancing environmental sounds and MR audio for a more enjoyable, coherent listening experience. The system is also customizable and context-aware in that the system permits users to define focus parameters or rely on adaptive algorithms that automatically react to changing surroundings. Another advantage relates to improved safety and awareness: users remain attentive to critical real-world signals (sirens, announcements) without removing beneficial cues. The system may scale to consumer headphones, augmented reality (AR) headsets, hearing aids, and enterprise solutions. The system may provide for greater accessibility, especially for individuals with varying hearing needs. Such individuals can fine-tune their auditory environment to ensure speech and other essential cues are easily discernible.

### 6. Environmental Audio Adaptation for Mixed Reality Content Generation

In mixed reality (MR) scenarios, achieving coherent immersion requires a fluid interplay between virtual elements and the real-world environment. While many MR systems focus primarily on visual blending, the auditory environment remains equally significant in delivering realism. Generating or adapting MR content based on real-time analysis of ambient sounds—be it music, street noise, or user conversations—poses unique technical challenges but yields far more personalized and context-aware experiences.

The described technology provides technical solutions to these technical problems. A system according to the described technology continuously monitors and analyzes real-world auditory inputs, then dynamically generates or adjusts MR content accordingly. Features or components of the system include environmental sound recognition and contextual analysis, adaptive MR content generation, dynamic audio mixing and spatialization, and continuous learning and refinement.

The system may implement environmental sound recognition and contextual analysis by using machine learning or artificial intelligence models to classify and interpret sounds (for example, traffic noise, conversation, weather-related sounds) in the user's environment. The system may also identify relevant acoustic cues (for example, volume level, pitch, rhythm patterns) that inform how virtual elements should adapt.

The system may implement adaptive MR content generation by causing virtual objects or ambient elements (for example, particle effects, animations) to respond to particular audio triggers. For example, louder real-world noise could trigger more vibrant or intense MR visuals. The system may also adjust MR audio content-tones, melodies, or auditory effects—to complement real-world sounds (synchronizing rhythm) or provide contrast.

The system may implement dynamic audio mixing and spatialization by blending real and virtual soundscapes. For example, the system may implement a mixing engine that modulates volumes and spatial positions for newly generated virtual sounds, ensuring coherence with actual background noise or music. The system may also utilize user-defined or approved settings for how aggressively or subtly MR audio elements blend with ongoing real-world audio.

The system may implement continuous learning and refinement by refining classification and response logic over time based on user feedback or success metrics (for example, “did this adaptation feel immersive?”). The system may also automatically adjust content if the user moves from a quiet space (for example, an office) to a louder space (for example, a busy street). Accordingly, the system may maintain immersion without requiring manual reconfiguration.

By synchronizing MR content with ongoing environmental sounds, the system may foster richer immersion, more natural interactions, and the spontaneous generation of novel experiences tied intimately to the user's immediate auditory context.

One potential application of the system is in adaptive immersive entertainment such as interactive shows or games that alter visual and auditory cues based on the user's real-time environment (for example, reacting to background music). Another use of the system is in educational content. Such content may include learning modules that tune difficulty or style of presentation to ambient noise levels or topics suggested by real-world audio cues. Another potential application is in augmented reality guides. For example, tourist applications may adjust commentary intensity or style if the user is in a noisy market or a silent museum. The system may also be used for interactive art installations, such as to enhance artwork that evolves based on live soundscapes, thereby creating unique experiences for each visitor.

The system has numerous advantages. One advantage is that the system may be deeply immersive and personalized. The system may align MR content with real-world surroundings, thereby reinforcing user engagement and relevance. The system may also enhance realism by adapting seamlessly to the user's acoustic context, maintaining continuity between physical and virtual realms. Through dynamic content generation the system may reduce reliance on pre-scripted events, enabling spontaneous, environment-driven experiences. The system may be applicable across diverse platforms, ranging from wearable augmented reality (AR) devices to mobile phones to large-scale installations, and adaptable to varying user preferences. Moreover, through machine learning or artificial intelligence-based monitoring and adaptation, the system may reduce the burden on developers or content creators to script every scenario.

### User Interface

### 1. Haptic-Audio Feedback System for Mixed Reality

In audio mixed reality (MR), the user's sense of immersion greatly depends on how believable and tangible virtual objects feel. While spatial audio provides a compelling layer of sound-based realism, the absence of tactile feedback can limit the user's perception of “touching” or interacting with these virtual constructs.

The described technology provides technical solutions to these technical problems. A system according to the described technology merges haptic and audio feedback to simulate physical interactions with virtual objects within an audio mixed reality environment. By combining haptic devices with synchronized audio cues, the system allows for the simulation of physical presence of virtual objects, thereby elevating immersion and the sense of realism in MR scenarios. When a user “touches” or manipulates a virtual object, the user may receive corresponding tactile sensations accompanied by realistic sound effects, based on the object's material properties and actions performed. Features or components of the system include haptic device integration, spatial audio synchronization, interaction tracking and gesture recognition, and adaptive feedback control.

The system may implement haptic device integration through wearable or hand-held devices such as controllers, gloves, or other wearable or hand-held devices that are capable of delivering vibrational or force-based feedback. The system may adjust the type and intensity of the haptic response (for example, soft, hard, springy) in accordance with the virtual object's characteristics.

The system may implement spatial audio synchronization using real-time sound effects. For example, the system may play or modify audio cues when the user touches, moves, or manipulates a virtual object. The system may also determine acoustic responses based on the type of material of virtual object. For example, the system may select distinctive sounds for different surfaces or object types (for example, metal clang, wooden thud) to reinforce the tactile impression.

The system may implement interaction tracking and gesture recognition by tracking the user's hands, controllers, or tools in 3D space, correlating their positions with virtual object coordinates. The system may also detect collisions or contact with virtual objects. When the system recognizes a collision or contact event, the system may trigger haptic feedback and audio effects synchronously to simulate tangible impact or friction.

The system may implement adaptive feedback control by differentiating between user actions such as tapping, grabbing or pushing, and may modify haptic and audio feedback accordingly. The system may also consider user velocity, force, or object properties in real time to produce nuanced feedback (for example, increased vibration intensity if an object is “thrown” more forcefully).

The system's dual-sensory approach may expand the boundaries of conventional MR experiences by letting users feel and hear the interactions. This may solidify their sense of presence and physical engagement with virtual elements.

Potential applications of the system include virtual training simulations, where the system mya allow users to “handle” virtual equipment with tactile fidelity and associated realistic sound, improving skill acquisition and retention, and gaming and entertainment, where the system may heighten immersion in virtual reality (VR) or augmented reality (AR) games by providing more convincing feedback for in-game objects and actions. The system may also be used in virtual prototyping to allow engineers or designers to virtually “touch” and test product components before physical manufacturing. Another use of the system may be in educational tools to enhance interactive lessons or labs by letting learners manipulate virtual objects (for example, historical artifacts, molecular models) with life-like sensations.

One advantage of the system is the deepened immersion the system may generate for users, as the combination of audio and tactile feedback creates a stronger perception of physical presence in MR. The system also provides enhanced realism and engagement, as users are more likely to accept virtual objects as tangible, increasing their sense of agency in the environment. The system may improve learning and skill transfer because hands-on interaction with realistic feedback may foster better memory retention and motor skill development. Another advantage of the system is that the system is adaptable to various MR platforms, such as headsets, gloves, or handheld controllers. The system may increase user satisfaction and accessibility: multi-sensory feedback can assist users with different sensory preferences or impairments, broadening MR accessibility.

### 2. Immersive Audio-Visual Mixed Reality Experiences

Visual mixed reality (VMR) methods offer interactive and graphic augmentations that blend seamlessly with the real world. However, VMR technologies have not been combined with audio mixed reality (AMR) technologies.

Combining both AMR and VMR allows users to experience a fully immersive, multi-sensory environment, mirroring human perception more closely. This unified approach addresses the disparity between purely audio or purely visual enhancements, creating a synchronized, coherent world that enriches user engagement and deepens the sense of presence. A system according to the described technology merges AMR with VMR to provide a comprehensive and immersive user experience. Features or components of the system include spatial audio and visual alignment, contextual and environmental adaptation, interactive augmented content, and user experience unification.

The system may implement spatial audio and visual alignment through integrated positional tracking and real-time synchronization. The system may capture head and body movement to maintain accurate alignment of both virtual audio sources and visual overlays. The system may also dynamically calibrate audio cues (for example, footsteps, speech, object interactions) to the virtual or augmented visuals, ensuring sounds emanate from correct locations.

The system may implement contextual and environmental adaptation by leveraging camera feeds, depth sensors, and microphone arrays to detect environmental conditions (for example, lighting, noise levels) and by implementing adaptive audio-visual overlays by adjusting brightness, contrast, or color schemes in visuals, as well as audio volume or filtering, based on real-world context and user preferences.

The system may implement interactive augmented content by placing digital objects or information overlays in the user's field of view while anchoring corresponding audio cues at spatially matched positions. The system may also allow for gesture and voice control: users can manipulate or query virtual elements by performing gestures or issuing voice commands, with the system responding both visually and aurally.

The system may provide user experience unification using a consistent interface for controlling audio-visual parameters (for example, toggling ambient noise reduction, highlighting visual overlays) and by allowing multiple users to interact in a shared, audio-visually augmented space, each receiving personalized yet synchronized experiences.

One potential application of the system is in educational content delivery. The system may be used in interactive lessons where students see labeled holographic diagrams over real-world objects while hearing contextual explanations in spatial audio. Another use of the system is in immersive entertainment such as virtual concerts, theater performances, or gaming scenarios where music and visuals adapt to user location and movements. The system may enhance navigation systems by providing audio prompts to direct user movement combined with AR arrows or pathways visually integrated into the real environment. Another use of the system is in virtual collaboration platforms to allow remote participants appear as avatars overlaid in the user's space, speaking from their respective positions with matching 3D audio cues.

The system provides numerous advantages, such as providing holistic multi-sensory engagement. The fusing of AMR and VMR ensures that audio and visuals are presented together, greatly intensifying user immersion. Another advantage relates to improved spatial awareness: the system may allow users to perceive and interpret both physical surroundings and digital overlays more intuitively, benefiting activities such as navigation or interactive learning. The system may be adaptive and personalized, as sensor-driven adjustments allow on-the-fly modifications to best suit each user's environment and preferences. The system may provide engaging, intuitive interactions: integrated voice commands and gestures promote natural user control and reduce friction in complex tasks. Another advantage of the system relates to enhanced collaboration. The system allows group experiences to become more immersive and synchronized by allowing multiple participants to share the same augmented environment in real time.

FIG. 44B depicts a system 4452 according to embodiments of aspects of the described technology. The system 4452 includes one or more sound output devices 4454, one or more sensors 4456 including one or more cameras and one or more microphones, one or more display devices 4458, one or more processors 4460, and one or more memories 4462 that include instructions that are executable by the one or more processors 4460.

The instructions include a display subsystem 4464 configured to utilize the one or more display devices to display images or video, a spatial audio subsystem 4466 configured to utilize the one or more sound output devices to output spatial audio sounds, a tracking subsystem 4468 configured to utilize the one or more sensors to detect gestures, movements, or speech of a person, and an environmental sensing subsystem 4470 configured to utilize the one or more sensors to determine environmental conditions.

The instructions also include an integration subsystem 4472 configured to synchronize display of the images or video with output of the spatial audio sounds, an interaction subsystem 4474 configured to utilize the gestures, movements, or speech of the person to identify interactions of the person with the images or video or the spatial audio sounds, and a rendering subsystem 4476 configured to modify the images or video or the spatial audio sounds based on the environmental conditions or the interactions of the person with the images or video or the spatial audio sounds. Additional or alternative components are possible.

In some aspects, the techniques described herein relate to a system including: one or more display devices; one or more sound output devices; one or more sensors including one or more cameras and one or more microphones; one or more processors; and one or more memories including instructions executable by the one or more processors, the instructions including: a display subsystem configured to utilize the one or more display devices to display images or video; a spatial audio subsystem configured to utilize the one or more sound output devices to output spatial audio sounds; a tracking subsystem configured to utilize the one or more sensors to detect gestures, movements, or speech of a person; an environmental sensing subsystem configured to utilize the one or more sensors to determine environmental conditions; an integration subsystem configured to synchronize display of the images or video with output of the spatial audio sounds; an interaction subsystem configured to utilize the gestures, movements, or speech of the person to identify interactions of the person with the images or video or the spatial audio sounds; and a rendering subsystem configured to modify the images or video or the spatial audio sounds based on the environmental conditions or the interactions of the person with the images or video or the spatial audio sounds.

In some aspects, the techniques described herein relate to a system wherein the one or more display devices include one or more holographic display devices.

In some aspects, the techniques described herein relate to a system wherein the integration subsystem synchronizes the display of the images or video with the output of the spatial audio sounds by placing the images or video in one or more locations in a field of view of the person and by placing the spatial audio sounds in one or more spatial audio locations corresponding to the one or more locations.

In some aspects, the techniques described herein relate to a system wherein the rendering subsystem modifies brightness, contrast or color schemes of the images or video or volumes of the spatial audio sounds.

In some aspects, the techniques described herein relate to a system wherein the one or more display devices, the one or more sound output devices, the one or more sensors, the one or more processors, and the one or more memories are incorporated in one or more wearable devices.

In some aspects, the techniques described herein relate to a system wherein the one or more wearable devices include two ear-worn devices.

### Applications

### 1. Spatial Audio Navigation in Mixed Reality

Navigating through complex virtual environments—such as large virtual museums, expansive educational worlds, or detailed gaming universes—can become cumbersome if users rely solely on visual indicators. This challenge grows when visual cues are sparse or overloaded, or when users cannot rely on sight (for example, due to visual impairment). Traditional methods (for example, on-screen arrows or miniature maps) do not fully address the user's desire for hands-free or more natural guidance.

The described technology provides technical solutions to these technical problems. A voice-activated spatial audio navigation system for mixed reality (MR) according to the described technology enables users to speak commands (for example, “Take me to the gallery entrance” or “Where is the information desk?”) and receive real-time directional audio cues that guide them to the requested location or object within the virtual environment. Components and features of the system include voice command processing, spatial audio rendering, continuous guidance and feedback, and accessibility and personalization.

The system may implement voice command processing using speech recognition and natural language processing techniques. The system may interpret user requests such as location names or commands to move toward a point of interest. The system may also map recognized destinations onto actual virtual coordinates or objects in the MR environment.

The system may implement spatial audio rendering using directional audio cues. For example, the system may generate a guiding sound (for example, a tone or voice prompt) that emanates from the direction where the user needs to move. As the user changes position or orientation, the system may reposition audio in three-dimensional space, continuously pointing to the target location.

The system may implement continuous guidance and feedback by causing audio cues to change pitch, volume, or timbre to reflect progress (for example, getting louder as the user approaches, faster as the user is close). The system may also correct user errors by providing corrective cues or asking clarifying questions if the user moves off track.

The system may provide accessibility and personalization by allowing users to modify volume levels, cue types (tones vs. voice prompts), and frequency of prompts to suit preference or hearing requirements. The system may also provide support for multiple languages, thereby expanding usability across diverse user groups by handling voice commands in multiple languages.

By combining voice-activated commands with spatial audio feedback, the system may provide a hands-free, visuality-reduced approach to navigation in MR environments.

Potential applications of the system include virtual museums and galleries to guide visitors to specific exhibits or interactive displays through voice queries and educational platforms to direct students or trainees to various learning stations or modules in immersive instructional spaces. Another potential use of the system is for virtual real estate tours. For example, the system may assist prospective buyers or renters in exploring properties by prompting location-based audio tours with voice requests. The system may also be used in exploration games. For example, the system may provide a unique dimension to gameplay where players rely on sound-based cues to find hidden treasures or navigate mazes.

One advantage of the system is that the system may provide intuitive interaction, as voice commands and 3D audio cues emulate natural human communication, thereby minimizing the learning curve for navigation. The system also may reduce dependence on visual directions, aiding users with visual impairments or those who prefer non-visual guidance. The system may enhance immersion through spatial audio, which may foster a deeper sense of presence and realism in the MR environment. The system may provide for hands-free operation that frees users from manual input devices, such as controllers or keyboards. Such operation may be beneficial in scenarios where both hands are occupied. The system may also be integrated into various MR platforms, from wearable augmented reality (AR) headsets to full virtual reality (VR) systems, supporting personalized user settings.

### Developer Platform and Tools

### 1. Developer Studio for Audio Mixed Reality Applications

Developing applications in the realm of audio mixed reality (AMR) poses unique challenges that exceed typical software engineering constraints. Traditional tools often focus on visual or 2D audio paradigms, leaving developers to manually tackle spatial audio, conversational AI, and environmental simulation. This gap makes it challenging to prototype, test, and deploy audio-driven, immersive experiences efficiently.

The described technology provides technical solutions to these technical problems. A system according to the described technology provides a comprehensive development studio designed specifically for creating audio mixed reality applications. This platform provides developers with tools for spatial audio design, conversational AI integration, environmental sound simulation, and user experience testing. The platform may accelerate the development of audio mixed reality applications. The platform may also foster innovation and creativity in audio-based experiences and may ensure high-quality, user-centric design. Components or features of the system include spatial audio design tools, conversational artificial intelligence (AI) integration (for example, with AI agents), environmental sound simulation and user experience (UX) testing and analytics.

The system may implement spatial audio design tools such as 3D sound modeling and sound propagation simulation. This may allow for fine-tuning of audio sources' positions, movements, and orientation in virtual or hybrid environments and for the emulation of reflections, occlusions, and material-based absorption for realistic acoustics.

The system may implement conversational AI integration through a voice interaction library that provides templates and APIs for embedding natural language processing (NLP), speech-to-text (STT), and text-to-speech (TTS) into AMR workflows. The system may also provide dialogue flow management that may simplify designing context-aware, interactive voice experiences that adapt to user commands and environmental cues.

The system may implement environmental sound simulation using adaptive noise profiles that the system utilizes to generate or reproduce real-world-like sound conditions (busy streets, quiet offices, etc.) to test the robustness of AMR experiences. Moreover, the system may provide a dynamic environment configurator that enables developers to orchestrate multiple ambient and event-driven sounds, validating app performance in diverse auditory scenarios.

The system may provide user experience (UX) testing and analytics by allowing real-time debugging and iteration of auditory interactions, letting developers assess user comfort and engagement. The system may also capture metrics and feedback. For example, the system may capture user input, voice analytics, and usage patterns to refine the AMR application's usability and audio design.

Through these integrated capabilities, the system may not only streamline development cycles but also foster new forms of audio-driven creativity and experimentation.

One potential application of the system is to develop immersive audio games. The system may be used to rapidly develop 3D soundscapes where players navigate using auditory cues alone. Another use is to develop educational software that enables interactive lessons featuring voice-responsive feedback and accurate environmental audio for enhanced learning. The system may be used to build multi-modal assistants that leverage speech recognition, spatial cues, and real-world acoustic conditions. The system may also be used to craft narrative-driven AMR experiences that adapt to user behavior and environmental changes in real time.

The system may accelerate development through centralizing tools for spatial audio, voice integration, and environment simulation. This may reduce overhead for AMR-specific tasks. Another advantage of the system is that the system may foster innovation by encouraging experimentation with purely auditory or hybrid experiences, spurring new genres and interaction methods. The system enables development of high-quality user experiences, as the testing and iteration ensure refined, user-centric design and polished end-products. The system may also accommodate varied project scopes and technical complexities. The system may also lower the learning curve for developers new to advanced audio or conversational AI.

FIG. 45 depicts a block diagram of an example digital device 4500 according to some embodiments. The digital device 4500 is shown in the form of a general-purpose computing device. The digital device 4500 includes at least one processor 4502, RAM 4504, communication interface 4506, input/output device 4508, storage 4510, and a system bus 4512 that couples various system components including storage 4510 to the at least one processor 4502. A system, such as a computing system, may be or include one or more of the digital devices 4500.

System bus 4512 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 4500 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 4502 is configured to execute executable instructions (for example, programs). In some embodiments, the at least one processor 4502 comprises circuitry or any processor capable of processing the executable instructions.

In some embodiments, RAM 4504 stores programs or data. In various embodiments, working data is stored within RAM 4504. The data within RAM 4504 may be cleared or ultimately transferred to storage 4510, such as prior to reset or powering down the digital device 4500.

In some embodiments, the digital device 4500 is coupled to a network via communication interface 4506. The digital device 4500 can communicate with one or more networks such as a local area network (LAN), a general wide area network (WAN), or a public network (for example, the Internet).

In some embodiments, input/output device 4508 is any device that inputs data (for example, mouse, keyboard, stylus, sensors, etc.) or outputs data (for example, speaker, display, virtual reality headset).

In some embodiments, storage 4510 can include computer system readable media in the form of non-volatile memory, such as read only memory (ROM), programmable read only memory (PROM), solid-state drives (SSD), flash memory, or cache memory. Storage 4510 may further include other removable/non-removable, volatile/non-volatile computer system storage media. By way of example only, storage 4510 can be provided for reading from and writing to a non-removable, non-volatile magnetic media. The storage 4510 may include a non-transitory computer-readable medium, or multiple non-transitory computer-readable media, which stores programs or applications for performing functions. Although not shown, a magnetic disk drive for reading from and writing to a removable, non-volatile magnetic disk (for example, a floppy disk), and an optical disk drive for reading from or writing to a removable, non-volatile optical disk such as a CDROM, DVD-ROM or other optical media can be provided. In such instances, each can be connected to system bus 4512 by one or more data media interfaces. As will be further depicted and described below, storage 4510 may include at least one program product having a set (for example, at least one) of program modules that are configured to carry out the functions of embodiments of the technology. In some embodiments, RAM 4504 is found within storage 4510.

Programs/utilities, having a set (at least one) of program modules, such as the property layout system, may be stored in storage 4510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 4500. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. An audio mixed reality device comprising:
a first ear interface configured to be at least proximate to a first ear of a wearer of the audio mixed reality device, the first ear interface including one or more first sound output devices configured to direct sound into a first ear canal of the first ear;
a second ear interface configured to be to be at least proximate to a second ear of the wearer, the second ear interface including one or more second sound output devices configured to direct sound into a second ear canal of the second ear;
one or more microphones;
one or more communication components;
one or more processors; and
one or more memories storing instructions that, when executed by the one or more processors, cause the audio mixed reality device to:
capture, using the one or more microphones, environmental noises;
generate, based on the environmental noises, one or more first signals for output as first sounds at one or more first spatial audio locations by the one or more first sound output devices or the one or more second sound output devices;
receive, using the one or more communication components, one or more second signals for output as second sounds at one or more second spatial audio locations by the one or more first sound output devices or the one or more second sound output devices; and
output, by the one or more first sound output devices or the one or more second sound output devices, the first sounds at the one or more first spatial audio locations and the second sounds at the one or more second spatial audio locations.

2. The audio mixed reality device of claim 1, further comprising one or more components configured to detect physical interactions of the wearer with the audio mixed reality device, and wherein the audio mixed reality device may perform beamforming using the one or more microphones, and the instructions further cause the audio mixed reality device to:
detect, using the one or more components, one or more physical interactions of the wearer with the audio mixed reality device;
select, based on the one or more physical interactions, a device mode, the device mode selected from:
a transparency mode in which the one or more first sound output devices or the one or more second sound output devices output the first sounds and may reduce or attenuate output of the second sounds;
an immersion mode in which the one or more first sound output devices or the one or more second sound output devices output the second sounds and may reduce or attenuate output of the first sounds; and
a focus mode in which the audio mixed reality device performs beamforming using the one or more microphones, the one or more first signals are amplified prior to output as the first sounds, and the one or more first sound output devices or the one or more second sound output devices output the first sounds and may reduce or attenuate output of the second sounds; and
output, based on the device mode, by the one or more first sound output devices or the one or more second sound output devices, the first sounds, the second sounds, or both the first sounds and the second sounds.

3. The audio mixed reality device of claim 2 wherein the audio mixed reality device performs beamforming using the one or more microphones on a target region relative to the wearer, and the one or more first spatial audio locations are based at least in part on the target region.

4. The audio mixed reality device of claim 1 wherein the one or more first signals for output as first sounds are generated to remove or attenuate the environmental noises.

5. The audio mixed reality device of claim 1 wherein the one or more first signals for output as first sounds are generated to modify or replace the environmental noises.

6. The audio mixed reality device of claim 1 wherein the instructions further cause the audio mixed reality device to determine one or more locations of the environmental noises using the one or more microphones, and the one or more first spatial audio locations correspond to the one or more locations.

7. The audio mixed reality device of claim 1, further comprising one or more components configured to detect a head orientation of the wearer, and the instructions further cause the audio mixed reality device to:
detect, using the one or more components, the head orientation of the wearer; and
modify, based on the head orientation of the wearer, the one or more first spatial audio locations or the one or more second spatial audio locations.

8. The audio mixed reality device of claim 1, further comprising:
a first ear-worn device that includes:
the first ear interface, wherein the first ear interface is configured to be at least partially positioned in the first ear canal and form at least a first partial acoustic seal with the first ear;
one or more first microphones of the one or more microphones; and
the one or more first sound output devices; and
a second ear-worn device that includes:
the second ear interface, wherein the second ear interface is configured to be at least partially positioned in the second ear canal and form at least a second partial acoustic seal with the second ear;
one or more second microphones of the one or more microphones; and
the one or more second sound output devices.

9. A method comprising:
capturing, using one or more microphones of an audio mixed reality device, environmental noises, the audio mixed reality device further including one or more sound output devices;
generating, based on the environmental noises, one or more first signals for output as first sounds at one or more first spatial audio locations by the one or more sound output devices;
receiving one or more second signals for output as second sounds at one or more second spatial audio locations by the one or more sound output devices; and
outputting, by the one or more sound output devices, the first sounds at the one or more first spatial audio locations and the second sounds at the one or more second spatial audio locations.

10. The method of claim 9, further comprising:
detecting one or more interactions with the audio mixed reality device;
selecting, based on the one or more interactions, a device mode, the device mode selected from:
a transparency mode in which the one or more sound output devices output the first sounds and may attenuate output of the second sounds;
an immersion mode in which the one or more sound output devices output the second sounds and may attenuate output of the first sounds; and
a focus mode in which the audio mixed reality device performs beamforming using the one or more microphones, the one or more first signals are amplified prior to output as the first sounds, and the one or more sound output devices output the first sounds may attenuate output of the second sounds; and
outputting, based on the device mode, by the one or more sound output devices, the first sounds, the second sounds, or both the first sounds and the second sounds.

11. The method of claim 10 wherein the audio mixed reality device performs beamforming using the one or more microphones on a region generally in front of a wearer of the audio mixed reality device, and the one or more first spatial audio locations correspond to the region.

12. The method of claim 9, further comprising processing the one or more first signals to remove or attenuate the environmental noises.

13. The method of claim 9, further comprising processing the one or more first signals to modify or replace the environmental noises.

14. The method of claim 9, further comprising determining one or more locations of the environmental noises using the one or more microphones, wherein the one or more first spatial audio locations correspond to the one or more locations.

15. The method of claim 9, further comprising:
detecting a head orientation of a wearer of the audio mixed reality device; and
modifying, based on the head orientation of the wearer, the one or more first spatial audio locations or the one or more second spatial audio locations.

16. An ear-worn device comprising:
an ear interface configured to be at least partially positioned in an ear canal of a wearer of the ear-worn device and form at least a partial acoustic seal with an ear of the wearer;
one or more microphones;
one or more sound output devices;
one or more communication components;
one or more processors; and
one or more memories storing instructions that, when executed by the one or more processors, cause the ear-worn device to:
capture, using the one or more microphones, environmental noises;
generate, based on the environmental noises, one or more first signals for output as first sounds at one or more first spatial audio locations by the one or more sound output devices;
receive, using the one or more communication components, one or more second signals for output as second sounds at one or more second spatial audio locations by the one or more sound output devices; and
output, by the one or more sound output devices, the first sounds at the one or more first spatial audio locations and the second sounds at the one or more second spatial audio locations.

17-41. (canceled)
